(19) United States
(12) Patent Application Publication
(10) Pub. No.: US 2025/0340197 A1
(43) Pub. Date: Nov. 6, 2025

(54) METHODS AND SYSTEMS FOR CONTROLLING VEHICLE POWERTRAINS

(71) Applicant: Ohio State Innovation Foundation, Columbus, OH (US)

(72) Inventors: Hamza ANWAR, Dublin, OH (US); Qadeer AHMED, Plain City, OH (US); Muhammad Qaisar FAHIM, Indianapolis, IN (US)

(21) Appl. No.: 18/870,856

(22) PCT Filed: Jun. 1, 2023
(86) PCT No.: PCT/US2023/024137

§ 371 Date: Dec. 2, 2024

Related U.S. Application Data
(60) Provisional application No. 63/347,707, filed on Jun. 1, 2022.
(60) Provisional application No. 63/371,918, filed on Aug. 19, 2022.

(51) Int. Cl. B60W 20/00; B60W 10/06; B60W 10/11; B60W 30/188

(52) U.S. Cl. CPC B60W 20/00; B60W 10/06; B60W 10/11; B60W 30/188; B60W 2510/06; B60W 2510/1005; B60W 2510/244; B60W 2510/246; B60W 2520/10; B60W 2710/06; B60W 2710/1005; B60W 2720/106

(57) ABSTRACT

An example computer implemented method includes receiving a plurality of optimization variables; receiving a cost function representing a vehicle system, where the cost function includes a plurality of weights assigned to the plurality of optimization variables; decomposing the cost function into a plurality of problems; and generating a solution to the cost function by solving the plurality of problems. An example system includes a vehicle powertrain and a computing device configured to receive a plurality of optimization variables; receive a cost function representing a vehicle system, where the cost function comprises a plurality of weights assigned to the plurality of optimization variables; decompose the cost function into a plurality of control problems; generate a solution to the cost function by solving the plurality of control problems; and control the vehicle powertrain based on the solution to the cost function.

### CROSS-REFERENCE TO RELATED APPLICATIONS

This application claims the benefit of U.S. provisional patent application No. 63/347,707, filed on Jun. 1, 2022, and titled “COMPREHENSIVE ENERGY FOOTPRINT BENCHMARKING ALGORITHM FOR ELECTRIFIED POWERTRAINS,” and U.S. provisional patent application No. 63/371,918, filed on Aug. 19, 2022, and titled “METHODS AND SYSTEMS FOR CONTROLLING VEHICLE POWERTRAINS,” the disclosures of which are expressly incorporated herein by reference in their entireties.

### BACKGROUND

A vehicle can be modeled to predict the performance of the vehicle in different states and under different conditions. The model of the vehicle can be used to determine how to operate the vehicle to achieve desired results. For example, a hybrid vehicle can be modeled to determine how to operate the vehicle to maximize efficiency, or to reduce pollutants. However, the performance of vehicles can be difficult to model and predict because the performance of a vehicle can be determined by both the characteristics of the vehicle and the way the vehicle is being driven. Additionally, a vehicle can include interrelated components, so that the operation of one part of the vehicle can affect the operation of other parts of the vehicle. Thus, models of vehicles can be complicated because the vehicle models can represent many interrelated components. There is a need for methods and systems for modeling complicated and/or interrelated vehicle systems, in particular, methods and systems for performing co-optimization of vehicle systems.

### SUMMARY

Methods and systems for predicting and controlling the powertrain of a vehicle are described herein.

In some aspects, the techniques described herein relate to a computer-implemented method for controlling a powertrain of a vehicle including: receiving a plurality of optimization variables; receiving a cost function representing a vehicle system, wherein the cost function includes a plurality of weights assigned to the plurality of optimization variables; decomposing the cost function into a plurality of control problems; and generating a solution to the cost function by solving the plurality of control problems.

In some aspects, the techniques described herein relate to a computer-implemented method, further including outputting the solution to a vehicle, whereby the powertrain of the vehicle is controlled based on the solution to the cost function.

In some aspects, the techniques described herein relate to a computer-implemented method or claim 2, wherein the optimization variables include a plurality of states.

In some aspects, the techniques described herein relate to a computer-implemented method, wherein the states include at least one of vehicle speed, vehicle distance, gear number, gear dwell time count, battery state-of-charge, battery temperature, engine status, engine on/off dwell time counter, fuel consumption, pre-Diesel Oxidation Catalyst (DOC) temperature, DOC temperature, Diesel Particulate Filter (DPF) temperature, and selective catalytic reduction (SCR) temperature.

In some aspects, the techniques described herein relate to a computer-implemented method, wherein the optimization variables include a plurality of design parameters.

In some aspects, the techniques described herein relate to a computer-implemented method, wherein the optimization variables further include a plurality of continuous and discrete variables.

In some aspects, the techniques described herein relate to a computer-implemented method, wherein the optimization variables further include a plurality of control variables.

In some aspects, the techniques described herein relate to a computer-implemented method, wherein the control variables include at least one of vehicle acceleration, gear shift command, torque split, and engine switch.

In some aspects, the techniques described herein relate to a computer-implemented method, wherein the optimization variables include a plurality of design parameters, and wherein the design parameters include number of battery cells in series (Ns), number of battery cells in parallel (Np), scaling factor for a genset power, and genset selection between diesel and compressed natural gas (CNG).

In some aspects, the techniques described herein relate to a computer-implemented method, wherein the cost function is a function that includes values representing fuel, battery energy, and emissions.

In some aspects, the techniques described herein relate to a computer-implemented method, wherein the cost function is a cost function that includes values representing vehicle efficiency.

In some aspects, the techniques described herein relate to a computer-implemented method, wherein the solution to the cost function includes a design-space optimization.

In some aspects, the techniques described herein relate to a system for controlling a powertrain of a vehicle, the system including: a vehicle powertrain; and a computing device in operable communication with the vehicle powertrain, wherein the computing device includes a processor and a memory, the memory having computer-executable instructions stored thereon that, when executed by the processor, cause the processor to: receive a plurality of optimization variables; receive a cost function representing a vehicle system, wherein the cost function includes a plurality of weights assigned to the plurality of optimization variables; decompose the cost function into a plurality of control problems; generate a solution to the cost function by solving the plurality of control problems; and control the vehicle powertrain based on the solution to the cost function.

In some aspects, the techniques described herein relate to a system, wherein the memory has further computer-executable instructions stored thereon that, when executed by the processor, cause the processor to output the solution to a vehicle including the vehicle powertrain, whereby the vehicle powertrain is controlled based on the solution to the cost function.

In some aspects, the techniques described herein relate to a system or claim 14, wherein the optimization variables include a plurality of states.

In some aspects, the techniques described herein relate to a system, wherein the states include at least one of vehicle speed, vehicle distance, gear number, gear dwell time count, battery state-of-charge, battery temperature, engine status, engine on/off dwell time counter, fuel consumption, pre-Diesel Oxidation Catalyst (DOC) temperature, DOC temperature, Diesel Particulate Filter (DPF) temperature, and selective catalytic reduction (SCR) temperature.

In some aspects, the techniques described herein relate to a system, wherein the optimization variables include a plurality of design parameters.

In some aspects, the techniques described herein relate to a system, wherein the optimization variables include a plurality of continuous and discrete variables.

In some aspects, the techniques described herein relate to a system, wherein the optimization variables include a plurality of control variables.

In some aspects, the techniques described herein relate to a system, wherein the control variables include at least one of vehicle acceleration, gear shift command, torque split, and engine switch.

In some aspects, the techniques described herein relate to a system, wherein the optimization variables include a plurality of design parameters, and wherein the design parameters include number of battery cells in series (Ns), number of battery cells in parallel (Np), scaling factor for a genset power, and genset selection between diesel and compressed natural gas (CNG).

In some aspects, the techniques described herein relate to a system, wherein the cost function is a function that includes values representing fuel, battery energy, and emissions.

In some aspects, the techniques described herein relate to a system, wherein the cost function is a function that includes values representing vehicle efficiency.

In some aspects, the techniques described herein relate to a system, wherein the solution to the cost function includes a design-space optimization.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates a system block diagram of a hybrid vehicle, according to implementations of the present disclosure.

FIG. 1B illustrates a method of controlling a powertrain of a vehicle, according to implementations of the present disclosure.

FIG. 1C illustrates a method of performing problem decomposition and co-optimization, according to implementations of the present disclosure.

FIG. 2 is an example computing device.

FIG. 3 illustrates a table of example optimization variables, according to implementations of the present disclosure.

FIG. 4 illustrates a table comparing four stages of a four-stage problem with optimization variables, according to implementations of the present disclosure.

FIG. 5 illustrates a table of optimization results, according to implementations of the present disclosure.

FIG. 6 illustrates a comparison of computational effort, according to implementations of the present disclosure.

FIG. 7 illustrates a table of optimization results for “stage 2” of an example implementation.

FIG. 8 illustrates a table of computational efforts results for stage 2 of an example implementation.

FIG. 9 illustrates a pareto front for multi-objective problem, according to implementations of the present disclosure.

FIG. 10 illustrates a comparison of optimization results, according to implementations of the present disclosure.

FIG. 11 illustrates a comparison of computational effort, according to implementations of the present disclosure.

FIG. 12 illustrates plots of power demand, drive cycle, state of charge 1206, battery power, genset power, exhaust gas temperature catalyst temperature, catalyst conversion efficiency, and tailpipe emissions, according to example implementations of the present disclosure.

FIG. 13 illustrates optimization results, according to example implementations of the present disclosure.

FIG. 14 illustrates baseline case results, according to example implementations of the present disclosure.

FIG. 15 illustrates examples of energy analysis, according to example implementations of the present disclosure.

FIG. 16 illustrates example stage 4 results including power demand and drive cycle; state of charge; battery power; genset power; exhaust gas temperature; on/off control input; catalyst temperature; catalyst conversion efficiency; and tailpipe emissions.

FIG. 17 illustrates an example decision matrix, according to implementations of the present disclosure.

FIG. 18 illustrates a block diagram of an example problem, according to an implementation of the present disclosure.

FIG. 19 illustrates vehicle speeds, fuel consumption and system-out NOx emission for three example problems and coarsely modeled baselines.

FIG. 20 illustrates a table of state and control variables with their types and symbols.

FIG. 21 illustrates a table of Problem-wise overall fuel consumption, system-out NOx emission and net energy demand at wheels, according to an implementation of the present disclosure.

FIG. 22 illustrates an example pareto-front study showing data points for various values of p, a linear regression fit, and Euclidean distance contours from a reference point (axes are normalized between 1.0 and minimum mf or ms).

FIG. 23 illustrates resultant trajectories of various time-series signals obtained after solving the three optimal control problems, according to an implementation of the present disclosure.

FIG. 24 shows bar charts of cumulative behaviors of the gear selection control, engine on/off control and the performance of average NOx conversion efficiencies, according to an implementation of the present disclosure.

FIG. 25 illustrates a comparative analysis of net energy flow in three cases, according to an implementation of the present disclosure.

FIG. 26 illustrates cell resistance, open-circuit voltage, temperature dependent current limit, according to an implementation of the present disclosure.

FIG. 27 illustrates a table of vehicle parameters, according to an implementation of the present disclosure.

FIG. 28 illustrates BSFC maps with infilled contours with fuel consumption, exhaust flow rate turbine-out temperature, engine-out NOx; electric machine efficiency, according to an example study.

FIG. 29 illustrates a block diagram of thermal and emissions modeling in the aftertreatment system.

FIG. 30A illustrates normalized 2-D Maps of SCR's NOx conversion efficiencies for NO.

FIG. 30B illustrates normalized 2-D Maps of SCR's NOx conversion efficiencies for NO₂.

FIG. 31 illustrates an example range-extender electric vehicle architecture showing various subsystems with relevant control and state variables, according to an implementation of the present disclosure.

FIG. 32 illustrates an electric machine efficiency map, according to an implementation of the present disclosure.

FIG. 33 illustrates an example of cell internal resistance and open circuit voltage, according to an example study.

FIG. 34 illustrates an example reference speed profile, v_{ref}(t).according to an example study.

FIG. 35 illustrates an example engine look-up table for fuel consumption rate, exhaust flow rate, exhaust temperature, and engine-out NOx emissions.

FIG. 36 illustrates example vehicle parameters and corresponding symbols, according to an example implementation of the present disclosure.

FIG. 37 illustrates a summary of results an energy metrics for an example implementation of the present disclosure.

FIG. 38 illustrates an example of three-way catalyst efficiency with respect to catalyst temperature for an example implementation of the present disclosure.

FIG. 39 illustrates discretization of continuous time OCP with 5 Radau collocation points as example {0.06,0.28,0.58,0.86,1} on an interval of (0,1] for state continuity and smoothness, according to an example implementation of the present disclosure.

FIG. 40 illustrates an example on-off duration histogram, according to a study of an example implementation of the present disclosure.

FIG. 41 illustrates results showing signals for three example problems, including predicted trajectories, according to a study of an example implementation of the present disclosure.

FIG. 42 illustrates results showing signals for three example problems and predicted trajectories, according to a study of an example implementation of the present disclosure.

FIG. 43 illustrates an engine on/off duration histogram for an initial warm condition, according to a study of an example implementation of the present disclosure.

FIG. 44 illustrates a table of summary of warm-start results and energy metrics, according to a study of an example implementation of the present disclosure.

FIG. 45 illustrates an example hybrid electrified powertrain with parallel architecture showing various subsystems with example frequently-used control and state variables for energy management.

FIG. 46 illustrates an example implementation of a method for mixed-integer optimal powertrain control.

FIG. 47 illustrates discretization of continuous time OCP with 5 Radau collocation points (ξᵢϵ{0.06,0.28,0.58,0.86,1} on an interval (0,1] for i=1, . . . , 5), according to a study of an example implementation described herein.

FIG. 48 illustrates an example NREL parcel delivery truck cycle as a reference drive cycle v_{org}, for an example implementation described herein.

FIG. 49 illustrates drive cycles and corresponding gear profiles used for studies of an example implementation of the present disclosure.

FIG. 50 illustrates example DP space discretization levels used in a study of an example implementation of the present disclosure.

FIG. 51 illustrates state and control variables used in a study of an example implementation of the present disclosure.

FIG. 52 illustrates results for a hybrid 1S1C problem, according to a study of an example implementation of the present disclosure.

FIG. 53 illustrates results for a hybrid 1S1C problem, according to a study of an example implementation of the present disclosure.

FIG. 54 illustrates a comparison of PS3 versus DP for a gear hybrid (1S1C & 2DS1DC), according to a study of an example implementation of the present disclosure.

FIG. 55 illustrates a comparison of PS3 versus DP for a thermal gear hybrid (2S1C & 2DS1DC) problem, according to a study of an example implementation of the present disclosure.

FIG. 56 illustrates a comparison of PS3 results for an eco hybrid 3S2C problem, according to a study of an example implementation of the present disclosure.

FIG. 57 illustrates a comparison of estimated computation time for an example implementation of the present disclosure.

FIG. 58 illustrates an example of resistance and open circuit voltage for an example battery pack, according to a study of an example implementation of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for predicting vehicle performance of hybrid vehicles, it will become evident to those skilled in the art that the implementations are not limited thereto, but are applicable for predicting vehicle performance of other vehicle types.

Described herein are decomposition-based methods for determining solutions to cost functions that represent vehicle performance. Decomposition-based methods can include “co-optimization.” “Co-optimization,” as described herein, refers to optimizing the design of vehicle components pre-operation with optimizing its control during operation. So, the present disclosure relates to designing which vehicle components to use in what configuration for given set of target missions/tasks, and also to control of powertrain to maximize efficiency considering interaction of all of its components. Co-optimization can be computationally intensive, which can limit the use of co-optimization for complex systems and/or systems operating in real time. Implementations of the methods and systems described herein can more efficiently perform co-optimization, which can allow for better optimizations to systems, and/or more efficient control of those systems. This can include optimizing more complicated systems, and performing optimizations of systems that are operating, including by providing “real time” control of the system. Optionally, the co-optimization methods and systems described herein can be used to control the system, for example to set the state of different components of the system or to

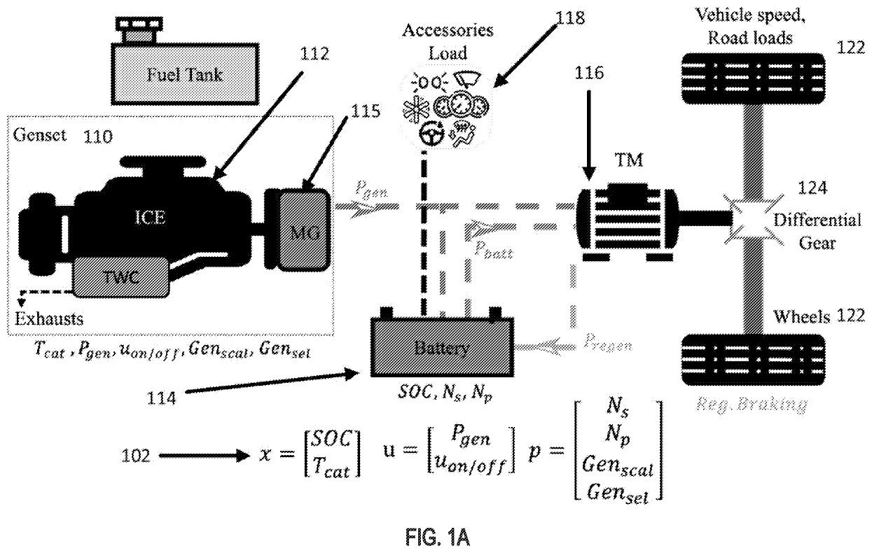

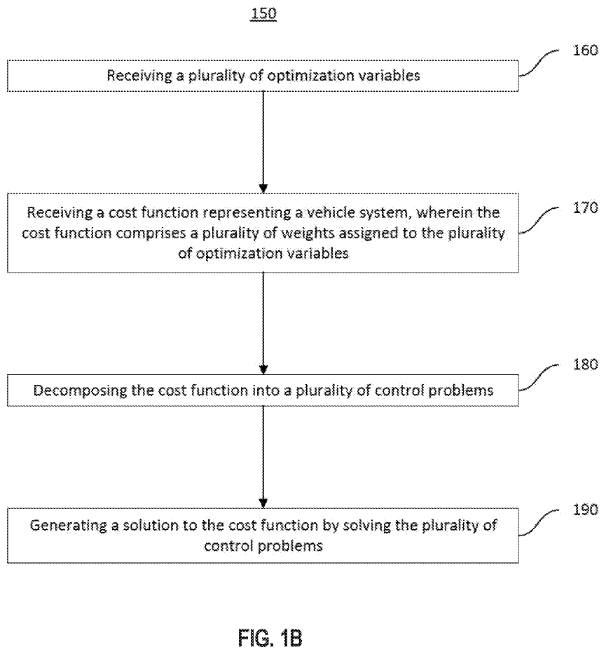

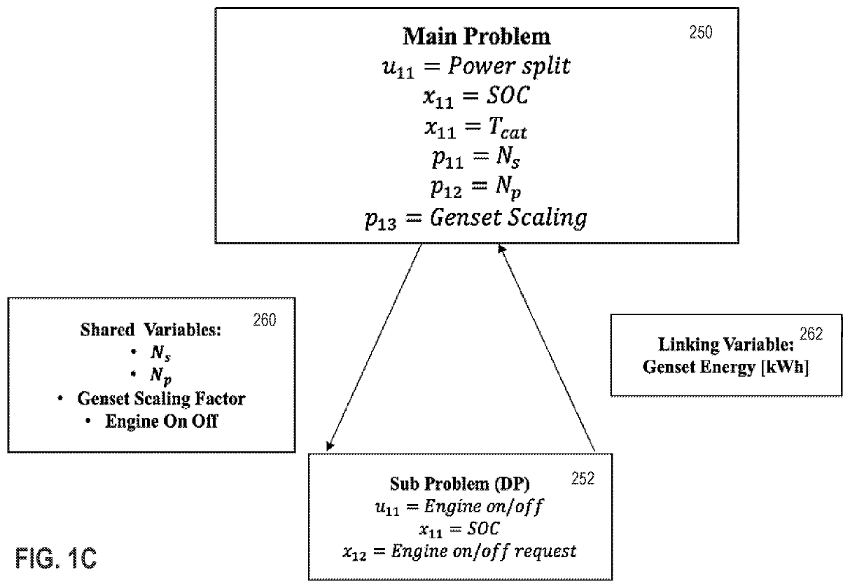

Referring now to FIG. 1A, a block diagram of a hybrid vehicle powertrain 100 is shown that can be modeled as a cost function 102. As shown in FIG. 1A, in some implementations the cost function 102 can include various optimization variables (e.g. SOC, T_{cat}, P_{gen}, Nₛ, etc.) which can be used to model and/or solve an co-optimization problem, optimization problem, powertrain control problem, optimal control problem for maximizing vehicle design and control operation efficiency. The powertrain co-optimization problem includes definitions of cost function 102 and of interlinked constraints. The non-limiting example hybrid vehicle includes a genset 110 with an internal combustion engine 112, a battery 114, an electric motor 116, and other vehicle accessories 118 (e.g., heating, cooling, navigation systems, defrosters and lights).

With reference to FIG. 1B, implementations of the present disclosure can include computer-implemented methods for controlling a vehicle, for example the hybrid vehicle powertrain 100 shown in FIG. 1A. An example computer-implemented method 150 for controlling the powertrain of a vehicle is illustrated in FIG. 1B.

At step 160, the computer-implemented method includes receiving a plurality of optimization variables. The optimization variables can represent the parameters or states or controls for the components including the genset 110, internal combustion engine 112, battery 114, electric motor 116, and other vehicle accessories 118 of the hybrid vehicle powertrain 100 shown in FIG. 1A. Non-limiting examples of states include: battery state of charge (“SOC”), after-treatment system catalyst temperature (T_{cat}), genset energy, rate of fuel consumption, battery temperature, motor armature temperature, vehicle speed, and/or driveshaft speed. Additional examples are described in the examples provided in the present disclosure. The model can also include design parameters. Non-limiting examples of design parameters include: number of battery cells in series (Ns), number of battery cells in parallel (Np), scaling factor for the genset power, and genset selection between diesel and compressed natural gas (CNG). The components of the vehicle can also be modeled with control variables. It should be understood that any combination of the control variables, states, and parameters described herein can be optimized together (e.g., simultaneously). Non-limiting examples of control variables include the power-split among genset and battery, and engine on/off). It should be understood that the design parameters, control variables, and states described herein are intended only as non-limiting examples, and that the model can include any number of design parameters, control variables and states. In some implementations of the present disclosure, the optimization variables include control levers. In some implementations of the present disclosure, the optimization variables include control variables. Non-limiting examples of control variables include vehicle acceleration, gear shift command, torque split, and engine switch.

It should also be understood that the system described herein can be used with vehicles other than hybrid vehicles, and that vehicles with different configurations of vehicle components, or different powertrains can be modeled using different design parameters, control variables, and states from those described herein.

In some implementations of the present disclosure, the design parameters, control variables, and states can include both continuous and discrete variables. As referred to herein, continuous variables can refer to variables that can take real-numbered values, this includes fractions, e.g. 3.45, and negative numbers, e.g. −27. Discrete variables can refer to variables that can only take integer numbers, e.g. 0, 1, 2, 3 without including fractions. “Binary” variables, as described herein, are a special case of discrete variables which would either take values exactly 0 or exactly 1. Alternatively, the design parameters, control variables, and states can be each be continuous variables or each be discrete variables.

In some implementations, the states may or may not be optimized, and the states may or may not be excluded from the list of optimization variables. In those implementations, the optimized controls and parameters can be sufficient to determine optimal state trajectories automatically. This can be performed because states are governed by differential equations influenced by trajectories of control variables and parameters.

At step 170, the computer-implemented method includes receiving a cost function representing a vehicle system. The performance of the vehicle can be modeled by a cost function. Implementations of the present disclosure include computer-implemented methods that can determine the solution to the cost function. The solution to the cost function can represent an optimization of the cost function. Non-limiting examples of optimizations include minimizing or maximizing the cost function. In some implementations, the cost function includes values representing vehicle efficiency or energy usage, so that maximizing or minimizing the cost function can correspond to maximizing vehicle efficiency.

The computer implemented method can be used to control the powertrain of the vehicle based on a solution to a cost function. The cost-function can be solved repeatedly while the vehicle is being operated (e.g., driven along a roadway) so that the vehicle's performance is optimized based on the cost function. For example, the solution to the cost-function can include information about what states (e.g., “on” or “off”) of different system components yield the solution to the cost function, and/or what values of continuous variables in the system yield the solution to the cost function (e.g., a speed of a motor, or a power value from a genset).

At step 180, the computer-implemented method includes decomposing the cost function into a plurality of control problems. The computer implemented method can further include decomposing the cost function into a plurality of problems (also referred to as “sub-problems”). The sub-problems can be co-optimized to determine a solution to the “main problem” (i.e., determining a solution to the cost function).

FIG. 1C illustrates a non-limiting example diagram of problem decomposition, illustrating a “main problem” 250 that is decomposed into “sub problems” 252 including shared variables 260 and linking variables 262. While FIG. 1C illustrates a single “sub problem” it should be understood that the relationship between the main problem 250 and sub problem 252 illustrated in FIG. 1C can be replicated among any number of sub-problems, and that decomposing the cost function into a plurality of control problems can include decomposing the cost function into any number of sub problems. Additionally, the problems and sub problems shown in FIG. 1C are intended only as non-limiting examples, and implementations of the present disclosure can decompose different main problems 250 into different sub problems 252, including different shared variables 260 and/or linking variables 262.

At step 190, the computer-implemented method includes generating a solution to the cost function by solving the plurality of control problems. Solving the sub-problems to determine solutions to the main problem can be computationally simpler than performing co-optimization without decomposition. This can be used to control systems in a vehicle, (e.g., the vehicle powertrain), while the vehicle is operating based on the solutions to the cost function. As a non-limiting example, a cost function can include different weights for terms representing fuel consumption, battery energy and emissions. The cost function can be optimized to generate a solution that represents the combination of fuel consumption, battery energy, and emissions that minimizes the cost function. The solution can be used to control the components of the vehicle in order to obtain the desired performance.

In some implementations, the solution to the cost function is a design-space optimization. A design space optimization can be used to design a vehicle or vehicle powertrain.

As used herein, “emissions” or “pollutant emissions” should be understood to include emissions of NOx (nitrogen oxides), PM, Soot, etc. and Greenhouse Gas emissions, e.g. CO2.

In some implementations, the solution to the cost function is output to the powertrain of a vehicle (e.g., the hybrid vehicle powertrain 100 illustrated in FIG. 1A), and the powertrain of the vehicle is controlled based on the solution to the cost function.

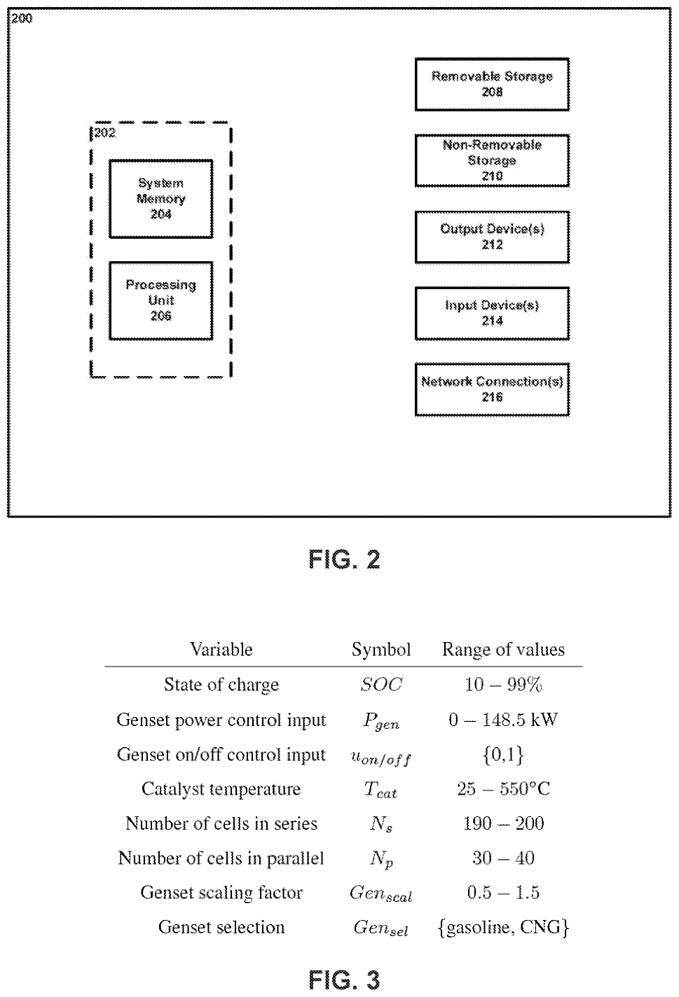

It should be understood that the computing device 200 shown in FIG. 2 can be an electronic control unit (“ECU”) or powertrain control module (“PCM”) of a vehicle or vehicle powertrain (e.g., the hybrid vehicle powertrain 100 shown in FIG. 1A).

The computer implemented method can further include receiving a cost function representing the vehicle system, where the cost function includes a plurality of weights assigned to the plurality of optimization variables.

It should be appreciated that the logical operations described herein with respect to the various figures may be implemented (1) as a sequence of computer implemented acts or program modules (i.e., software) running on a computing device (e.g., the computing device described in FIG. 2), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 2, an example computing device 200 upon which the methods described herein may be implemented is illustrated. It should be understood that the example computing device 200 is only one example of a suitable computing environment upon which the methods described herein may be implemented. Optionally, the computing device 200 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 200 typically includes at least one processing unit 206 and system memory 204. Depending on the exact configuration and type of computing device, system memory 204 may be volatile (such as random access memory (RAM)), non-volatile (such as read-only memory (ROM), flash memory, etc.), or some combination of the two. This most basic configuration is illustrated in FIG. 2 by dashed line 202. The processing unit 206 may be a standard programmable processor that performs arithmetic and logic operations necessary for operation of the computing device 200. The computing device 200 may also include a bus or other communication mechanism for communicating information among various components of the computing device 200.

Computing device 200 may have additional features/functionality. For example, computing device 200 may include additional storage such as removable storage 208 and non-removable storage 210 including, but not limited to, magnetic or optical disks or tapes. Computing device 200 may also contain network connection(s) 216 that allow the device to communicate with other devices. Computing device 200 may also have input device(s) 214 such as a keyboard, mouse, touch screen, etc. Output device(s) 212 such as a display, speakers, printer, etc. may also be included. The additional devices may be connected to the bus in order to facilitate communication of data among the components of the computing device 200. All these devices are well known in the art and need not be discussed at length here.

The processing unit 206 may be configured to execute program code encoded in tangible, computer-readable media. Tangible, computer-readable media refers to any media that is capable of providing data that causes the computing device 200 (i.e., a machine) to operate in a particular fashion. Various computer-readable media may be utilized to provide instructions to the processing unit 206 for execution. Example tangible, computer-readable media may include, but is not limited to, volatile media, non-volatile media, removable media and non-removable media implemented in any method or technology for storage of information such as computer readable instructions, data structures, program modules or other data. System memory 204, removable storage 208, and non-removable storage 210 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

A study was performed on an example implementation of the present disclosure. The example implementation of the present disclosure includes an efficient design and control co-optimization framework for hybrid electric vehicles. An example decomposition-based coordination scheme can handle multi-time scale, time-variant and time-invariant (discrete and continuous) variables. This is demonstrated in the study by solving mixed-integer optimal control problem for full horizon an-hour long drive cycle backward simulator problem with 1 second time discretization. Complexity is elevated by using multi-time scales of state variables, non-linear dynamics, thermal, electric, mechanical and kinematic states and controls with associated algebraic constraints, and 2D lookup tables. The example decomposition-based scheme is comparable with simultaneous-based scheme with 14% improvement in computational performance. Compared to dynamic optimization, cooptimization (joint static and dynamic optimization), yields up to 3.7% average genset efficiency improvement and fuel consumption reduction to 1.6 kg from 2.5 kg. It was further reduced to 1.5 kg by adding engine on-off control. Implementations of the present disclosure also include a decision matrix to provide guidance on framework and solver selection for any problem.

Hybrid electric vehicles (HEVs) represent a key element in the transition to a clean and sustainable transportation system. Powertrain electrification proved to be an effective means of increasing energy efficiency and reducing CO₂ and NOx emissions, by incorporating the advantages of electric vehicles without losing the reliability of conventional vehicles (1; 2; 3). China Society of Automotive Engineers (China-SEA) also claimed significant jumps in HEV sales in the upcoming years within China, the largest auto market (4). Also, 27% increase in HEV sales has been witnessed in USA in last quarter of 2021 as compared to last quarter of 2020(5). However, hybrid architectures present a variety of additional dynamic & static variables, whose choice can greatly influence the system energy efficiency and emissions. Therefore, the necessity of dynamic & static co-optimization framework is well understood today (6). Existing algorithms can be related to some “coordination principles” (7). The sequential “design-first-then-control” optimization method can be sub-optimal as compared to system level co-optimization. This present disclosure includes a decomposition based scheme capable to handle increasing number of diverse optimization variables of all kinds i.e., time variant (discrete and continuous), time invariant (discrete and continuous) and categorical variables. Complexity of this mixed integer optimal control problem is further elevated because of using multi-time scales of state variables, nonlinear dynamics, thermal, electric, mechanical and kinematic states and controls with associated algebraic constraints and 2D lookup tables. This full horizon an-hour long drive cycle backward simulator problem is solved with 1 second discretization of time resulting in large number of variables which ultimately adds large number of optimization variables. The example decomposition based scheme can solve sub-problems with different solvers including NLP(8), MINLP(9), Surrogate, Fmincon(10), and Dynamic Programming. In addition, multiple optimization objectives are considered, solved, and compared simultaneously with both coordination schemes which demonstrates the ability of solver to handle conflicting objectives like reduced tail pipe emissions and optimal fuel consumption at same time. A decision matrix is presented to provide guidance on selection of framework and solver for any problem at hand. The example problem is solved in four steps with increasing number of variables (such as engine type and size, battery number of cells, power split, engine on-off control) and complexity at each level to see the impact on computation time and results. Various recommendations in the decision matrix are discussed while doing one to one comparison of decomposition-based scheme with simultaneous based scheme in terms of computational performance and ability to obtain the optimal solution. Finally, importance of co-optimization is also demonstrated by presenting the efficiency and energy consumption improvements as compared to dynamic optimization case.

The optimal design of a hybrid electric vehicle not only involves optimal selection and sizing of the components, but also the solution of an optimal control problem aimed at defining the vehicle energy management strategy. The presence of two power sources, i.e. a conventional engine and an electric machine with a high volt-age battery, generates a large design space from which the components can be selected and increases the complexity of the control algorithm. Moreover, the selection and sizing of the components will affect the energy management strategy and vice versa. Exploring a large design space and using optimal control algorithms in a co-optimization framework can lead to more efficient and less polluting hybrid electric vehicle designs. However, when HEVs emerged, dynamic & static optimization were performed separately, because of limitations related to computational power. On one hand, early studies focused on application-specific architectures and components sizing (11;12;13). On the other hand, studies in the field of energy management control strategies indicate that heuristic or optimal approaches were first investigated for fixed designs, e.g., using Dynamic programming and Equivalent Consumption Minimization Strategy (ECMS) (14; 15). Most of these studies neglected the existing coupling between design and control and only explored a restricted design space, thus resulting in sub-optimal solutions (6; 16). For this reason, and because of the advancements in the computer technology, researchers started to investigate and develop more efficient methods to co-optimize design and energy management control strategies (17). (6) describes the most commonly used co-optimization coordination schemes: Iterative/Alternating, Nested, Simultaneous/All-at-once. Silvas et al., has combined the design of power steering and auxiliaries control strategy to reduce overall energy consumption (18). Silvas et al., along with the optimal design of steering pump also optimized air conditioning compressor and coupled it with dynamic optimization (19). The simultaneous approach used to solve these problems is computationally very expensive and difficult to formulate and solve for complex interconnected co-design problem (22). In (23) an optimal design is found for a series range extender HEV using a nested approach in which different design configurations are estimated using DP and com-pared with a Pareto front analysis. Azad et al. worked on a reliability-based co-optimization model (24). Murgovski et al. simultaneously optimized battery sizing and power management control along with gear selection and engine on/off control for the application in series and parallel PHEV powertrains (25). In (26) for an in-wheel motor electric vehicle demonstrated the effectiveness's of solving multi objective problem by decomposition as compared to solving all at once. Another example of application of a decomposition-based scheme can be found in (27) in which the authors jointly optimize the size of the electric machine and the geometry of a continuously variable transmission together with its ratio trajectory, with the goal of minimizing the energy consumption of the vehicle. Yet, in this work the vehicle is a full electric and not an hybrid. Behtash el al., co-optimized the design and control of engine, battery, generator, and motor of a HEV using hierarchical framework in (28), but only 600 s long drive cycle was considered. In this study a 1-hour long drive cycle is considered and discretization of time variant variables of 1 second is considered which add huge number of variables hence full horizon backward simulator problem has been solved altogether. This study compared the performance of an example implementation with simultaneous based scheme in a four-step problem.

Implementations of the present disclosure include a decomposition-based scheme able to handle complex mixed integer nonlinear multi-objective(e.g., conflicting objectives like reduced tail pipe emissions and optimal fuel consumption at same time) optimal control problem. Complexity is increased by presence of variables of all kinds i.e., time variant (discrete and continuous), time invariant (discrete and continuous) and categorical variables and on the other hand 1 second discretization of time variant variable with 1-hour long drive cycle added large number of optimization variables to backward simulator problem.

Subsystems include multi-time scales of state variables, non-linear dynamics, thermal, electric, mechanical and kinematic states and controls with associated algebraic constraints and 2D lookup tables further increase the complexity of the problem. Secondly the ability of decomposition-based scheme to solve sub-problems with different solvers including NLP, MINLP, Surrogate, Fmincon, and Dynamic Programming is demonstrated. Thirdly, one to one comparison of decomposition-based scheme with simultaneous based scheme in terms of computational performance and ability to obtain the optimal solution is presented. Moreover, importance of co-optimization is also demonstrated by presenting the efficiency and energy consumption improvements as compared to dynamic optimization case. Finally, a decision matrix is disclosed to provide guidance on selection of framework and solver for any problem at hand. Various recommendations in the decision matrix are also described herein

This example includes a hybrid electric vehicle model, including sub-models of a range extender generator set (genset), after-treatment system, battery, and traction motor. An optimization problem formulation and the simulation tools (environment, parser, algorithms and solvers) are described herein along with optimization results for the four stage problem, comparing the two different coordination schemes and proposing a decision matrix to help the selection of the co-optimization scheme as a function of the number and nature, e.g., integer-valued or continuous, dynamic or static, of optimization variables.

In this study an energy-based backward-looking HEV powertrain model is disclosed, including quasi-static sub-models for the range-extender internal combustion engine and generator, the after-treatment system, and the traction motor (TM). The battery pack is modeled with a 0^{th} order equivalent circuit model that captures the dynamics of the state of charge (SOC). Optimal energy management control strategy, and powertrain components sizing and selection are solved together with the objective of minimum energy consumption and tailpipe emissions.

FIG. 1A shows an example range-extender plug-in series hybrid architecture in detail. The internal combustion engine (ICE) 112, is coupled to a motor-generator (MG) 115 to form a generator set (genset) 110 and can be used to either provide electrical power to the electric traction motor (e.g., the electric motor 116) or recharge the battery 114. The electric motor 116 can be directly connected to the wheels 122 through the final drive 124 and can be used to either power the wheels 122 or recover energy during braking, recharging the battery 114 through regenerative braking. At the beginning of the drive cycle the battery can be fully charged (e.g., 99% SOC). The example shown in FIG. 1A can be modeled with 3 states (SOC, catalyst temperature, genset energy, 2 controls (Power-split, Engine on-off, and four design variables (no of cells in series, no of cells in parallel, genset scaling and genset selection)

In a backward-looking model, the study can make the assumption that the vehicle speed is known in the form of a drive cycle (speed v versus time t), and back-calculate the tractive force request (F_{w}) starting from the wheels, using the vehicle longitudinal dynamics in Eqn. (1) and a road load model as shown in Eqn. (2):

$${F}_{w} - {F}_{rl} = {m}_{eff} \frac{dv}{dt} \qquad ( 1 )$$

$${F}_{rl} = \frac{1}{2} {ρ}_{air} {C}_{d} {A}_{f} {v}^{2} + mg sin ( θ ) + {C}_{r} mg cos \qquad ( 2 )$$

In Eqn. (1) and Eqn. (2), Fri is the road load force, pair is the air density, Cd is the vehicle drag coefficient, A is the vehicle frontal area, C, is the tires rolling resistance coefficient, m is the vehicle mass, m_{eff} is the effective mass (taking into account the inertia of rotating components), g is the gravitational constant, and θ the road grade (assumed to be zero in this study). All values are reported in reference (29). From F., using the tire radius r, the study can calculate the torque request at the wheels Eqn. (3) and to the motor Eqn. (4):

$${T}_{w} = {F}_{w} \cdot r , \qquad ( 3 )$$

$${T}_{TM} = \frac{{T}_{w}}{{G}_{r} \cdot η} , \qquad ( 4 )$$

where Gᵣ is the final gear ratio and η is its mechanical efficiency of the differential gear (assumed to be constant and equal to 0.95). The angular velocity of the TM is calculated from the angular speed of the wheels φ_{w}=v/r:

$${ω}_{T M} = {ω}_{w} \cdot {G}_{r} \qquad ( 5 )$$

By using T_{TM} and ω_{TM}, the efficiency of the electric motor η_{TM} can be evaluated from a look-up table η_{TM}=f(T_{TM}, ω_{TM}).

The power demand from the traction motor P_{TM}=T_{TM}·ω_{TM} is split between the genset and the battery according to the control strategy, which is a result of the optimization. The power demand to the battery P_{batt} is calculated from the power balance in Eqn. (6):

$${P}_{b a t t} = \frac{{P}_{T M}}{{η}_{T M}^{γ}} - {P}_{g e n} + {P}_{a c c} \qquad ( 6 )$$

here P_{acc} is the accessory power (assumed to be constant and equal to 4 kW), P_{gen} is the genset power, and the coefficient γ is 1 in traction and −1 during regenerative braking.

Genset energy is given by:

$$\frac{d}{d t} {E}_{g e n} = {P}_{g e n} \qquad ( 7 )$$

For the battery the instantaneous open circuit voltage V_{oc} is a function of the state of charge. The cell power is given by:

$${P}_{cell} = \frac{{P}_{batt}}{{N}_{t o t}} \qquad ( 8 )$$

where Nₜₒₜ is the total number of cells. The cell current I_{cell} is calculated with Eqn. (9):

$${I}_{cell} = \frac{{η}_{batt} \cdot ( {V}_{o c} - \sqrt{{V}_{oc}^{2} - 4 \cdot {R}_{i n t} \cdot {P}_{cell}} )}{2 \cdot {R}_{i n t}} \qquad ( 9 )$$

In Eqn. (9), η_{batt} is the battery efficiency, and Rᵢₙₜ is the internal resistance which is obtained from SOC−Rᵢₙₜ directional look-up tables. Finally the SOC dynamics are calculated by using Eqn. (10):

$$\frac{d}{d t} SOC = - \frac{{I}_{c e l l}}{{C}_{c e l l}} \qquad ( 10 )$$

where C_{cell} is the cell nominal capacity.

The genset is modeled using a power/fuel flow rate look-up table \dot{m}_{f}=f(P_{genset}), assuming the engine is operated on its optimal operating line. The aftertreatment system is considered as a lumped heat capacity with catalyst temperature T_{cat}. Exhaust gases and chemical heat generation can transfer heat to the system, whereas heat rejection to the ambient occurs through the walls. The energy balance can be written as:

$$m c \frac{d {T}_{cat}}{dt} = {\dot{Q}}_{i n} + {\dot{Q}}_{e x o} - {\dot{Q}}_{o u t} \qquad ( 11 )$$

where \dot{Q}ᵢₙ is the heat coming from the exhaust gases into the system, \dot{Q}ₑₓₒ is the chemical heat generation, and \dot{Q}ₒᵤₜ is the heat rejected to the ambient. Eqn. (11) is used to calculate the dynamics for T_{cat}, which is a function of exhaust flow rate \dot{m}ₑₓₕ and exhaust temperature Tₑₓₕ, catalyst conversion efficiency η_{cat}, and ambient temperature T_{amb}:

$$\frac{{dT}_{c a t}}{dt} = f ( α , β , {\dot{m}}_{e x h} , {T}_{e x h} , {T}_{cat} , {\dot{η}}_{cat} , {T}_{a m b} ) . \qquad ( 12 )$$

The parameters α and β in Eqn. (12) can be calibrated based on experimental data (29). The model uses look-up tables for Tₑₓₕ, \dot{m}eₓₕ, and the engine-out pollutant emissions \dot{m}_{poll,eo}, whereas ambient temperature is assumed as constant. The mass flow rate of pollutant emissions at the tail pipe \dot{m}_{poll,tp} is evaluated by using Eqn. (13):

$${\dot{m}}_{poll , tp} = {\dot{m}}_{poll , eo} \cdot {η}_{c a t} ( {T}_{c a t} ) \qquad ( 14 )$$

As shown in FIG. 1A, in this study three states (battery SOC, after-treatment system catalyst temperature (T_{cat}) and genset energy), four design parameters (number of battery cells in series (Nₛ), number of battery cells in parallel (Nₚ), scaling factor for the genset power, and genset selection between diesel and compressed natural gas (CNG)), and two control variables (power-split among genset and battery, and engine on/off) are considered as a non-limiting example. All optimization variables and their range of values are reported in FIG. 3.

In the most general case, the multi-objective, multivariable co-optimization problem can be formulated as a non-linear optimization problem, with x, u, and p being the state vector, the control inputs vector, and the design parameters vector, respectively, and J the cost functional:

$${min}_{x , u , p} J ( x , u , p ) \qquad ( 14 )$$

subject to:

$${h}_{l} ( x , u , p ) = 0 l ∈ L \qquad ( 15 )$$

$${g}_{m} ( x , u , p ) \geq 0 m ∈ M \qquad ( 16 )$$

$$\underline{x} \leq x \leq \overline{x} \qquad ( 17 )$$

$$\underline{u} \leq u \leq \overline{u} \qquad ( 18 )$$

$$\underline{p} \leq p \leq \overline{p} \qquad ( 19 )$$

$$x ( {t}_{0} ) = {x}_{0} \qquad ( 20 )$$

$$x ( {t}_{f} ) = {x}_{f} \qquad ( 21 )$$

In Eqn. (15) L is the set of equality constraints, whereas in Eqn. (16) M is the set of inequality constraints. The underline and overline in the above equations represent the lowest and highest admissible values for the states, inputs and parameters, respectively. Eqn. (20) and Eqn. (21) represent initial and final conditions on the states. In this study, the cost function in Eqn. (14), in its simplest form, is expressed as a weighted sum of three terms, representing fuel, battery energy, and emissions, respectively:

$${min}_{x ( t ) , u ( t ) , p} {\int }_{{t}_{0}}^{{t}_{f}} [ {α}_{f} {\dot{m}}_{f} ( x , u , p ) + {α}_{b} {E}_{batt} ( x , u , p ) + {α}_{e} {\dot{m}}_{p o ll , tp} ( x , u , p ) ] d t , \qquad ( 22 )$$

where α_{f} is the weight for the fuel consumption, α_{b} is the weight for battery energy E_{batt}, and αₑ is the weight for mass of tail pipe out emissions. Note that the weights add up to 1 and \dot{m}_{f}, E_{batt}, and \dot{m}_{poll,tp} can be normalized with respect to their maximum values. Eqn. (22) can be characterized with additional terms depending on the co-optimization scheme, as discussed herein.

In the study of an example implementation, to compare the performance of decomposition-based scheme with simultaneous based scheme the problem in Eqn. (14) is solved with both co-ordination schemes, and then results are compared. In simultaneous scheme, the plant and the controller are optimized together. Therefore, for every iteration of the design optimization, the control strategy is also optimized in tandem with the plant variables. On the other hand, a decomposition-based scheme decomposes the system into smaller sub-problems and the system-level optimality is obtained by employing the concept of Analytical Target Cascading (ATC): the problem is divided into a main problem and multiple sub-problems, and targets are given to the sub-problems by solving the main problem, while responses are calculated by optimizing the decision variables within each sub-problem, iterating the process in order to reduce the difference between the targets and the responses. These targets are also called the linking variables because of their property to link multiple subproblems.

For the simultaneous scheme, the optimization problem is parsed for CasADi with YOP (31; 32) and solved in Matlab using either IPOPT, a non-linear programming (NLP) solver (8) provided by the OPTI toolbox, or BONMIN (9), a mixed-integer non-linear programming solver (MINLP), depending on the nature of the optimization variables (continuous or integer-valued). CasADi and IPOPT are also used for the decomposition-based scheme, but in this case Matlab built-in optimizers (10), such as Fmincon and Surrogate, or open-source Dynamic Programming solvers, such as the dpm function (33), can be used to solve the individual sub-problems, as further discussed later. The study selected direct transcription method and Legendre-Gauss-Radua collocation method for parametrization of time-dependent quantities(34). All the problems are solved in Matlab environment on a laptop with 16.0-GB of RAM and eight (four performance and four efficiency) Apple M1 chips.

In the co-optimization problem of a hybrid electric vehicle most control variables are dynamic (time dependent) and continuous. Nonetheless, design variables can be either continuous or integer, e.g., the number of battery cells is an integer-valued design variable, whereas the maximum power rating of the genset can in principle be considered as a continuous design variable. The simultaneous coordination scheme can be implemented with a derivative-based NLP solver or with a MINLP solver. The former is fast but can only handle continuous variables, the latter is comparatively slower but can handle integer-valued variables.

When solving the co-optimization problem in Eqn. (22) with the simultaneous scheme using a derivative-based NLP algorithm, all functions are considered as continuous functions. Nonetheless, if some optimization variables must take integer values, treatments can be used to force variables to take integer values, as discussed in the following paragraphs. However, using NLP solvers with treatments will lead to sub-optimal solutions.

Sine treatment can be performed in the example implementation studied. The first treatment can include adding a penalty term to the objective function while keeping the rest of the problem formulation same [(20)]. The modification of the objective function Eqn. (22) as shown below will penalize the non-integer values:

$${min}_{x ( t ) , u ( t ) , p} {\int }_{{t}_{0}}^{{t}_{f}} [ {α}_{f} {\dot{m}}_{f} ( x , u , p ) + {α}_{b} {E}_{b a t t} ( x , u , p ) + {α}_{e} {\dot{m}}_{p o ll , tp} ( x , u , p ) ] d t + ( {W}_{n} ( {sin ( p \cdot π )}^{2} ) . \qquad ( 23 )$$

In Eqn. (23), sin (p·π)=0 if p ϵΠ, else sin (p·π)≠0. Therefore, a nonzero term is added to the objective function if the parameter is not an integer. Larger weight W will penalize more and will nudge the solver to take integer values. When the value of the sine function is very small, then W needs to be infinite to guarantee integer solution. However, adding too large values can prevent the solver to find the optimal solution.

Rounding off treatment can also be performed. Another example option is to use NLP and rounding off, following a three-step approach:
(1) Solve with continuous variables. The objective function will be same as Eqn. (22). This step will optimize all the optimization variables and will give the continuous-valued solution.
(2) Round off the optimized design variables obtained in step 1 to closest integers.
(3) Re-solve with fixed rounded integer-valued parameters and find the optimal control solution for those fixed parameters.

Also in this case, sub-optimal solutions may be found.

Another non-limiting example is to solve the co-optimization problem in Eqn. (22) with the simultaneous scheme is to use the MINLP solvers, which can directly handle both integer and continuous variables at the same time. When using MINLP, states, control inputs and parameters can take either continuous or integer values. However, the simultaneous scheme using MINLP is computationally more expensive as compared to the same scheme but using NLP.

Decomposition-based Schemes can also be used in implementations of the present disclosure. Introducing more optimization variables, static or dynamic, continuous or integer-valued, the simultaneous scheme can suffer of high computational cost, as the solution is evaluated all at once. Moreover, MINLP computational costs increase exponentially with increase in discrete design variables. Hence, when the co-optimization problem becomes complex, then solving the problem by decomposing it into several sub-problems can improve the computational efficiency. The example implementation includes Analytical Target Cascading (ATC), in which the problem is divided into a main-problem and multiple subproblems. On the one hand, the solution of the main problem generates targets for the sub-problems. On the other hand, responses are calculated by optimizing the decision variables within each sub-problem. The optimization continues in a loop from main problem to sub-problems until the discrepancy between the targets and the responses is reduced below a certain threshold (E). With reference to the multi-objective optimization problem in Eqn. (22), the cost function for the main problem in the decomposition-based scheme is modified as follows:

$${min}_{x ( t ) , u ( t ) , p} {\int }_{{t}_{0}}^{{t}_{f}} [ {α}_{f} {\dot{m}}_{f} ( x , u , p ) + {α}_{b} {E}_{batt} ( x , u , p ) + {α}_{e} {\dot{m}}_{poll , tp} ( x , u , p ) ] dt + {‖ {w}_{i j} ∘ {c}_{i j} ‖}_{2}^{2} . \qquad ( 24 )$$

The main problem solution can be implemented using MINLP or NLP solvers depending on the type of variables involved and the constraints on the problem will remain the same as in Eqn. (15)-(19). The ability to separate the control and design optimization problem provide a leverage to reduce number of discrete variables in main problem which improves the computational performance if solved with MINLP. In Eqn. (24), symbol represents term by term multiplication, wᵢⱼ are quadratic weights, where the subscript i refers to the i^{th} stage and subscript j refer to the j^{th} sub-problem. The term cᵢⱼ is the inconsistency for the i^{th} stage and j^{th} sub-problem, determined by the difference between the main problem and the sub-problem linking variable L:

$${c}_{i j} = abs ( max ( L - \overline{L} ) ) , \qquad ( 25 )$$

with the term with an overhead bar referring to the response variables. For the first iteration, the response will come from the initial guess. Sub-problems are optimized once the solution from the main problem is obtained. The optimization algorithm will stop when a convergence criterion is met:

$$abs ( max ( L - \overline{L} ) ) \leq 1$$

The weights will be updated for the next loop as follows:

$${w}_{ij}^{n + 1} = {w}_{i j}^{n} \cdot β$$

The value of β can be fixed in the first iteration n=1 and it will determine the rate at which the weights are updated after each iteration. For fast convergence the recommended value of β is 2<β<3. After updating the weights, the main problem will be solved again using these updated weights and new responses will be evaluated to set new targets for the sub-problem. This loop will continue until the convergence criteria are met.

Remarks Relaxation of the inconsistency constraint (cᵢⱼ≤ϵ) instead of equality constraint (cᵢⱼ=0) can converge to the optimal solution until wᵢⱼ is increasing(35). ϵ is determined based on the requirement of designer.

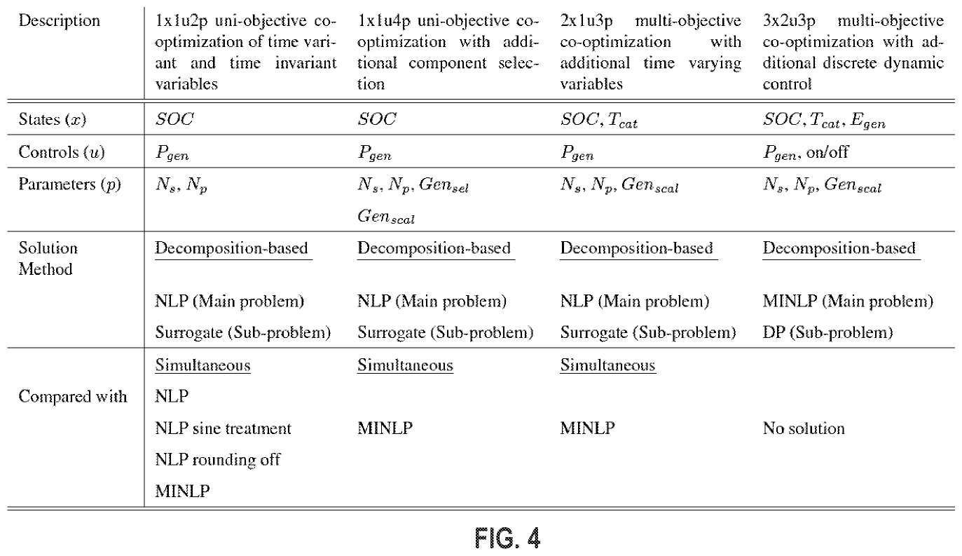

An example implementation was studied including a multi-objective co-optimization problem for a range-extender series plug-in hybrid truck is solved with an increasing number of variables that are static and dynamic, continuous or integer-valued. The study defined four stage problem with increasing number of optimization variables and level of complexity at each stage to see the impact on computation time and results. These four stages and the corresponding solution approach are summarized in FIG. 4. All stages are solved for the same drive cycle (speed vs time profile).

In stage 1 (uni-objective co-optimization) the study considers one dynamic state (SOC), one dynamic input control (genset power) and 2 integer-valued static parameters (battery cells, Nₛ and Nₚ). The first stage is used to compare all proposed coordination schemes, therefore it is solved using: simultaneous with NLP, simultaneous with NLP and sine treatment, simultaneous with NLP and three-step rounding method, simultaneous with MINLP, and decomposition-based scheme (using NLP in the main problem and Surrogate in the sub-problem). The optimality of the solutions and the computational times between all these four coordination schemes are also compared.

In stage 2 (uni-objective co-optimization with model selection) the study can increase the number of integer-valued static parameters, adding genset scaling, and introduce a categorical variable, the genset selection. In this stage the simultaneous scheme with NLP and its treatments are not considered, as the purpose of introducing and comparing those strategies is fulfilled in stage 1, hence stage 2 is solved with decomposition-based scheme and compared with simultaneous scheme (MINLP).

In stage 3, the emissions/thermal dynamic state are introduced. This stage can be solved both with decomposition-based scheme and compared with simultaneous scheme (MINLP). In this case the cost function takes its complete form as in Eqn. (22). FIG. 1C.illustrates an example implementation of Problem 4 solution using decomposition-based scheme. In order to also explore integer-valued dynamic variables, the engine on/off control input can be added in Problem 4. Integer-valued dynamic variables remain difficult to solve while solving along other kind of variables (38; 39). The solution of this problem with simultaneous scheme, which uses the branch and bound method, becomes computationally too expensive. Therefore, the problem is solved with a state of art decomposition-based scheme which uses dynamic programming (DP) to handle the integer-valued dynamic variable in the sub-problem. FIC. 1C2 shows the linking variables 262 and shared variables 260 between the main problem 250 and the sub problem 252. The engine on/off control is solved in the sub-problem and genset energy is used as linking variable 262. With this approach, the strengths of the two solvers are combined, i.e., the main problem is solved using MINLP (which can handle large number of states as seen in (40), unlike DP which suffers curse of dimensionality) and the sub-problem (that cannot be solved using MINLP) is solved using DP.

Results for each stage are presented and an overall comparison between the computational performance of decomposition-based scheme and simultaneous scheme is done. Results from final stage of cooptimization are then compared against a conventional “control-only” type of optimization. For stage 1 and stage 2 results are tabulated and explained, whereas for stage 3 and stage 4 the results are also presented graphically. In all problem stages discussed total cost of ownership is considered constant while only running cost is determined.

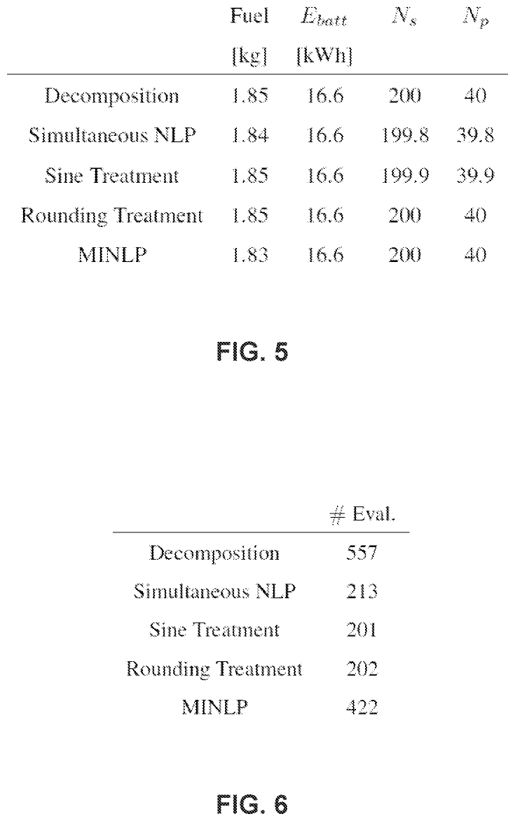

Stage 1 has one state (SOC), one control input (P_{gen}) and two design parameters (Nₛ and Nₚ). The multi-objective cost function Eqn. (22) is characterized depending on the solution method, as explained herein. The problem is solved by decomposition-based scheme and compared with NLP, MINLP, NLP sine treatment, NLP rounding, adjusting the cost function accordingly. In all the example cases, since the aftertreatment thermal model and emissions are not implemented in stage 1, the weight αₑ is zero. When using the decomposition-based scheme, SOC and P_{gen} are solved in the main problem, while the battery design parameters Nₛ and Nₚ are solved in the battery sub-problem. FIG. 5 shows the results of the optimization, presenting the optimal energy consumption and battery energy, and the optimal design parameters Nₛ and Nₚ, whereas FIG. 6 shows the computational effort in terms of number of cost function evaluations.

In terms of optimality (fuel consumption and battery energy consumption), results of decomposition-based scheme are approximately same as simultaneous based scheme, as shown in FIG. 6. However, results in FIG. 5 show that the number of objective function evaluations when using NLP (regardless of the treatment) is less than half the one for MINLP or decomposition-based scheme. Regarding the design parameters Nₛ and Nₚ, in simultaneous NLP and sine treatment the optimized results do not take integer values. On the other hand, using MINLP or decomposition-based scheme allows to obtain integer values, but at the cost of more than twice the number of objective function evaluations, hence computational time. In the example implementation rounding off treatment achieves the same optimal Nₛ and N, as MINLP or decomposition-based scheme. The solution using simultaneous with MINLP achieves the minimum value for the fuel cost, hence can be used as a benchmark. Finally, the decomposition-based coordination scheme converged in 2 iterations, thus resulting in a very high number of objective function evaluations as compared to the other methods. The initial weight for the decomposition-based scheme (see Eqn. (27)) was w₂₂=1 and the weight multiplier β=2.5. The inconsistency threshold for the total number of cells was 4. The inconsistency after the first iteration was 5.90, and 2.63 after the second.

In conclusion, at this stage when the problem is relatively simple, results of decomposition-based scheme are comparable with “all-at-once” simultaneous scheme however computationally expensive. Nonetheless, the number of cost function evaluations can change with changes in the discretization of variables and in weights and weights multipliers.

Stage 2 has one state, one control and four parameters (including one categorical variable, i.e., genset selection). The co-optimization problem is solved using decomposition-based scheme and compared with simultaneous (MINLP). The objective functions for decomposition-based and simultaneous (MINLP) scheme are shown in Eqn. (24) and Eqn. (22), respectively. Also in this case, αₑ=0, since no thermal state of the aftertreatment system is considered. In the decomposition based scheme, two sub-problems are defined, one for the battery (solving for Nₛ and Nₚ) and the other one for the genset (solving for Genₛₑᵢ and Gen_{scal}). Hence there are two inconsistency terms in the objective function Eqn. (24). Therefore, with the addition of the categorical variable, the computational complexity of the problem is increased by a factor of two.

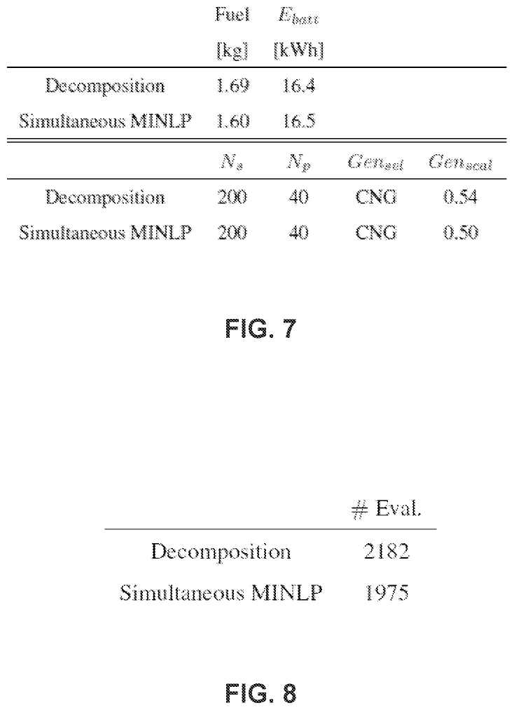

The results for the genset scaling in FIG. 7 show that in the example a smaller engine is always selected (as long as it can satisfy the power demand of the driving cycle), which will result in lower fuel consumption during idle operation (in this problem there is no engine on/off control). Also, between CNG and gasoline genset, both optimization schemes selected CNG engine which is known to be more efficient. The best solution in terms of fuel consumption is achieved with the simultaneous scheme with MINLP, showing that the communication of the optimization is best when the problem is optimized all-a-once, in particular when categorical variables are involved. FIG. 8 shows a larger number of objective function evaluations for the decomposition-based scheme, but it needs to be considered that the decomposition-based problem was solved twice to meet the convergence criteria of both sub problems, therefore the number of objective function evaluations is the sum of two loops. The optimality and the computational effort of the decomposition-based scheme solution highly depend on the threshold for the convergence criterion (the lower the threshold, the better the solution but the higher the computational time). In the example implementation, the case when it is recommended to avoid decomposition based scheme is when there are categorical variables in model because presence of those variables requires very strong communication as the example implementation does in simultaneous-based scheme.

In stage 3 emissions/thermal model can also be included, along with additional time varying variable i.e., catalyst temperature T_{cat}. The results of decomposition based scheme are compared with simultaneous (MINLP). Like the previous case, the problem in this stage is decomposed using two sub-problems, one for the battery (solving for Nₛ and Nₚ) and the other one for the genset (solving for Gen_{scal}). In stage 3 all three terms appear in the cost function Eqn. (22), with weights associated with fuel consumption, battery energy consumption, and tail pipe emissions. As stage 4 problem cannot be solved using simultaneous (MINLP) hence to compare the effectiveness of weights in the objective function in a multi-objective problem stage 3 problem is selected and three different combinations of wights have been tested:
1 Case A: the weights associated with αₑ, α_{f}, and α_{b} are 1,0 and 0, respectively.
2 Case B: the weights associated with αₑ, α_{f}, and α_{b} are 0.6,0.2 and 0.2, respectively.
3 Case C: the weights associated with αₑ, α_{f}, and α_{b} are 0.1 and 0, respectively.

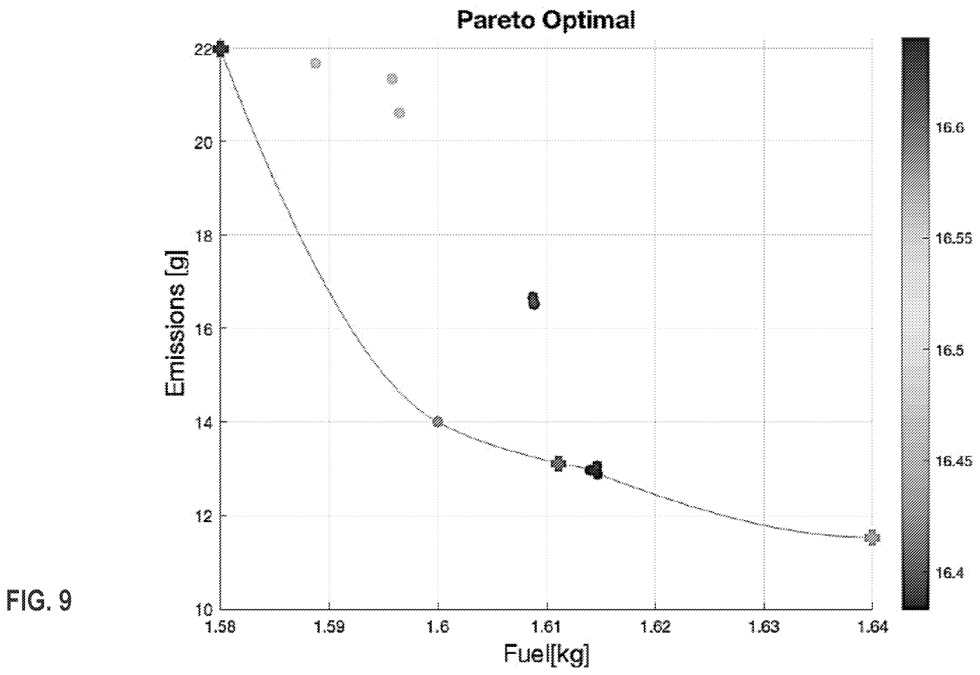

In some implementations, these 3 cases are not chosen randomly. Instead, the cases can be selected from the Pareto front in FIG. 9. The term Pareto optimal is used for the solution of multi-objective problem in which one objective can never be improved without sacrificing the other solution. The solution on Pareto front shifts towards lower emissions with a compromise on fuel consumption. The third dimension is battery energy kWh) which is the artifact of fuel consumption hence most important parameters are fuel consumption and emissions in the example case for a Pareto optimal solution. From FIG. 9 it can be observed that the top left corner has minimum fuel consumption but at the expense of maximum emissions i.e., “case C” explained herein. The right most point on the Pareto front has minimum emissions but that comes on the expense of maximum fuel consumption i.e., “case A.” The middle point on the Pareto optimal front shows a compromised solution between the fuel and the emissions. All other solutions which are not on Pareto front are inferior solutions.

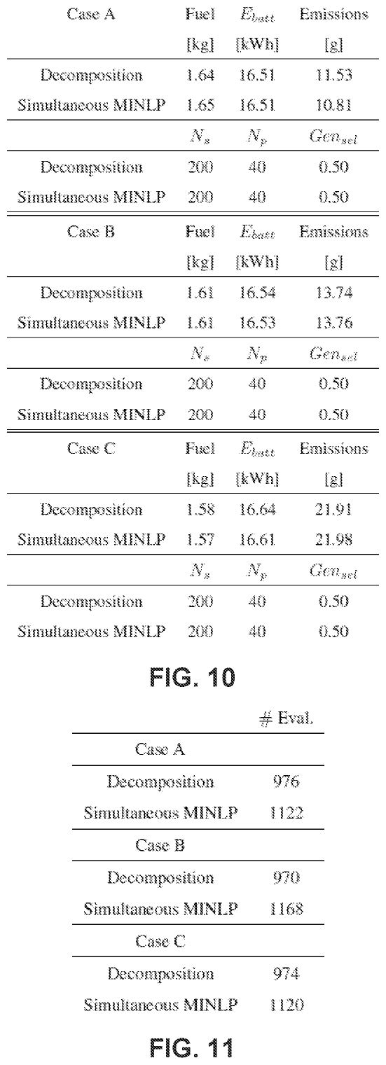

FIG. 10 shows fuel (kg), battery energy (kWh), and emissions (grams) for all cases. The results obtained with the simultaneous (MINLP) are very close to those obtained with the decomposition-based scheme. As expected, the fuel consumption is lowest in Case C in which the only objective is to optimize for minimum fuel (α_{f}=1). On the other hand, fuel consumption is highest in Case A in which α_{f}=0.

As shown in FIG. 10, in all cases the selected genset is the smallest and the selected battery is the largest (Nₛ=200 and Nₚ=40). This is expected since the cost function Eqn. (22) does not consider the investment cost of the components, but only the operating cost related to the energy consumption. In addition, since genset on/off control is not implemented in this problem, selecting the smallest engine will minimize fuel consumption during idling. The number of objective function evaluations is reported in FIG. 11. It is remarkable to note that in all three cases the average improvement in computational time by solving with decomposition-based scheme is approximately 15% as compared to simultaneous (MINLP), which proves that decomposition-based scheme can outperform simultaneous scheme as the complexity of the problem grows.

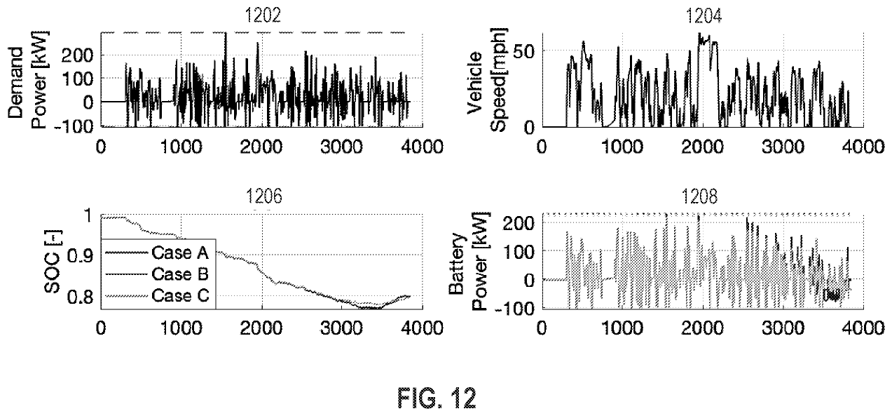

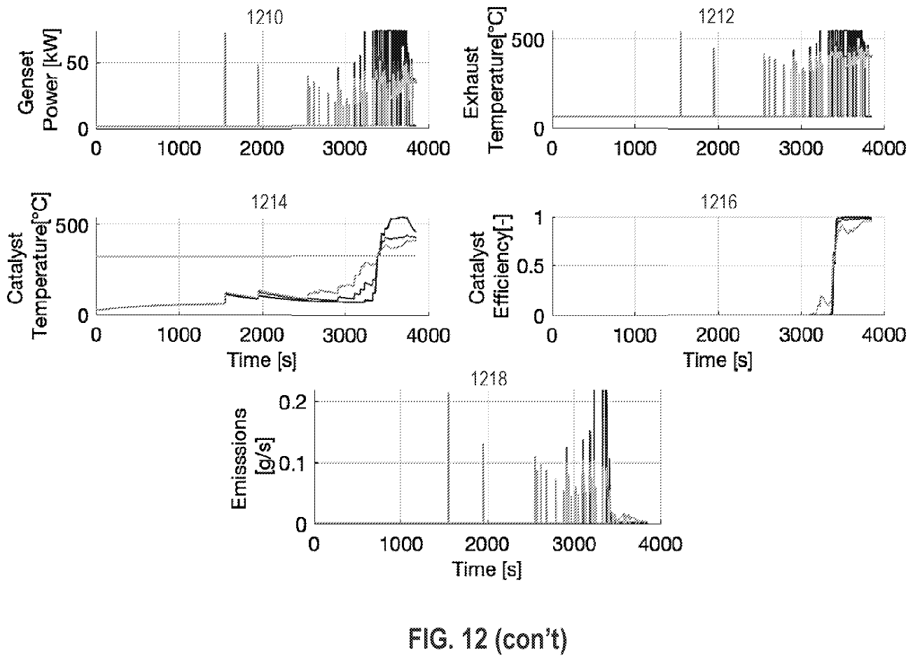

The results of stage 3 are also presented in terms of time-varying variables in FIG. 12. The plots in FIG. 12 allow comparisons of the solutions of the three cases in terms of states and inputs trajectories, showing the impact of the cost function on the energy management strategy of the powertrain. FIG. 12 shows results for decomposition-based scheme. FIG. 12 includes plots of power demand 1202, drive cycle 1204, state of charge 1206, battery power 1208, genset power 1210, exhaust gas temperature 1212 catalyst temperature, 1214, catalyst conversion efficiency 1216, and tailpipe emissions 1218.

From FIG. 12, it can be seen that the behavior is the same for all cases in the first half of the cycle, in which the powertrain is operated mostly in charge-depleting mode (only the battery is used to power the traction motor) and the range-extender engine of the genset is kept at lowest power, i.e., idling, since it cannot be turned off. Indeed this kind of operation can be optimal for fuel consumption and emissions reduction objectives. In the second half of the drive cycle the genset must provide power and energy to assist the battery and allow the vehicle to complete the mission. In this part of the cycle the study shows how different weights on the different objectives can affect the optimal control inputs and the state trajectories. Genset power 1210 in FIG. 12 shows that when minimum fuel is the only objective (Case C, green line), the genset is operated for longer duration but at lower powers, which results in lower fuel consumption, as already show in FIG. 10. On the other hand, when emissions are the only objective (Case A), then the operation of the genset is concentrated in the last part of the drive cycle, with higher power levels. This allows to quickly reach the catalyst light off-temperature (horizontal line in plot 1214 and bring the conversion efficiency to its maximum (catalyst conversion efficiency 1216). Conversely, in Case C, the genset operates for a significant amount of time with low catalyst temperature, thus low conversion efficiency. Also note in state of charge 1206 that in Case A the SOC reaches lower values, meaning that full electric operating mode is kept for a longer duration in order to have lower emissions, but this translates in more energy that will be needed from the fuel to recharge the battery to respect the final condition of SOC_{f}=0.8. Finally, Case B, in which all terms in the objective function are non-zero, shows an intermediate solution, which trades-off some fuel consumption to reduce emissions. For more insight, the energy analysis, which details the energy flows within the powertrain components, is detailed in FIG. 15 for all three cases.

Energy flows calculated from the energy analysis are helpful to understand the effectiveness of weights in the cost function. As shown in FIG. 15, the total positive energy demand (which is the sum of demand to overcome aerodynamic, rolling, grade and inertial losses) is (a) the same in all the three cases, but depending upon the weights in the objective function, the energy flows in the powertrain will change. As Case A is the extreme case for emissions, catalyst efficiency is prioritized over genset efficiency, which leads to higher fuel consumption and lower genset efficiency, but higher catalyst efficiency and lower emissions. As already mentioned, to respect the final condition of SOC_{f}=0.8, at some point the genset must charge the battery. The most efficient genset operation is the one which directly powers the wheels instead of charging the battery. Therefore in Case C, in which the only optimization objective is minimum fuel consumption, the genset energy consumption during traction is not the highest but the fraction of this power sent to wheels directly is maximum as compared to other two cases. On the other hand, in Case A genset energy consumption during traction is the highest but the fraction of this power that is directly sent to the wheels is minimum. Such an operation is required to maintain higher catalyst temperatures and efficiencies. Battery discharging during traction can only be reduced when more energy is provided by the genset, which minimizes the overall genset losses. Accordingly, in Case C battery discharging during traction is minimum, whereas it is maximum in Case A.

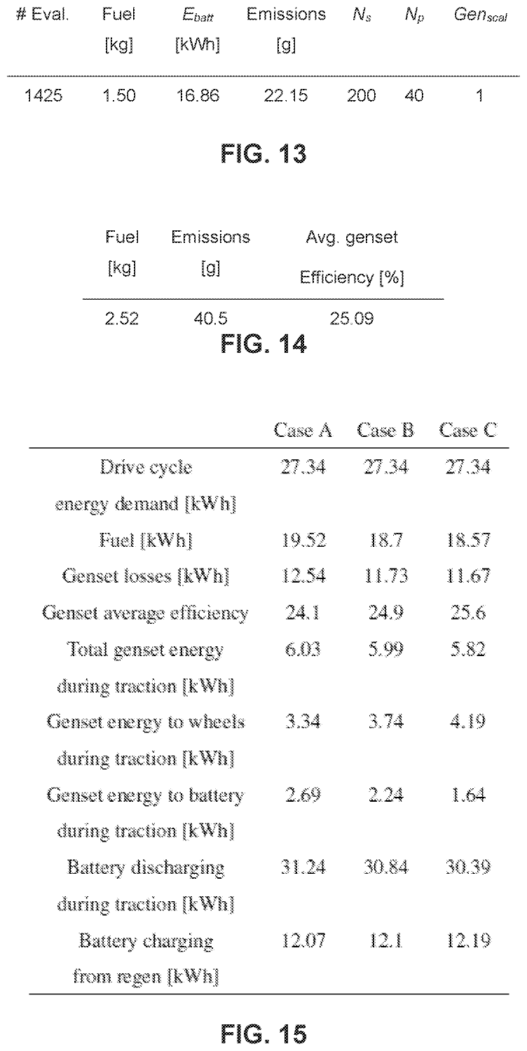

As described herein, stage 4 can include all types of optimization variables: two states (SOC and T_{cat}), one continuous control input (P_{gen}) and one integer-valued control input (genset on/off), and three design parameters (Nₛ, Nₚ, and Gen scal). In addition, the objective function includes all three terms in Eqn. (22). Since the final stage problem is only solved using decomposition-based scheme, the final cost function is the one in Eqn. (24). The problem is decomposed by using one sub-problem for the genset to solve for the on/off control input. The results are presented in FIG. 13.

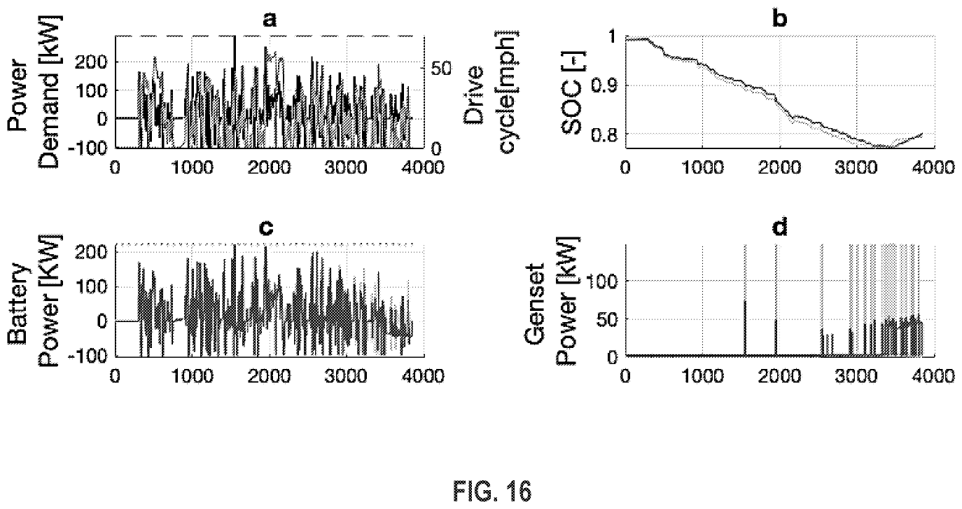

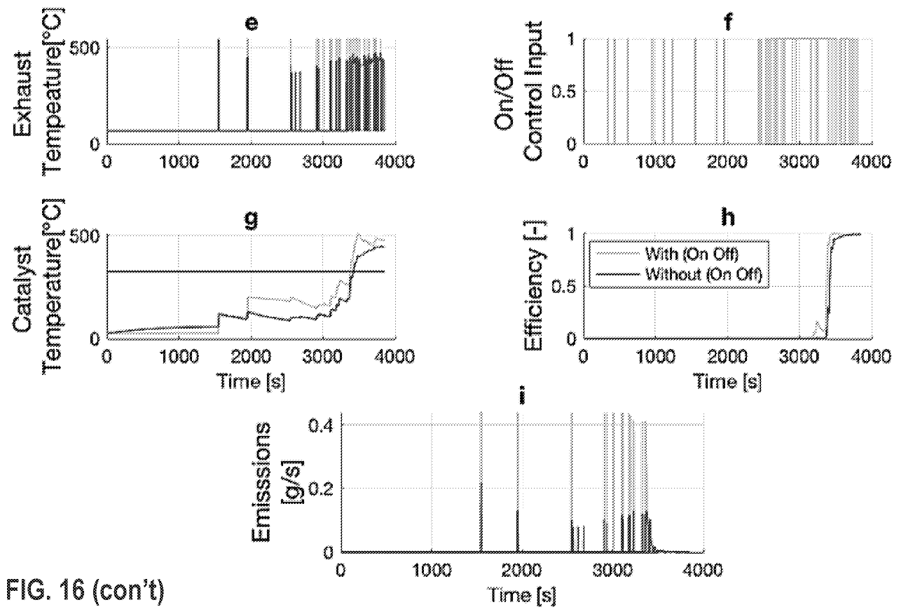

Also in this case, the results are presented in terms of time-varying variables in FIG. 16. It can be observed that with the introduction of genset on/off control, the additional fuel cost associated with idling can be eliminated. However, turning off the genset will cause cooling of the after-treatment system and a reduction of the catalyst conversion efficiency, hence more emissions. To maintain the thermal response of the catalyst while reducing fuel, a larger genset is selected (Gen_{scal}=1) and operated at higher powers. As a result, fuel consumption is decreased by 6%, but the emissions are increased because of the selection of the larger genset and engine on off operation.

If the results in FIG. 13 for the multi-objective multi-variable co-optimization problem are compared to results obtained from a baseline sequential “design-first-then-control” optimization approach (see FIG. 14), fuel consumption reduced to 1.5 kg from 2.5 kg and emissions are reduced to 22.15 g from 40.5 g. These improvements are not trivial as this difference is not just a consequence of the optimized parameters. The co-optimization helps to improve the individual efficiencies of the components and increase regeneration from brakes. For example, genset average efficiency is increased by 3.7% and braking energy recovery is increased by 15% as compared to dynamic optimization problem. Similarly, for stage 3 (in which the genset cannot be turned off), comparing the results to the baseline solution, the improvements are still remarkable: genset average efficiency is increased by 1% and fuel consumption reduced to 1.6 kg from 2.5 kg. Also, the computational performance of decomposition based has significant improvement with the increase in complexity as compared to simultaneous (MINLP). For stage 3 problem decomposition based scheme has 14% less computational as compared to simultaneous (MINLP). Therefore, it appears how the sizing and selection of the powertrain components creates the opportunity for more efficient energy management when the two aspects are cooptimized and also it is evident that computational performance of decomposition-based scheme improves as compared to simultaneous-based scheme with the increase in complexity.

FIG. 16 illustrates example stage 4 results including power demand and drive cycle; state of charge; battery power; genset power; exhaust gas temperature; on/off control input; catalyst temperature; catalyst conversion efficiency; and tailpipe emissions.

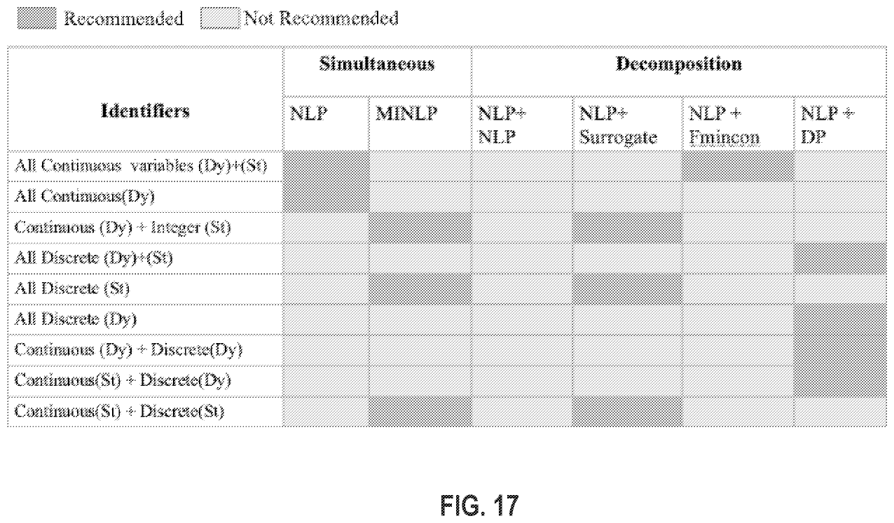

An example decision matrix, shown in FIG. 17 is illustrated, summarizing the selection criteria from cooptimization schemes to solve different problems depending on the type of variables used and problem complexity. The decision matrix has been populated based on the results and the trends observed in herein. In FIG. 17 Dy and St refer to dynamic and static variables, respectively. Starting from the problem's variables, the matrix can be used to assist to find the most suitable coordination scheme. While selecting the coordination scheme the complexity of the problem should be considered. For instance, if the problem contains all continuous variables (first row in the table), either dynamic, static or both, then the best starting point would be simultaneous scheme with NLP if the problem is simple, whereas decomposition-based scheme with NLP+Fmincon if the problem is complex. Similarly, if the optimization variables are both continuous (dynamic), and integer-valued (dynamic), then the best approach is to start with decomposition-based scheme (NLP/MINLP+DP). The rest of the combinations can be used intuitively by understanding the nature and number of the optimization variables.

In this study a decomposition-based framework is developed that uses ATC to decompose the full horizon complex mixed integer non-linear problems into sub-problems and then solved iteratively to obtain system level optimal solution. Implementations of the present disclosure can decouple different kind of variables enable us to use the best solver depending on the kind of variables sub-problem have e.g., DP was used to handle discrete dynamic variables which always remained problematic, surrogate was used to handle discrete static variables and IPOPT or BONMIN in CasADi are used to handle continuous variables. Moreover, numerical results of decomposition-based scheme are comparable with simultaneous based scheme. The computational performance of decomposition-based scheme with complex problems can be better than simultaneous-based scheme. As selection of the appropriate coordination scheme and solver can effect the quality of solution and computational cost hence based on the learning's from the study a decision matrix is disclosed to facilitate the decision on choice of solver and coordination scheme based on the kind and quantity of variables for a given problem. Implementations of the present disclosure can also include dedicated control for emission reduction can be included to improve tailpipe emissions. Also, the cost function can be modified to include the investment cost for the different components, which will impact the decision of component sizing and selection.

### Example 2

The transportation sector is responsible for more than 29% of greenhouse gas (GHG) emissions [1A, 2A] and over 55% of total NOx emissions in the U.S. [3A]. Largest contributors of NOx pollutants are commercial medium and heavy duty trucks 4. Class 4-8 trucks are only 4% of the number of U.S. on-road vehicles, yet they represent a quarter of the annual vehicle fuel use [5A]. In response, the developed world sees increasing purely electric vehicles on the road but the benefits of hybrid electric vehicles (HEV) which combine the pros of electric and conventional vehicles together still arguably outweigh. HEVs are known for their significant low-carbon usage of up to 68% compared to conventional fuel vehicles on real-world driving cycle, that is representative of most city activities [6A]. Owing to the complex nature of hybrid electric powertrain, research on its energy management strategies is a growing research area. Due to the diverse scope of the optimization variables, complex formulations that it entails, and intricate interactions between the powertrain subsystems, it becomes involved to simultaneously optimize all variables to get a comprehensive solution. In this study, a comprehensive optimal solution is presented for a 13-state 4-control energy management case-study problem in a class-6 hybrid-electric pickup and delivery truck. Modeling of complex interactions between different powertrain subsystems is included and results for a multi-objective scenario of diesel fuel and NOx emissions minimization is presented.

The 13-state 4-control problem consists of some fast dynamics, such as battery state-of-charge (SOC), some slow dynamics like battery temperature and catalyst temperatures in after-treatment system, some discrete dynamics like gear selection and engine on/off status, and some continuous dynamics like vehicle acceleration. All of these are optimized together using the PS3 approach described herein [7A]. The PS3 algorithm is a three-step direct method of numerical optimization that uses pseudo-spectral collocation for highly accurate state estimation. Formulations imposing discontinuities, the use of real-world data maps of the engine, motor, battery, and after-treatment systems, problem stiffness, and nonlinear constraint handling make this problem challenging for any solver to optimize. Additional challenging constraints include the sustaining of battery SOC, modulation of vehicle acceleration, i.e., eco-driving, while keeping total traveled distance to be the same, and combinatorial constraints like dwell time constraints on the engine on/off status and gear selection. An example objective function involves a trade-off between minimization of overall fuel consumption and system-out NOx emissions.

There are multiple methods used to find optimal solutions, including Dynamic Programming (DP) [10A, Pontryagin's Minimum Principle [11A, convex optimization [12A, etc. Although each of these methods are effective in tackling the problem of finding the optimal powersplit for a given cost function, they come with some major drawbacks. Of the main drawbacks of PMP and DP are large computation times, requiring huge memory, and mathematical intractability to optimize a large state space that exists in complex powertrain systems. In convex optimization based energy management the fidelity of power-train models is compromised and specific to certain scenarios. The example study includes comprehensive energy management strategy for hybrid electric powertrains. For benchmarking, dynamic programming is widely used as it guarantees globally optimal solution. The example study disclosed herein looks at a large number of powertrain variables for comprehensive energy management and in-depth energy footprint analysis. So the example implementation disclosed herein uses the PS3 framework along with validated real-world powertrain system models to generate Pareto-optimal minimization of carbon (or fuel) and system-out NOx emissions.

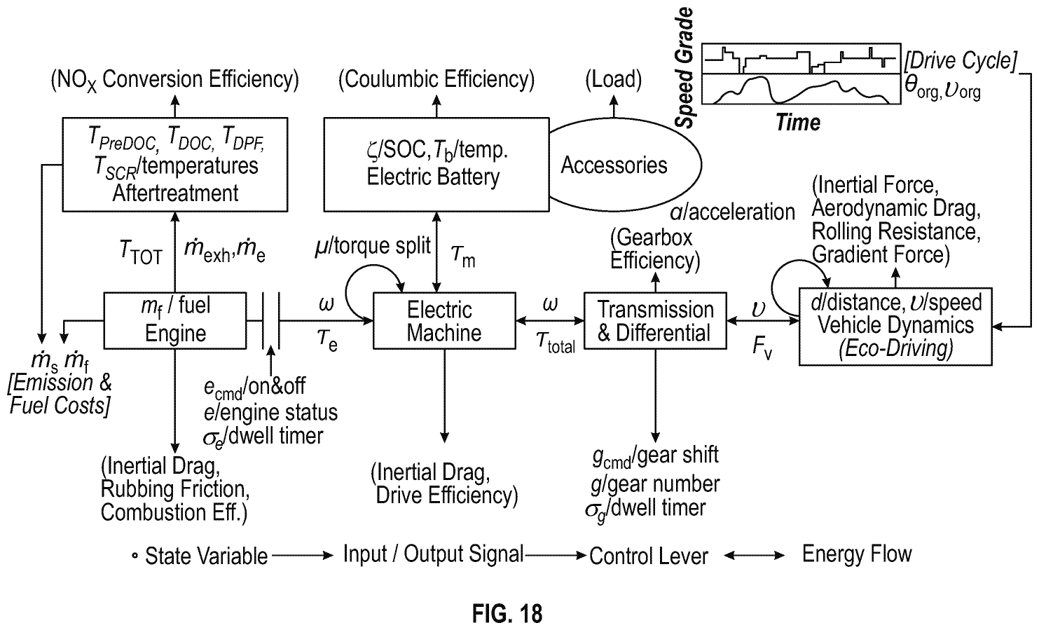

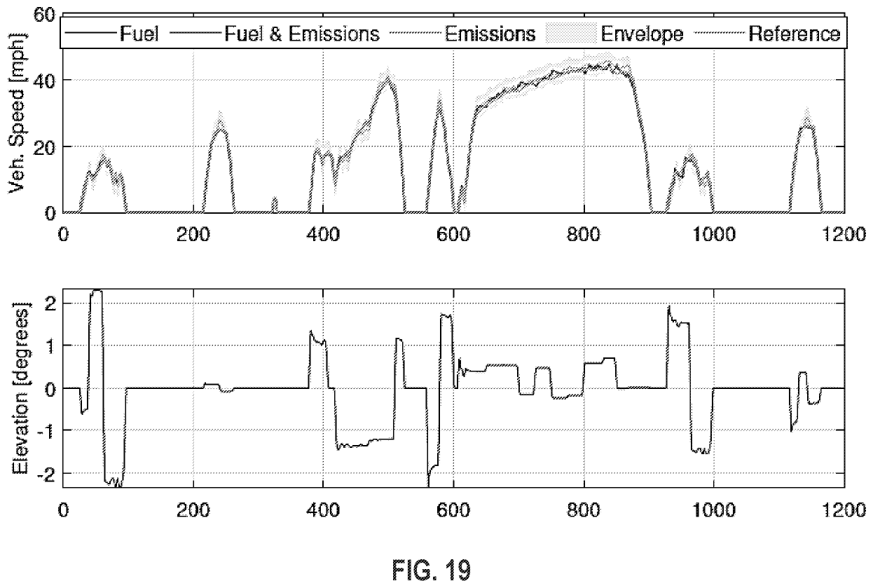

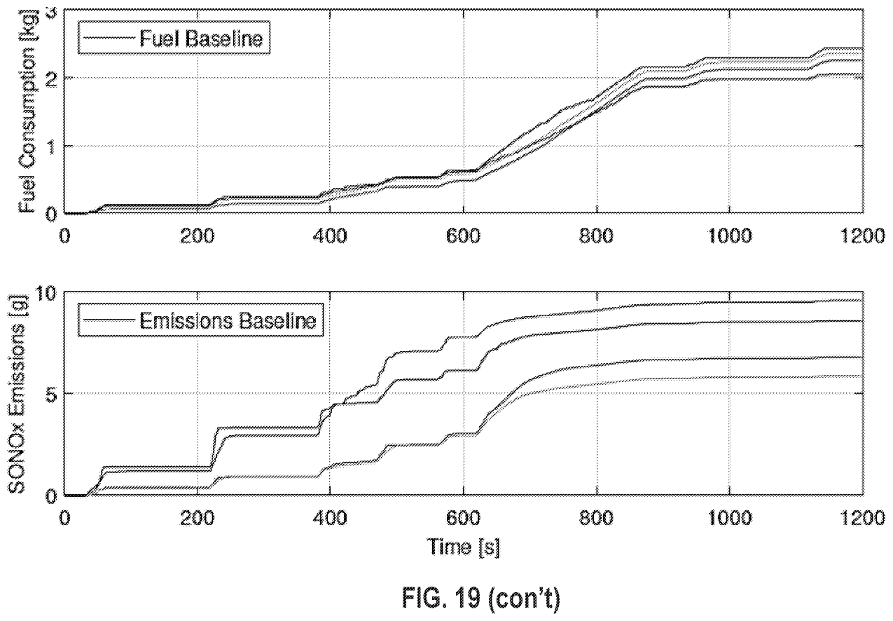

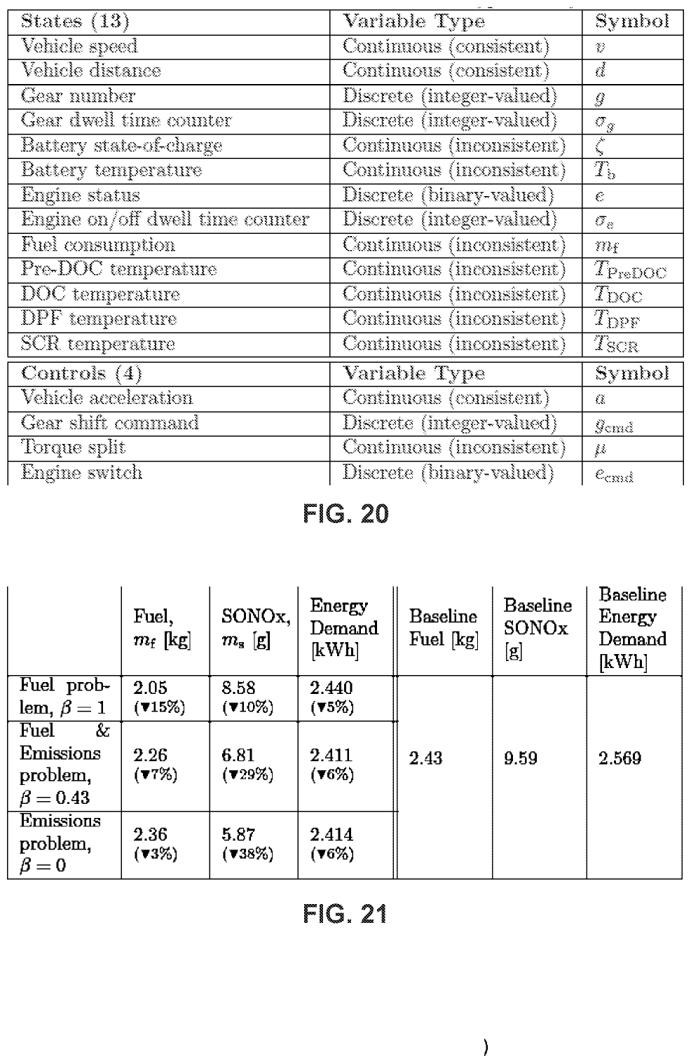

For the study, a strong P2 parallel hybrid architecture is disclosed. The application is a class-6 pick-up & delivery truck. Real-world duty cycle considered is known a priori having 20-minute duration for urban pickup and delivery application, as shown in FIG. 19. The block diagram in FIG. 18 shows the various sub-components, states, controls and other important signals described herein. In the example, there are 13 states and 4 control variables. The state variables and control variables with their types and symbols are given in FIG. 20 These variables are optimized across the three steps of the PS3 algorithm. Continuous variable being consistent or inconsistent has to do with the PS3 algorithm's step its final solution is obtained from. Modeling details that explain continuous and discrete control action and dynamics of states are described herein, and also include formal definitions of various path, box, bound, initial-value and final-value constraints that the case-study considers. Implementation details therein include explanation of the numerical programs that the three-step PS3 algorithm formulates and solves.

The cost function for the example optimization problem is divided into three cases depending on the value of the weighing factor βϵ[0,1], and is given below:

$$J := {\int }_{0}^{T} β {\dot{m}}_{f} + ( 1 - β ) {\dot{m}}_{s} dt \qquad ( 1 )$$

where T is the total drive cycle duration, m_{f} the rate of fuel consumption, and ms the system-out NOx emissions. Fuel problem minimizes only the fuel consumption, β=1. Emissions problem minimizes only system-out NOx emissions, β=0. Fuel & Emissions problem minimizes a combination of fuel consumption and system-out NOx emissions wherein β is chosen appropriately through Pareto-front study presented next.

The following examples outline the results of experiments the study performed using the example approach. A Pareto-front study is disclosed, and a comparison is performed to overall fuel consumption and NOx emissions numbers in the three problems. The study further analyzes trajectories of various dynamic state, control and other signals of those three dynamic optimization problems to establish comprehensiveness and energy footprint impact, which culminates with benchmarking energy analysis of all powertrain components. Computation time for these problems are of the order of 45-75 minutes for each problem run.

Various values of the weighting factor β were chosen to solve Fuel and Emissions problem, while keeping solver options, initial guess, error tolerances and objective scaling the same. Resulting values of total fuel consumed and NOx emissions are shown in FIG. 21. Wide spread of values owes to the fact that the algorithm may converge to local minima. The two objective function terms have different sensitivities to β and thus the two axes are scaled for finding Paretooptimal point by Euclidean norm. As a result, β=0.43 is chosen as the best compromise between fuel and emissions minimization. For faster computation time in this study, the study uses Radau collocation of degree one. The two extreme data points, β=1.00 and β=0.00 are annotated in the figure, and so is the Pareto-optimal point β=0.43 annotated.

For the three cases of β=1, β=0.43, and β=0 the study presents the primary overall metrics of respective obtained optimal solutions in FIG. 21. To compare the results with a baseline, the study solved a simpler optimization problem having only a single control variable, the torque split, on the same but coarsely modeled powertrain. A case minimizing only cumulative fuel, and another minimizing only cumulative NOx emissions were considered for the baseline. It assumes engine to be on unless vehicle is stopped and the gear sequence to be predefined by speed-dependent rules, and it operates on the reference drive cycle. In FIG. 21 the study observed that the Pareto optimal result, i.e., Fuel and Emissions problem, has 7% reduction in fuel consumption, and 29% reduction in NOx emissions compared to the best baseline solutions. Net energy demand at the wheels, which is an outcome of eco-driving control of vehicle speed can be observed to have reduced by 6% compared to the baseline. Note that due to a hard constraint set up, the total distance covered and total trip time exactly matches with the reference drive cycle for all three problems.

For fuel efficiency, the study observes that the solution of Fuel problem prefers frequent engine on/offs and higher gear in the high-power maneuver at 600-900 seconds of the drive cycle, which is where it saves most fuel. The Fuel & Emissions and Emissions problems tend to take lower gear and keep engine on in this maneuver, to raise the catalyst temperatures for better pollutant reduction. However, the initial 300 seconds are where the Fuel problem consumes most fuel by operating at higher engine torque to charge the battery up, where the Fuel & Emissions problem saves more by turning engine off frequently. The cumulative fuel plot shown in FIG. 19 verifies the trend.

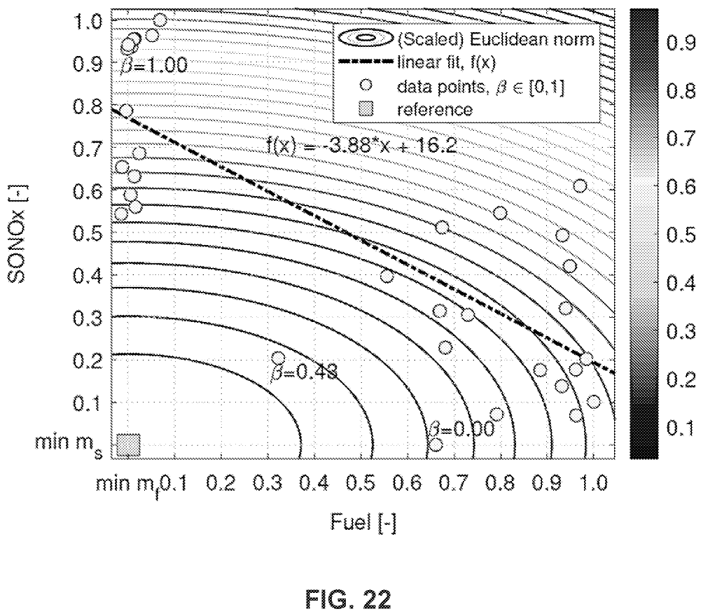

As for behavior with respect to NOx emissions, various temperatures and other engine-out signals are depicted in the same figure. Even though temperature of aftertreatment system's SCR block has the primary role in efficient conversion of NOx pollutants, yet highest SCR temperature does not necessarily guarantee overall reduction in system-out NOx because of dependence on other terms of engine exhaust flow rate and engine-out NOx. In the plots the study observes that the SCR temperature is usually always lower for Fuel & Emissions problem compared to the other two solutions, but because of engine-out NOx and exhaust mass flow rate also being consequently lower (especially in earlier cold part of drive cycle), the SCR's NOx conversion efficiencies are higher on average. Specifically, there are dips in NOx efficiency in earlier half where exhaust flow rates shoot up due to high power demand from engine. Thus, the Fuel & Emissions problem does relatively better emission reduction compared to Fuel problem, despite having slightly lower SCR temperature. Cumulative SONOx plot shown in FIG. 19 verifies the trend. FIG. 22 illustrates an example pareto-front study showing data points for various values of p, a linear regression fit, and Euclidean distance contours from a reference point where the axes are normalized between 1.0 and minimum mf or ms.

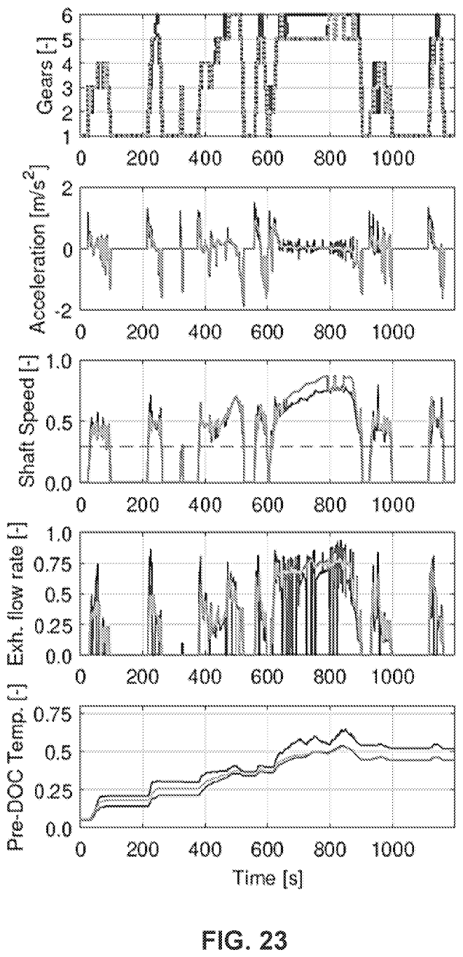

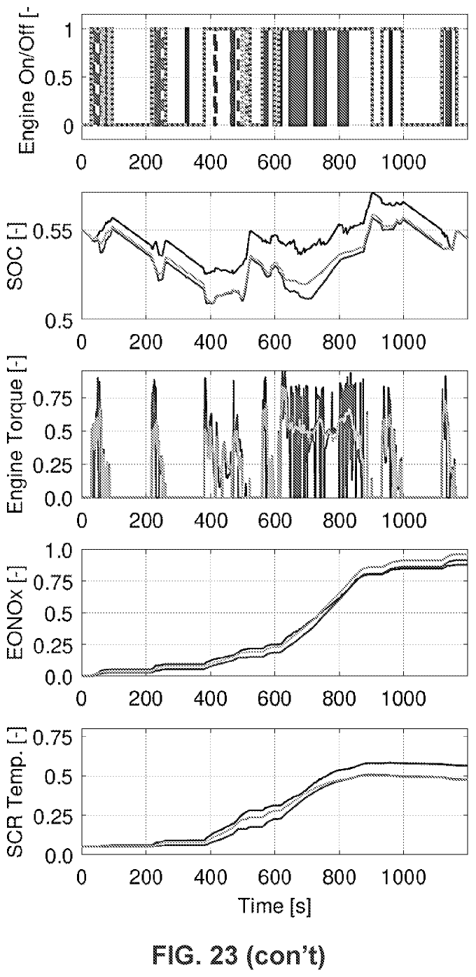

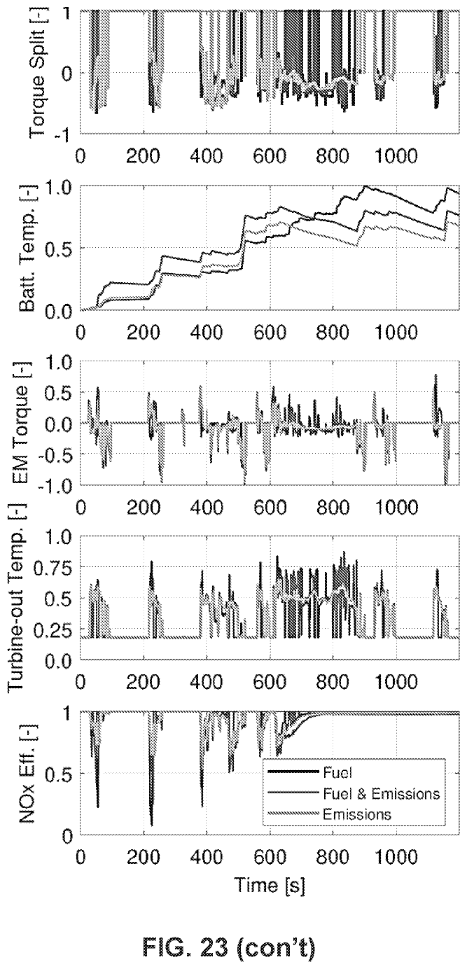

FIG. 23 shows resultant trajectories of various time-series signals obtained after solving the three optimal control problems. To take into account electric energy usage, a charge-sustaining constraint on battery SOC to have its initial and final values at 55% is imposed. Also, minimum dwell time constraints on gear shifting and engine on/off switching are imposed as well to avoid chattering and improve drivability.

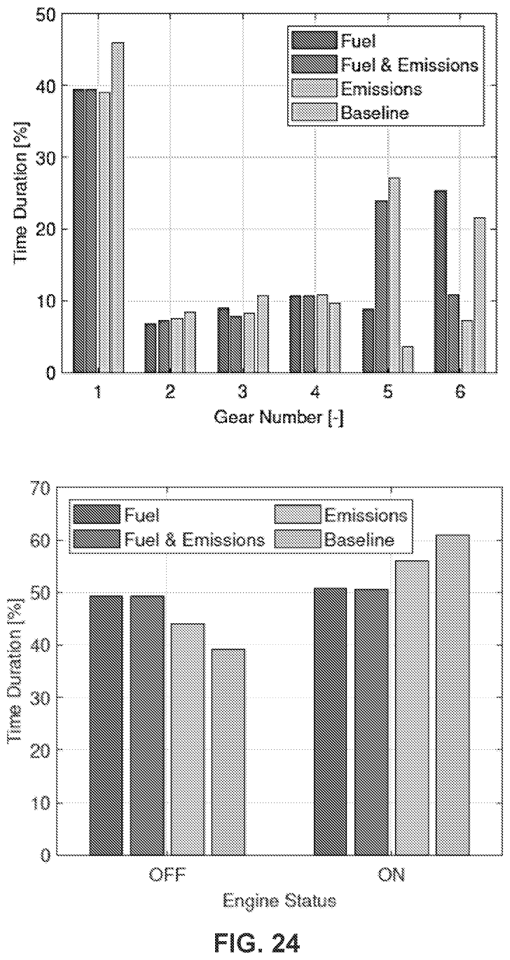

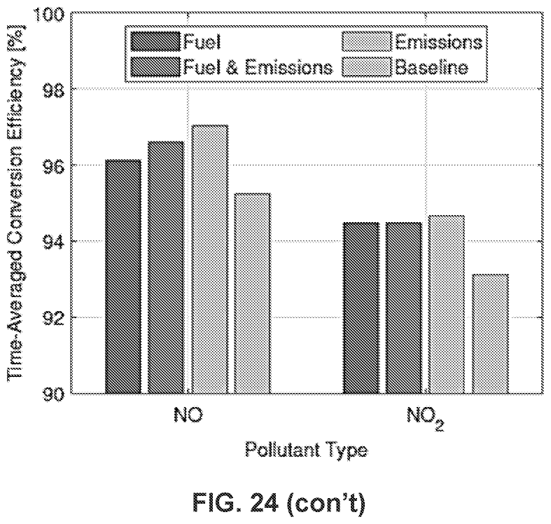

FIG. 24 shows bar charts of cumulative behaviors of the gear selection control, engine on/off control and the performance of average NOx conversion efficiencies. The study observes that the Fuel & Emissions problem solution tends to prefer lower gears overall compared to the Fuel problem in order to keep lower NOx emissions at the cost of higher fuel. On the other hand, the Emissions problem has longer engine on duration (56%) compared to the other two (50.6% and 50.7%). Thus, keeping engine off for long, especially in the first half of the duty cycle, allows the Fuel & Emissions problem to save more on fuel compared to the emissions problem. Time-averaged NOx conversion efficiencies conform to the objective functions of the three respective problems. Note that in the aftertreatment emissions model the study assumed equal ratio of NO and NO₂ molecules, and have not considered ammonia storage nor catalytic pressures. Baseline time-duration and efficiency percentages are given for reference comparison.

As described herein, this problem cannot be easily solved using the well-known global optimization benchmark algorithm, Dynamic Programming, because of its curse of dimensionality for problems of such a large number of variables. To establish the study's results for serving as a benchmark, the present disclosure includes a cumulative energy analysis of the results.

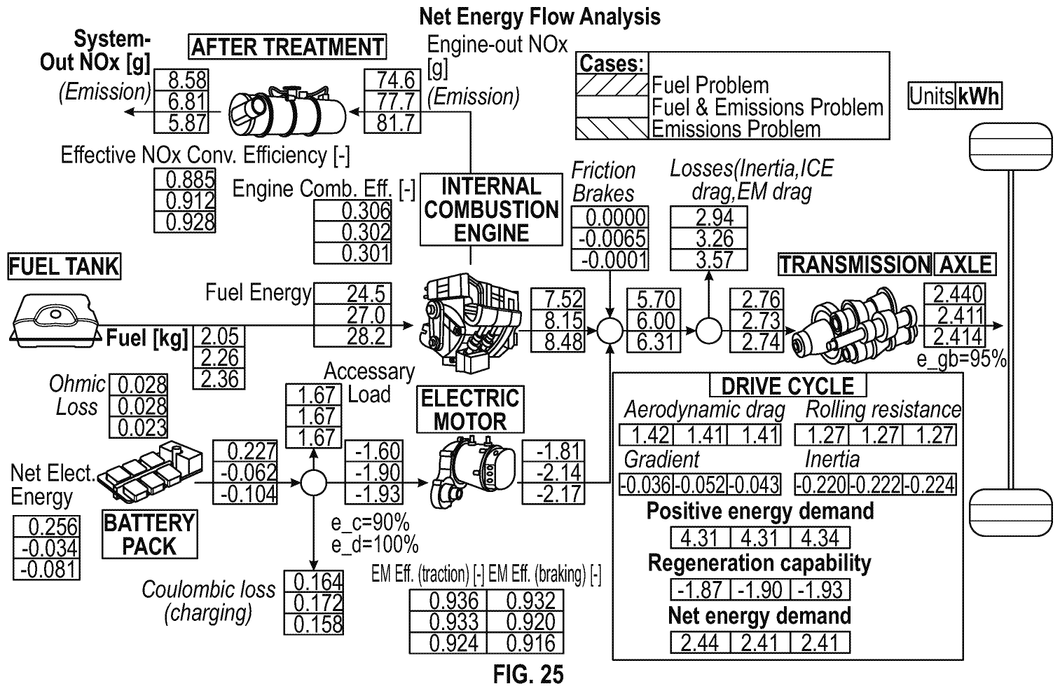

In FIG. 25 overall net-energy flow numbers are shown between various powertrain components for the three cases of problems. All boxes showing net energy are in kWh. Other terms, such as efficiency, fuel, and emissions are in their respective units as shown.

Trends can be seen in FIG. 25. In the Fuel problem, the engine's combustion efficiency (30.6%) is the highest, and net electrical energy drawn from the battery is positive, i.e., the battery is providing energy overall. Both of these observations conform to the objective of Fuel problem and strengthen the optimality of its results. The Emissions problem, is opposite in these aspects. However, Emissions problem has the largest positive energy demand (4.34 kWh) as well as regeneration capability (−1.93 kWh) in its eco-driven drive cycle. High positive energy demand leads to high engine provided energy, which indirectly improves the effective NOx conversion efficiency to 92.8% compared to the Fuel problem's 88.5%. High regeneration capability helps in more battery charging operation (−0.081 kWh), lesser Ohmic loss (0.023 kWh) and the least Coulombic loss while charging (0.158 kWh). Finally, the Fuel & Emissions problem mostly has values (orange) within the other two extremes (blue and green). This verifies the appropriate balance in Paretooptimality of fuel consumption and NOx pollutant emissions. Not only are overall fuel and emission numbers being traded off, but the component-wise efficiency, energy delivered and consumed, as well as mechanical losses are also the result of this trade-off. When comparing performance of eco-driving control, the Fuel & Emissions problem has the lowest net energy demanded at the wheels (2.411 kWh), supporting Pareto-optimality.

The extensive results and energy flow analysis establish reliability in the proposed method to serve as (close-to) optimal benchmark in real-world comprehensive and dynamic powertrain energy management problems, especially when globally-optimal Dynamic Programming fails to remain computationally tractable.

The example implementation described with respect to this example includes a comprehensive and large 13-state 4-control problem for powertrain energy management with complex interactions between the powertrain components is solved using a three-step approach, PS3. PS3 algorithm is based on the CasADi framework in MATLAB with YOP used for parsing the mixed-integer optimal control problem (MIOCP). State-of-the-art NLP solver IPOPT with HSL MA97, and MIQP solver Gurobi make up the optimization solver part of PS3.

Powertrain component models in the optimization problem capture their rich interactions for a class-6 parallel P2 hybrid electric truck. The duty cycle used is based on urban pickup and delivery operations and is 20-minutes long. The study is of MIOCP of index-1 DAE system, having path and boundary value constraints. The complex nature of the real-world validated powertrain models makes it challenging; it exhibits discontinuous dynamics (engine on/off and gear selection), combinatorial constraints (minimum dwell-time), eco-driving capability, thermal model of battery, thermal and emissions model of the aftertreatment system, various efficiency maps, and map-based mean-value engine models. All simulations are based on an offline backward simulator with apiori known drive cycle information. Detailed results are presented for three cases: Fuel optimization problem, where the objective function only minimizes fuel consumption; emissions optimization problem, where solely system-out NOx emissions are minimized; and Fuel & Emissions joint optimization problem, where conflicting objectives of fuel consumption and system-out Nox emissions are jointly minimized based on a Pareto-front study. Trajectories of various dynamic signals are analyzed to capture the influence of every subsystem (transmission, engine, electric machine, after-treatment, battery, eco-driving controller) on the cumulative energy footprint—fuel, and Nox emissions. Finally, comparative energy analysis is presented to establish the capability of serving as a benchmark optimal solution for the solved powertrain problem. In comparison to a coarsely modeled baseline solution, the Pareto-optimal result saves 7% more fuel, reduces pollutant Nox emissions by 29%, and demands 6% lower energy from the powertrain system.

In the example studied, the continuous states, with their respective models, state dynamic equations, algebraic equations and constraints pertaining to them, along with relevant maps and look-up tables are listed and explained herein.

The study included a battery model.

An 11 kWh NMC/Graphite based battery pack of 350 V nominal voltage with 90 cells in series and 6 branches in parallel is used as a non-limiting example. There are two state variables, battery SOC (and battery temperature T_{b} related to the battery model. SOC is a dimension less quantity between 0 and 1. For the electrical dynamics, the study assumes a zero-th order equivalent circuit model, and for the thermal dynamics, a first order temperature model with heat addition due to Ohmic losses is used. These dynamics are expressed in the following two differential equations:

$$\dot{ζ} = - \frac{{I}_{b}}{{Q}_{n o m}} ; {I}_{b} = - {η}_{b} [ \frac{{V}_{o c}}{2 {R}_{0}} - \sqrt{{( \frac{{V}_{o c}}{2 {R}_{0}} )}^{2} - \frac{{P}_{b}}{{R}_{0}}} ] , \qquad ( 2 )$$

$${\dot{T}}_{b} = - \frac{1}{{m}_{b} {c}_{b}} ( {h}_{b} {A}_{b} ( {T}_{b} - {T}_{a m b} ) + {I}_{b}^{2} {R}_{0} ) \qquad ( 3 )$$

where, the constants are as follows: Qₙₒₘ is the battery capacity (31 Ah), η_{b} is Coulumbic efficiency (90% for charging, 100% for discharging), h_{b} is heat transfer co-efficient due to convection with ambient temperature (assumed constant), A_{b} is outer battery pack surface area, mb is battery pack mass, c_{b} is battery pack specific heat capacity, and T_{amb} is ambient temperature. The equivalent circuit model internal resistance, R₀ is assumed to be a function of SOC, ξ; and the V_{oc}(ξ) is the open-circuit voltage which is SOC-dependent. These dynamics are essentially driven by the battery power, Pb which is as follows:

$${P}_{b} = {P}_{m} + {P}_{aux} ,$$

where Pₘ is the mechanical power delivered to/from the electric machine and Pₐᵤₓ is the constant accessories load on the battery pack. Other box constraints are defined as,

$$0.3 \leq ζ \leq 0.8 , \qquad ( 4 )$$

$$0 \leq {T}_{b} \qquad ( 5 )$$

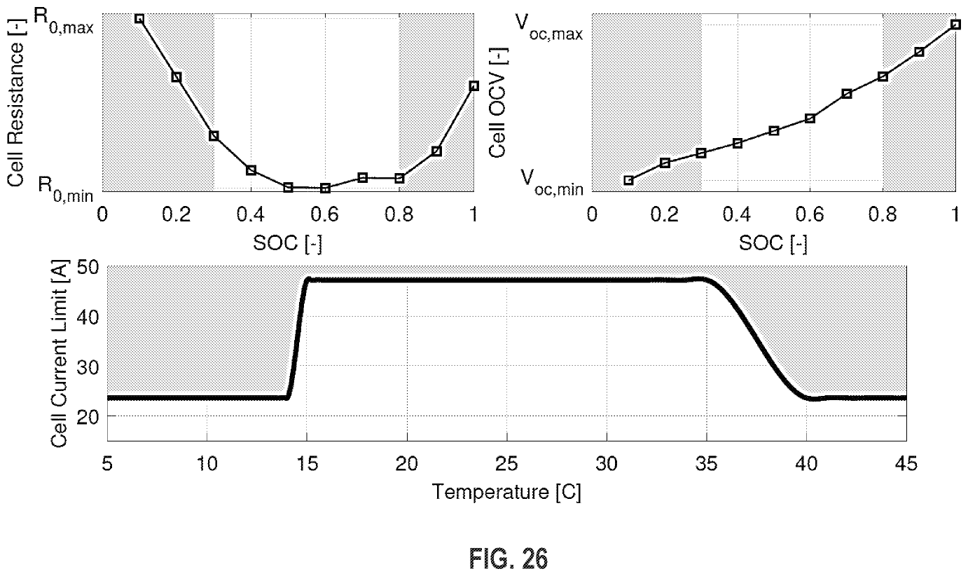

The maximum and minimum current limits I_{b,max} and I_{b,min} are given as a function of the battery temperature T_{b}. The study uses a spline interpolation for battery temperature dependence of battery current limit to retain smoothness. This is given in FIG. 26.

$${I}_{b , min} ( {T}_{b} ) \leq {I}_{b} \leq {I}_{b , max} ( {T}_{b} ) \qquad ( 6 )$$

In FIG. 26 the study shows the internal resistance of a battery cell as a function of SOC, the open-circuit-voltage form with respect to SOC. The charge sustaining constraint is assumed on SOC for the complete drive cycle, this means that the initial and the final charge over the complete drive cycle has to be the same. This is set to be equal to 0.55. If T is the final time the charge sustaining constraint is formulated as:

$${ζ}_{0} = {ζ}_{T} = 0 \text{.55} \qquad ( 7 )$$

In example vehicle dynamics block, there are two state variables, speed v and distance d, and one control variable acceleration a. Time-varying input to the vehicle dynamics (eco-driving) block is a reference drive cycle, v_{org}(t) that the ecodriving vehicle needs to follow within certain bounds while satisfying stop-at-stop constraint and same-total-distance constraint. The stop-at-stop constraint is that whenever the reference vehicle is stopped, the eco-driven vehicle is to be forced stopped as well v(t)=0. This path constraint essentially captures occurrences of road stop signs and red-traffic lights. It is formulated as:

$$\vert {v}_{o r g} - v \vert \leq 1.39 [ \frac{m}{s} ] , \qquad ( 8 )$$

$$v = 0 if {v}_{o r g} = 0 \qquad ( 9 )$$

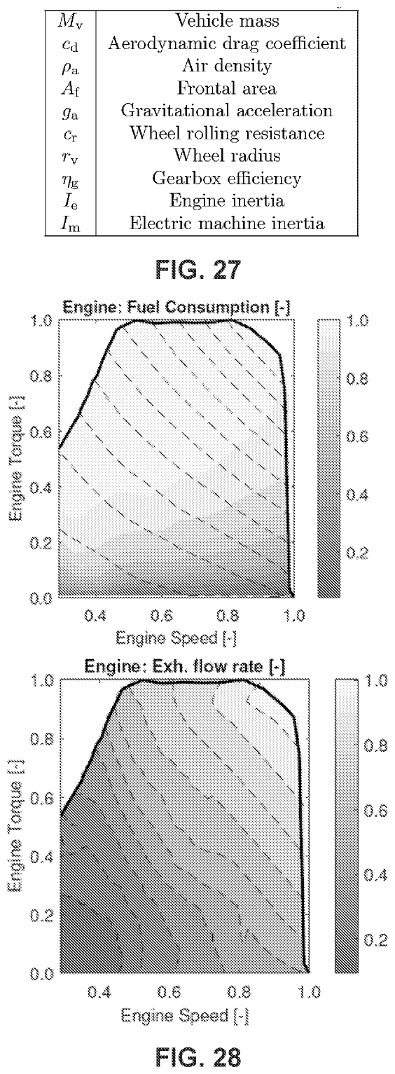

The same-total-distance constraint refers to the boundary value constraint on the state variable distance, d that the total distance covered by eco-driven vehicle must be the same as that covered through reference drive cycle. This is given as a boundary constraint,

$${d}_{T} = {d}_{o r g , T} , \qquad ( 10 )$$

where, d_{org,T} is the total distance travelled by the reference vehicle. Connected to the vehicle dynamics block is the differential and transmission block, for which the input is a gear profile g. A 6-speed auto transmission model is used having a constant gearbox efficiency η_{g}. Longitudinal vehicle dynamics and point-mass wheel model is used for simplicity. The study assumes road loads of aerodynamic drag, rolling resistance, inertial drag and gradient forces acting against the supplied power by the propulsion system. Hence, the following kinematic and dynamic equations are part of these blocks:

$$\dot{v} = a , \qquad ( 11 )$$

$$\dot{d} = v , \qquad ( 12 )$$

$${F}_{v} = {M}_{v} a + \frac{{c}_{d} {ρ}_{a} {A}_{f}}{2} {v}^{2} + {M}_{v} {g}_{a} {c}_{r} cos ( {θ}_{org} ) + {M}_{v} {g}_{a} sin ( {θ}_{org} ) , \qquad ( 13 )$$

$$ω = \frac{{γ}_{g} v}{{r}_{v}} \qquad ( 14 )$$

$$α := \dot{ω} = \frac{{γ}_{g} a}{{r}_{v}} \qquad ( 15 )$$

$${τ}_{g} = \frac{{F}_{v} {r}_{v}}{{γ}_{g} {η}_{g}^{s i g n ( {F}_{v} )}} \qquad ( 16 )$$

$${τ}_{total} = \{ \begin{matrix}{τ}_{g} + {τ}_{e , drag} + α ( {I}_{e} + {I}_{m} ) & if e = 1 \\ {τ}_{g} + α {I}_{m} & if e = 0\end{matrix} \qquad ( 17 )$$

where, F_{V} is total traction force at wheels. θ_{org} is the road-grade which is displayed below. γ_{g} is the gear ratio for gear number g. τ_{g} is the driveshaft torque after the transmission, τ_{e,drag} is the motoring torque of the engine i.e. rubbing friction and τₜₒₜₐₗ is the total torque that the combination of motor and engine needs to provide. Some assumptions here are whenever the vehicle is stopped, v=0, the demand torque τₜₒₜₐₗ is set to take value zero. The demand torque is given by the above mentioned equations for e=0 case and e=1 case separately when v≠0. Other constants are given in the table shown in FIG. 27

Finally, some box constraints on the state and control variables are:

$$- 2 \leq a \leq 1.5 [ m / {s}^{2} ] , \qquad ( 18 )$$

$$0 \leq v \leq 25 [ m / s ] , \qquad ( 19 )$$

The reference speed profile v_{org} and the elevation profile θ_{org} used in the problem is given in FIG. 19.

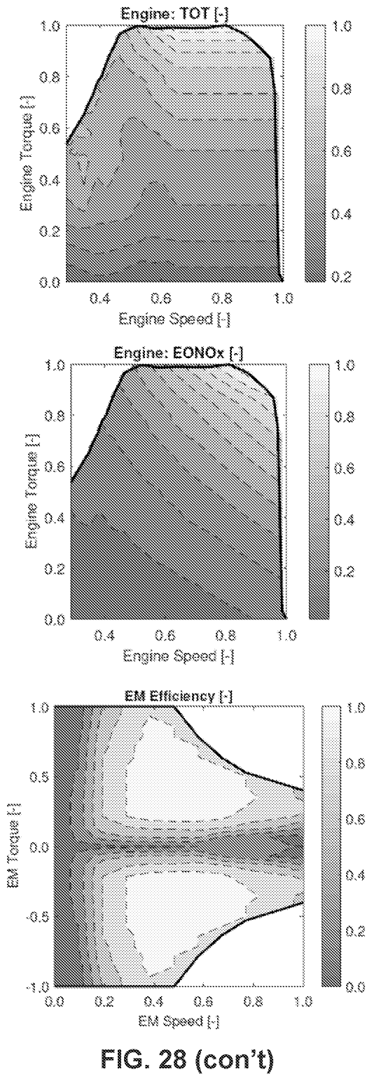

A 90 kW electric machine (EM) is used assumed to always operate in continuous mode for the experiments. A scaled diesel internal combustion engine (ICE) rated with 220 hp is used. The efficiency of mechanical-to-electrical (or electrical-to-mechanical) conversion in the EM is denoted by ηₘ(ω, τₘ) which is given as a 2-D look-up table of the operating points of shaft speed ω and EM torque τₘ. Similarly, internal combustion engine map for fuel consumption \dot{m}_{f}, the exhaust flow rate \dot{m}ₑₓₕ, the turbine-out temperature T_{TOT}, and the engine-out NOx me are also given as 2-D look-up tables of shaft speed ω and engine torque τₑ. These normalized maps are depicted in FIG. 28, When the driveshaft speed is below engine idle these four signals take some minimum values depending on engine being switched on or off.

$${\dot{m}}_{f} = ℱ ( ω , {τ}_{e} ) , \qquad ( 20 )$$

$${\dot{m}}_{e x h} = ℳ ( ω , {τ}_{e} ) , \qquad ( 21 )$$

$${T}_{T O T} = 𝒯 ( ω , {τ}_{e} ) , \qquad ( 22 )$$

$${\dot{m}}_{e} = 𝒩 ( ω , {τ}_{e} ) \qquad ( 23 )$$

The time-varying signals related to these subsystems are governed by algebraic relationships or through look-up tables. The torque split control variable, μ, relates the engine, τₑ and EM, τₘ torques to the demand torque after transmission, τₜₒₜₐₗ. Similarly, the mechanical power delivered to/from electric machine, Pₘ algebraically relates with electric machine (EM) torque through efficiency term, ηₘ(ω, τₘ). Note that engine drag is accounted for by adding it in the demand torque expression τₜₒₜₐₗ as explained in herein. Through experimentation with the solver, making mf a state variable aids in convergence. These algebraic relationships for both traction and braking phases are summarized as follows:

$$Traction : \{ \begin{matrix}{τ}_{e} = \{ \begin{matrix}( 1 - μ ) {τ}_{total} & if ω > {ω}_{idle} \\ 0 & if ω \leq {ω}_{idle}\end{matrix} \\ {τ}_{m} = \{ \begin{matrix}{μτ}_{total} & if ω > {ω}_{idle} \\ {τ}_{total} & if ω \leq {ω}_{idle}\end{matrix} \\ {P}_{m} = \frac{{ωτ}_{m}}{{η}_{m}}\end{matrix} \qquad ( 24 )$$

$$Braking : \{ \begin{matrix}{τ}_{e} = 0 \\ {τ}_{m} = max \{ {τ}_{total} , {τ}_{m , min} \} \\ {P}_{m} = {ωτ}_{m} {η}_{m}\end{matrix} \qquad ( 25 )$$

When the vehicle is braking, i.e. τₜₒₜₐₗ<0, the example assumes that EM operates at maximum recuperation energy to charge the battery which is illustrated as max{τₜₒₜₐₗ, τ_{m,min}}.

As for some inequalities, the engine and EM torques are limited at their minimum and maximum curves, which are given by shaft-speed dependent 1-D look-up tables (shown in FIG. 28). The shaft-speed is constrained by the maximum engine speed at redline:

$$0 \leq ω \leq {ω}_{max} , \qquad ( 26 )$$

$${τ}_{m , min} \leq {τ}_{m} \leq {τ}_{m , max} , \qquad ( 27 )$$

$${τ}_{e , min} \leq {τ}_{e} \leq {τ}_{e , max} , when e = 1 , \qquad ( 28 )$$

$${τ}_{e} = 0 , when e = 0 \qquad ( 29 )$$

Torque split does not affect the τₑ and τₘ in the following cases:

When the engine is off, e=0;

When the driveshaft speed is below engine idle, ω≤ω_{idle};

During the braking phase, τₜₒₜₐₗ<0.

For these cases the study assumes μ to be equal to 1. This is because during these cases, the engine torque τₑ=0.

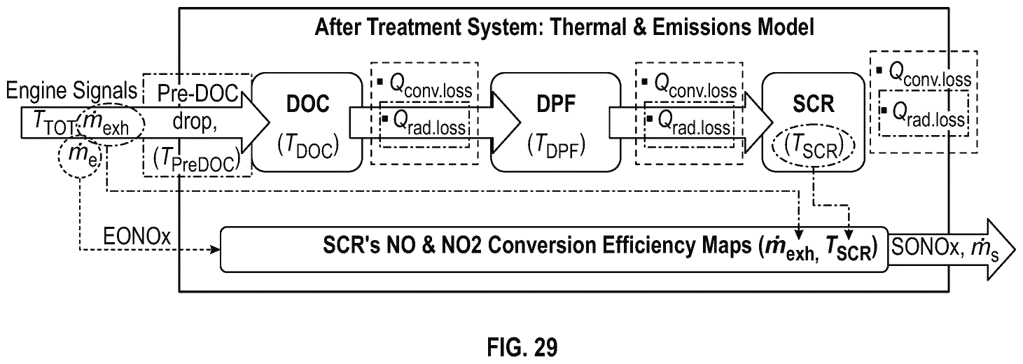

The example after-treatment system consists of the Diesel Oxidation Catalyst (DOC), Diesel Particulate Filters (DPF), and selective Catalytic Reduction (SCR). The states associated with the after-treatment system are Pre-DOC temperature, DOC temperature, DPF temperature and SCR temperature respectively. The initial conditions for all the four states are considered to be equal to the ambient temperature. The ambient losses are assumed to be only due to convection and radiation. Pictorially, the thermal flow is represented in FIG. 29. The state dynamic equations are given by:

$${\dot{T}}_{P r e D O C} = 0.042 {\dot{m}}_{e x h} ( {T}_{T O T} - {T}_{P r e D O C} ) \qquad ( 30 )$$

$${Q}_{i n , ( \cdot )} = {c}_{p , a i r} {\dot{m}}_{e x h} ( {T}_{( * )} - {T}_{( \cdot )} ) \qquad ( 31 )$$

$${Q}_{c onv . loss , ( \cdot )} = {h}_{( \cdot )} {A}_{( \cdot )} ( {T}_{a m b} - {T}_{( \cdot )} ) \qquad ( 32 )$$

$${Q}_{rad . loss , ( \cdot )} = {ϵσ}_{( \cdot )} {A}_{( \cdot )} ( {T}_{a m b}^{4} - {T}_{( \cdot )}^{4} ) \qquad ( 33 )$$

$${\dot{T}}_{( \cdot )} = \frac{{Q}_{i n , ( \cdot )} + {Q}_{conv , loss , ( \cdot )} + {Q}_{rad . loss , ( \cdot )}}{{m}_{( \cdot )} {c}_{p , ( \cdot )}} \qquad ( 34 )$$

Here, (⋅)ϵ{DOC, DPF, SCR} respectively. T_{(*)} is the temperature of the previous stage, i.e., if (⋅)=DOC, then the T_{(*)}=T_{preDOC} Similarly, if (⋅)=DPF then T_{(*)}=T_{DOC} and if (⋅)=SCR then T_{(*)}=T_{DPF}·Qᵢₙ is the energy entering the catalyst, Q_{conv.loss} is the loss of energy in the catalyst due to convection, and Q_{rad.loss} is the loss due to radiation. The specific heat of the SCR is a 1-D LUT of the SCR temperature. The heat transfer co-efficient c_{p(⋅)} of DOC, DPF and SCR is a function of air speed which is equal to the vehicle speed, air temperature which is equal to constant ambient temperature, respective catalyst lengths and lastly their external heating factors h_{(⋅)}. The area of the catalysts is denoted by A_{(⋅)}. The Stefan-Boltzmann constant is denoted by ϵ. The external emissivity of the catalyst is denotes by σ_{(⋅)}. The SCR's conversion efficiencies of NO and NO₂ are 2-D LUTs of SCR temperature and exhaust flow rate. The study assumes here that the density of gases is equal to density of air. The system-out NOx is the product of engine-out NOx and the conversion efficiencies. The ratio of number of molecules for nitrogen oxides is assumed to be equal

$$( \frac{NO mol}{{NO}_{2} mol} = 1 ) .$$

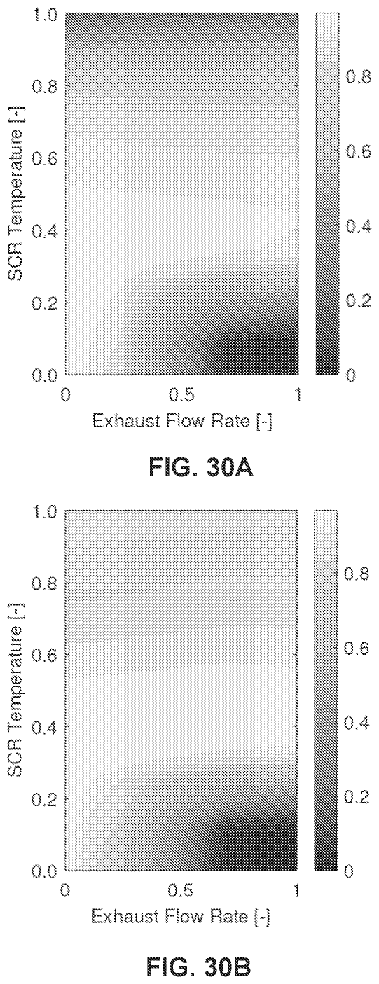

FIG. 30A-30B shows the normalized conversion efficiency maps used for both NO and NO₂. FIG. 30A illustrates normalized 2-D Maps of SCR's NOx conversion efficiencies for NO. FIG. 30B illustrates normalized 2-D Maps of SCR's NOx conversion efficiencies for NO₂.

Gear command control signal, g_{cmd} ϵ{−1,0,1}, performs instantaneous gear shifts. Gear number, g ϵ{1,2,3,4,5,6} is a state governed by its difference equation. The study imposes a minimum dwell-time constraint on gear shifts, restricting two consecutive shifts to be at least L=3 seconds apart. Due to this constraint, a counter state variable σ_{g} is required that takes note of the time between two consecutive gear shifts. The discrete-time dynamics for gears and gear dwell time counter are formulated as following with k as the time step:

$${σ}_{g} ( k + 1 ) - {σ}_{g} ( k ) = \{ \begin{matrix}1 & if {σ}_{g} ( k ) \leq L \\ 0 & otherwise \\ - ( L + 1 ) & if g ( k + 1 ) - g ( k ) = {g}_{cmd}\end{matrix} \qquad ( 35 )$$

$$g ( k + 1 ) - g ( k ) = \{ \begin{matrix}{g}_{cmd} & if {σ}_{g} ( k ) > L \\ 0 & otherwise\end{matrix} \qquad ( 36 )$$

In solving for relaxed or integer gears, the following box constraint is used:

$$1 \leq g \leq 6.5 \qquad ( 37 )$$

A similar formulation is made for engine on/off state variable, eϵ{0,1} and engine on/off switch control, e_{cmd}. As the engine status also has a minimum dwell-time constraint with Lₑ=2 seconds, a counter variable σₑ is assigned to monitor its dwell time. The formulation of discrete-time dynamics for engine status and engine start-stop counter is as follows:

$${σ}_{e} ( k + 1 ) - {σ}_{e} ( k ) = \{ \begin{matrix}1 & if {σ}_{e} ( k ) \leq {L}_{e} \\ 0 & otherwise \\ - ( {L}_{e} + 1 ) & if e ( k + 1 ) - e ( k ) = {e}_{cmd}\end{matrix} \qquad ( 38 )$$

$$e ( k + 1 ) - e ( k ) = \{ \begin{matrix}{e}_{cmd} & if {σ}_{e} ( k ) > {L}_{e} \\ 0 & otherwise\end{matrix} \qquad ( 39 )$$

In solving for relaxed or integer engine on/off variable, the following box constraint is used:

$$0 \leq e \leq 1 \qquad ( 40 )$$

The optimal control problem with 13 states and 4 controls is solved using PS3 algorithm. The consistent variables can be vehicle speed, acceleration and distance, and all other state and control variables are considered as inconsistent or discrete variables. The step-1 involves 9 states and 4 control variables. Step-2 involves 4 states and 2 control variables. Step-3 involves 7 state variables and 1 control variable. All the above mentioned steps are solved in succession to obtain the final solution. [7].

STEP-1—solving relaxed version of the NLP: The NLP which is solved in this step has 9 states which are ζ, v, d, m_{f}, T_{b}, T_{PreDOC}, T_{DOC}, T_{DPF}, and T_{SCR}. The 4-control variables are μ, \tilde{g}, a, and \tilde{e}. The three consistent variables are v, d and a. For simplicity in formulation, the continuous time optimal control problem (OCP) for the given NLP solved in step-1 is given below. This is because discretization is done using the pseudo-spectral collocation scheme and the NLP used has the states, cost function and the constraints being evaluated at each collocation point as mentioned in [7. Some of the path constraints used in this step were modified to accommodate the relaxed nature of the control levers gears and engine switch. For example the path constraint limiting the engine torque was formulated as follows:

$$e {τ}_{e , min} \leq {τ}_{e} \leq e {τ}_{e , max} \qquad ( 41 )$$

In 41, the relaxed engine switch scales the engine max. and min. torque, in such a way that the engine torque is in between these scaled versions of the max. and min. engine torques. The cost function, box, path and boundary constraints are given as follows:

The cost function used is given in (1) where the states are controls are the NLP optimization variables.

The ordinary differential equations for each state variable used here are outlined herein. This is given by (2), (3), (11), (12), (30) & (34).

The box constraints are given by (4), (5), (18), (19), (37) & 40).

The path constraints are given by (6), (8), 9, (26), (28) & 41).

The boundary constraints are given by (7)&10.

Apart from these constraints, initial and final conditions on states, controls and other signals are also specified.

AN initial guess based on a priori information about the control variables was used. To avoid numerical difficulty for the interior point algorithm in IPOPT [23], the constraint bounds were relaxed by a factor of 10⁻⁴. The polynomial degree for collocation points was set to 5, to take full advantage of radau collocation for handling stiffness in the problem. The control interval was set to 1 second.

STEP-2—solving integer states and controls: Once step-1 is solved, the study obtains the optimal trajectories of consistent variables, (v, d, a), and the trajectories of the relaxed discrete variables (\tilde{g}, \tilde{e}). Step-2 of the PS3 algorithm is about finding the optimal integer trajectories (g, e) from the relaxed solutions that satisfy combinatorial constraints, and it requires solving a mixed-integer quadratic program. Inherently, the step-2 problem is about solving an optimal control problem of four integer states (g, e, σ_{g}, σₑ) and two integer controls (g_{cmd}, e_{cmd}) while satisfying the additional combinatorial constraints. Hence it is a 4-state 2-control subproblem. However, by virtue of reformulation into a mixed-integer quadratic program the study can pose the same problem with only two types of discrete optimization variables, gear number and engine on/off. To solve, the study uses a formulation of MIQP similar to the one described in the prequel paper's gear example. In particular, the study uses the vectorized forms of relaxed and binary-equivalent gear number trajectories. The binary gear trajectory is denoted using bⱼ(k) ϵ{0,1} which will take value 0 if j-th gear at time k is inactive, and value 1 if it is active. Similarly, the relaxed gear trajectory is denoted using

$${r}_{j}^{′} ( k ) ∈ [ 0 , 1 ] .$$

Before the MIQP is defined, the study starts off from the optimal trajectories of consistent variables, v and a to arrive at all possible shaft speed and shaft angular acceleration values for the 6 gears at every time step. Naturally, not all gears will always be feasible in the complete drive cycle due to violation of the maximum shaft speed constraint. Another reason for infeasibility of a gear at a given time is when the corresponding maximum torque constraint is violated. However, the torque constraints are dependent on the engine switch as given herein. Nonetheless, as stated below the study arrives at two gear-feasibility binary matrices B₀ (used when e=0) and B₁ (used when e=1), each of size N (length of drive cycle) by 6. For the k-th time step (out of N steps), and j-th gear number,

$${B}_{0 , j} ( k ) := \{ \begin{matrix}1 & if {τ}_{total , j} ( k ) \leq {τ}_{m , max , j} ( k ) ⋀ {ω}_{j} ( k ) \leq {ω}_{max} \\ 0 & if {τ}_{total , j} ( k ) > {τ}_{m , max , j} ( k ) ⋀ {ω}_{j} ( k ) \leq {ω}_{max}\end{matrix} \qquad ( 42 )$$

$${B}_{1 , j} ( k ) := \{ \begin{matrix}1 & if {τ}_{total , j} ( k ) \leq ( {τ}_{e , max , j} ( k ) + {τ}_{m , max , j} ( k ) ) ⋀ {ω}_{j} ( k ) \leq {ω}_{max} \\ 0 & if {τ}_{total , j} ( k ) > ( {τ}_{e , max , j} ( k ) + {τ}_{m , max , j} ( k ) ) ⋀ {ω}_{j} ( k ) \leq {ω}_{max}\end{matrix} \qquad ( 43 )$$

where, the subscript j and paranthesized k indicates dependence on the gear choice and time step, respectively. Once the two gear-feasibility matrices are determined, the study formulated and solved the mixed-integer quadratic program given below:

$${min}_{e ( k ) , {b}_{j} ( k )} {\sum }_{k = 1}^{N} ( {( e ( k ) - \tilde{e} ( k ) )}^{2} + {\sum }_{j = 1}^{6} {( {b}_{j} ( k ) - {r}_{j}^{′} ( k ) )}^{2} )$$

s.t. One-Gear-At-A-Time Constraint ∀k:

$$1 = {\sum }_{j = 1}^{6} {b}_{j} ( k )$$

Feasible Gear Selection Constraint ∀k∀j:

$$0 \leq {b}_{j} ( k ) \leq \{ \begin{matrix}{B}_{0 , j} ( k ) & if e ( k ) = 0 \\ {B}_{1 , j} ( k ) & if e ( k ) = 1\end{matrix}$$

Minimum Dwell-Time Constraints ∀k∀j:

$$∀ i ∈ \{ k , k + 1 , … , k + L \} :$$

$${b}_{j} ( k ) - {b}_{j} ( k - 1 ) \leq {b}_{j} ( i )$$

$${b}_{j} ( k - 1 ) - {b}_{j} ( k ) \leq 1 - {b}_{j} ( i )$$

$$∀ {i}_{e} ∈ \{ k , k + 1 , … , k + {L}_{e} \} :$$

$$e ( k ) - e ( k - 1 ) \leq e ( {i}_{e} )$$

$$e ( k - 1 ) - e ( k ) \leq 1 - e ( {i}_{e} )$$

where, L=3 seconds is the minimum dwell-time duration that gear has to remain unchanged before next gear shift, and likewise, Lₑ=2 seconds is the minimum dwell-time for engine switch.

The feasible gear selection constraint can be an “indicator” constraint because the upper bound imposed on the optimization variable bⱼ(k) is either of the two pre-determined values B_{0,j}(k) or B_{1,j}(k), but the choice is governed by the value of another optimization variable e(k). In integer programming an indicator constraint can be written as linear inequality constraints. Hence the step-2 problem is a mixed-integer quadratic programming problem as it only has linear constraints on the optimization variables with a quadratic objective function. It is solved using MIQP solver, Gurobi [24], with solution time under 10 seconds for N=1200.

As a result of solving the above described MIQP and converting the binary equivalent gear form into its integer-valued counterpart, the study obtains the optimal discrete trajectories of gear number g(k) and engine state e(k), which can then be used in step-3 to solve for the inconsistent variables.

The study also solved the step-2 problem using Dynamic Programming (DP) to compare the results obtained with mixed-integer quadratic programming (Gurobi). For DP, the study used the popular ‘dpm’ function [25] to solve this 4-state 2-control optimal control problem of step-2. By far, all step-2 results obtained using Gurobi were identical to the ones obtained using DP with insignificant differences. This fact validates the use of MIQP-based solver to solve for integer states and controls.

STEP-3—solving for the inconsistent variables: The cost function that is optimized is retained to be the same as the one optimized herein. The integer gear and engine on/off profiles g and e described herein with v, a, and θ_{org} are used as inputs. The states used in this problem are ζ, m, T_{b}, T_{DOC}, T_{DPF} and T_{SCR}. The control variable is p. The cost function, box, path and boundary constraints are given as follows:

The state dynamics of each of these states are the same as used herein. These are given by (2), (3), 30) & (34).

The box constraints are given by (4) & 5

The path constraints are given by (6), 26), 29) & 28.

The boundary constraints is given by (7).

The initial guess used for this problem is obtained from the state and control trajectories of step-1. The solver options used for this problem were the same as the ones used in step-1 in order to ensure consistency. Since the example study used a very good initial guess, a warm start option was used additionally.

### Example 3

The automotive industry battles with concerns on ever-growing energy consumption, greenhouse gas and pollutant emissions. Electrified vehicle powertrains continue to offer solutions, however, their sustainable adoption is not free from challenges because of emissions and energy consumption in electricity generation. Complex dynamical nature of electrified powertrain systems adds to research challenges owing to multiple energy sources of combustion engine and electric battery, as well as to complex interactions between various components including electric machine, aftertreatment, transmission, and driveline. Eco-friendly velocity optimization around a given target drive cycle, sometimes referred to as eco-driving, is another hot research topic aiming to minimize emissions and energy consumption in mobility and transportation. In recent years, there has been growing interest in wholesome comprehensive control optimization to reduce fuel consumption and emissions that also captures complex nonlinear interactions of the powertrain system.

In its multi-decade history of research, the optimal energy management strategies for HEVs mainly have used Dynamic Programming (DP), Pontryagin's Minimum Principle (PMP), Model Predictive Control [3] and ECMS. Numerical programming-based approaches that use convex optimization [4] and linear programming have also been popular lately. The study described herein finds the use of pseudo-spectral collocation method for optimal control of powertrain energy management problems slowly appearing over the last decade [5,6]. Works based on PSC are employed when using nonlinear programming.

In the example study described herein range-extender electric vehicle architectures are disclosed, using a non-limiting example of a medium duty truck. The study models diverse state and control variables of all powertrain subsystems, nonlinear and discontinuous dynamics therein that exhibit multiple time-scales. The study includes mixed-integer optimal control problems and employs numerical optimization approach based on pseudo-spectral collocation (PSC) theory to obtain solutions. The approach employs the PS3 algorithm described herein. The study shows overall energy consumption and NOx emission reduction with growing problem size and complexity. Simulation experiments are conducted to evaluate and analyze results of three representative problems, and their impact on energy minimization.

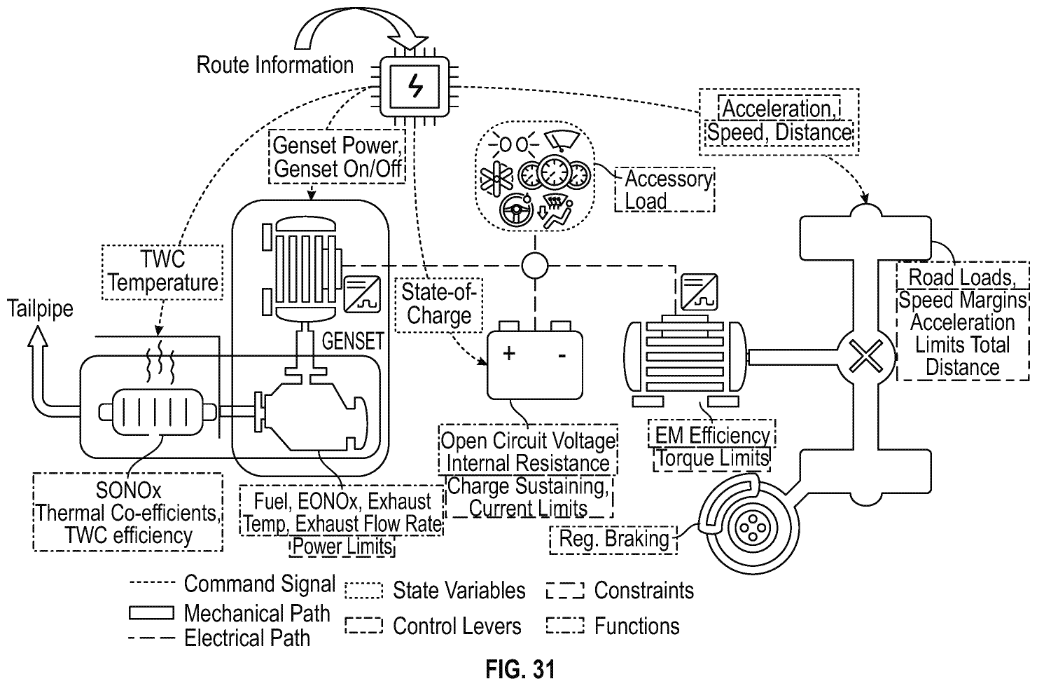

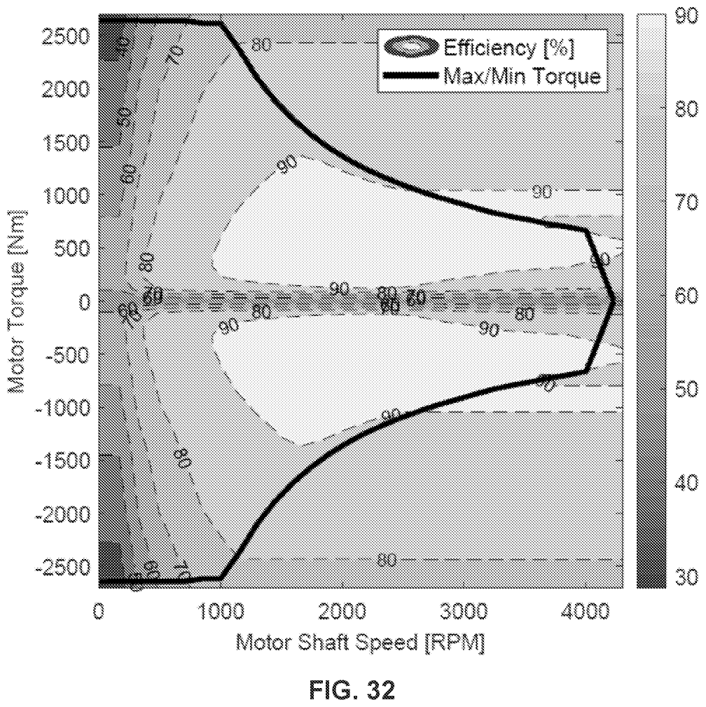

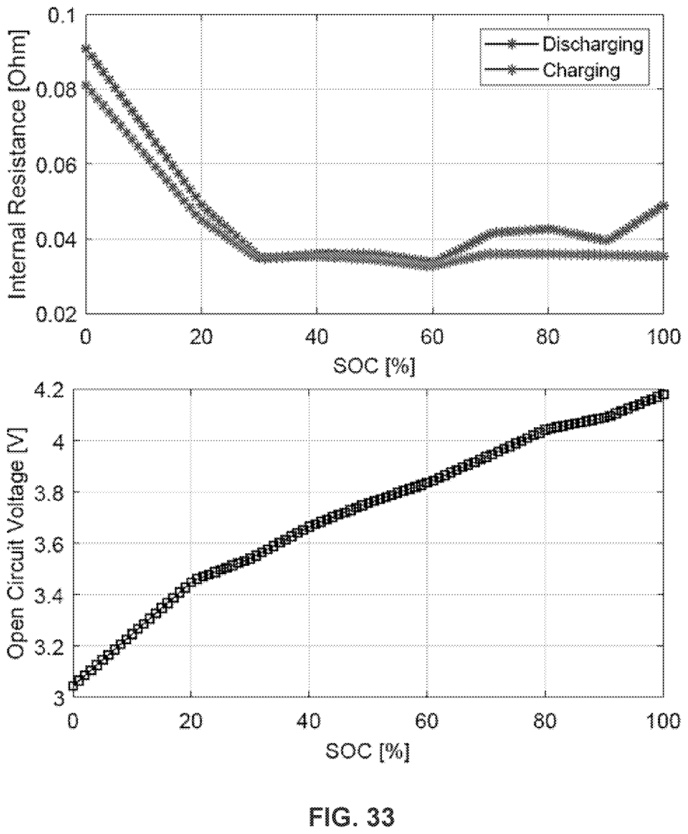

The study includes a range-extender electric vehicle architecture shown in FIG. 31. Genset (CNG powered engine with a generator) is modeled as quasi-static maps having maximum power of 148.5 kW, and generator constant efficiency of 90%, see FIG. 35. The study assumes that engine operates at the optimal operating line at all times and can always meet the desired demand power. This gives us a 1-D look-up table relating genset output power and fuel consumption rate. High power electric machine is also modeled as a quasi-static efficiency map only operating in continuous mode of operation, as shown in FIG. 32. For the 700 V nominal voltage and 74 kWh nominal capacity NMC battery pack, a 0-th order equivalent circuit model is considered which is calibrated and validated at 230 Celsius, as shown in FIG. 33. Number of cells considered are Nₚ=35 in parallel and Nₛ=194 in series, while the cell current is limited by a hard constraint of 2.5 C-rate (discharging) and 1C-rate (charging). Coulombic efficiency is assumed to be constant η_{b}=98%. Accessory load of 4 kW is assumed when vehicle is moving, and assumed zero when stopped. No transmission is considered.

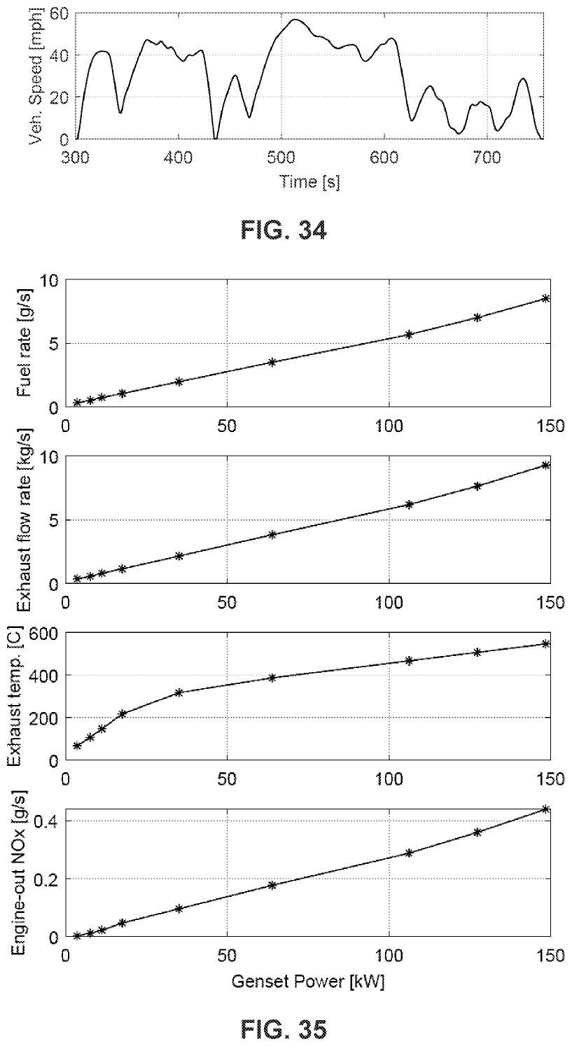

The reference drive cycle specified by a speed profile used is shown in FIG. 34. This example is taken from NREL pickup and delivery urban duty cycle (Baltimore). Note that, even though a specified speed profile is provided as an input, the controller determines what speed profile to actually follow by setting vehicle acceleration trajectory.

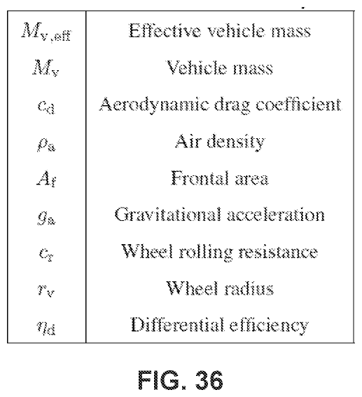

The study assumes a backward simulator. For the vehicle, longitudinal vehicle dynamics are considered. The road load equation below includes vehicle inertia, aerodynamic drag, rolling resistance and gradient forces. The study assumes no change in elevation because elevation profile is not provided through NREL, thus θ_{ref} ≡0. Road load equation and various algebraic relationships between many subsystem signal are explained below:

$${F}_{v} = {M}_{v , e f f} a + \frac{{c}_{d} {ρ}_{a} {A}_{f}}{2} {v}^{2} + {M}_{v} {g}_{a} {c}_{r} cos ( {θ}_{ref} ) + {M}_{v} {g}_{a} sin ( {θ}_{r e f} ) , \qquad ( 1 )$$

$${ω}_{m o t} = \frac{{γ}_{d} v}{{r}_{v}} \qquad ( 2 )$$

$${τ}_{m o t} = \frac{{F}_{v} {r}_{v}}{{γ}_{d} {η}_{d}^{s i g n ( {F}_{v} )}} , \qquad ( 3 )$$

$${P}_{m o t} = {ω}_{m o t} {τ}_{mot} , \qquad ( 4 )$$

$${P}_{d e m} = \frac{{P}_{m o t}}{{η}_{m o t}^{s i g n ( {τ}_{m o t} )}} , \qquad ( 5 )$$

where, F_{V} is total traction force at wheels, Yd is the final drive ratio at the differential, τₘₒₜ is the driveshaft demand torque at the input of the electric machine, and ωₘₒₜ is the corresponding shaft angular speed. When the vehicle is stopped, the demanded torque and shaft speed are set to zero. Demand power Pₘₒₜ is at the input of the electric machine, which is limited above and below by the motor power limits of traction and regeneration, as shown in FIG. 32. And the actual demanded power P_{dem} from the energy sources (battery and genset) is after considering 2-D look-up table efficiency map of electric machine ηₘₒₜ(ωₘₒₜτₘₒₜ) which is linearly interpolated. Other constants are given in FIG. 36.

Various modes of operation exist. The battery and genset can jointly fulfill the demand power. Similarly, genset can operate above the demand to provide traction as well as charging of the battery simultaneously. While braking, the battery can be charged using recuperation energy available from wheels as well as energy provided by the genset. All these modes satisfy the energy balance equation given below:

$${P}_{d e m} + {P}_{a c c} = {P}_{g e n} + {P}_{b a t t}$$

where, P_{acc}=4 kW is the constant accessory load when vehicle is moving, genset power P_{gen} is limited between its min/max bounds. Battery power P_{batt}=NₛNₚP_{cell} is related to the SOC dynamics and constrained indirectly via limits on the min/max cell current. Battery capacity is constant, Qₙₒₘ, while the SOC-dependent cell open circuit voltage V_{oc} and internal resistances R₀ are shown in FIG. 33.

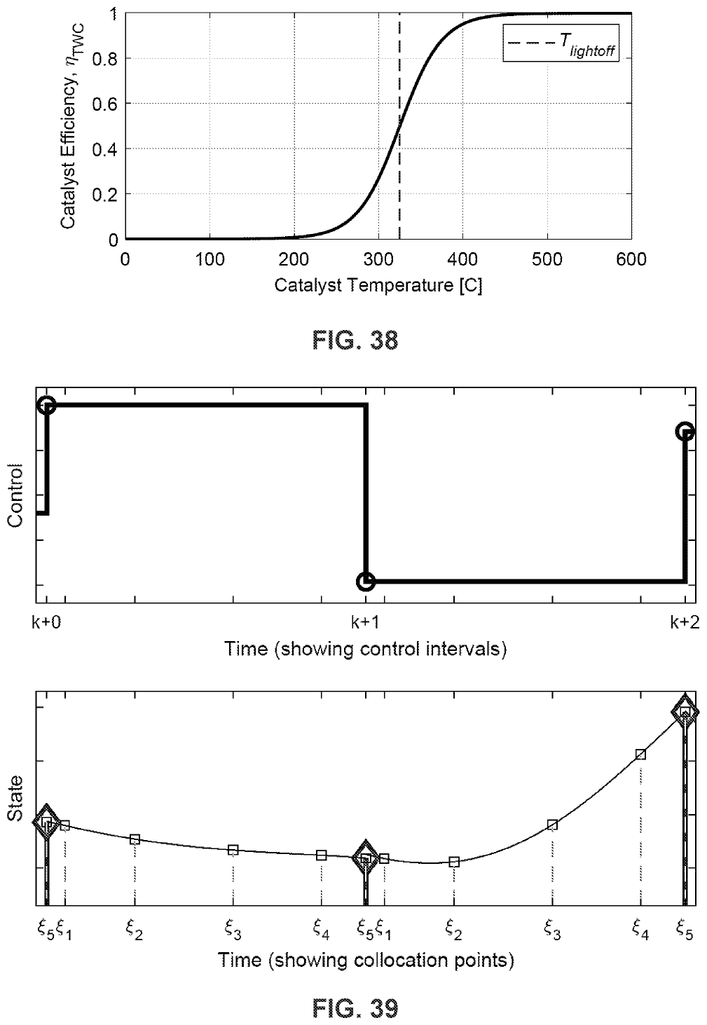

Other models considered in some problems below are that of a engine on/off switch and three-way catalyst (TWC) in aftertreatment system. Engine on/off is a binary-valued control variable that allows the genset to be powered on and off instantaneously, forcing P_{gen}=0 at times when genset is off. The TWC is modeled using one state variable of catalyst temperature, T_{cat} whose dynamics are given below calibrated with various parameters:

$$A \cdot {\dot{T}}_{cat} = B \cdot ( {T}_{e x h} - {T}_{c a t} ) + {η}_{TWC} {\dot{m}}_{exh} - μ ( {T}_{cat} - {T}_{amb} ) , \qquad ( 7 )$$

where A and μ are constant parameters but depend on engine status being on versus off, and B is thermal coefficient that depends on the engine exhaust flow rate, \dot{m}ₑₓₕ. Tₑₓₕ and \dot{m}ₑₓₕ are the engine-out exhaust gas temperature and flow rate which are given by 1-D look-up tables dependent on genset power. T_{amb}=25° C. is the ambient temperature. The term η_{TWC} is the catalyst efficiency and is a sigmoid function dependent on the catalyst temperature as shown below and in FIG. 38.

$${η}_{TWC} = {η}_{TWC , max} ( \frac{1}{1 + {e}^{- r ( {T}_{cat} - {T}_{lightoff} )}} ) \qquad ( 8 )$$

where, T_{lightoff}=325° C., η_{TWC,max}=99.5%, and exponent r=0.04. Four 1-D LUTs of \dot{m}_{f}, \dot{m}ₑₓₕ, Tₑₓₕ, \dot{m}_{EONOx} with genset operating on the optimal line are given in FIG. 35.

The study considers three optimal control problems with increasing level of complexity to demonstrate the contribution. The first, eco-driving problem, has three real-valued state variables—battery state-of-charge ξ, vehicle speed v, and distance covered d—and two real-valued controls—power provided by genset P_{gen} and vehicle acceleration a. The optimization objective is the same for all problems which is to minimize the cumulative fuel consumption which comes from look-up table of genset power. The eco-driving problem with its constraints is summarized in Prob. 1. Index “(t)” is sometimes used with signals only to emphasize the time-dependence at any given t, otherwise all signals are time-varying by default anyway.

$${min}_{{P}_{g e n} , a} {\int }_{{t}_{0}}^{{t}_{N}} {\dot{m}}_{f} dt ,$$

$$s . t . \dot{ξ} = - \frac{1}{{Q}_{nom}} \underbrace{[ \frac{{η}_{b} {V}_{o c}}{2 {R}_{0}} - {η}_{b} \sqrt{{( \frac{{V}_{o c}}{2 {R}_{0}} )}^{2} - \frac{{P}_{cell}}{{R}_{0}}} ] .}_{{I}_{cell}}$$

$$\dot{v} = a ,$$

$$\dot{d} = v ,$$

$$Bound const . \{ \begin{matrix}3.6 \leq {P}_{gen} \leq 148.5 [ kW ] , \\ - 3 \leq a \leq 2 [ m / {s}^{2} ] , \\ 0.1 \leq ξ \leq 0.995 , \\ 0 \leq v \leq 65 [ mph ] ,\end{matrix}$$

where the first three constraints are essentially ODEs for the three state variables, bound constraints specify constant lower and upper bounds on the optimization variables. Algebraic constraints guarantee no violation of cell current limits and eco-driving range limit to be within a specified envelope around the reference vehicle speed. When reference vehicle is stopped, the eco-driven vehicle should also be stopped. The study imposes a final value constraint on total distance covered to be equal to the precomputed distance covered by reference vehicle. Also, the final value of SOC is desired to be 95% starting off initially at 99% charged. The reason for this is to ensure that within the short drive cycle the study has considered, charge-depleting as well as charge-sustaining operations of the battery are shown.

The second problem, Prob. 2, involves one additional control variable, the engine on/off switch, e. It adds a different level of complexity because of being a discontinuous binary-valued variable, as the study assumes instantaneous gear shifts. The study keeps the same objective function, but constraints are slightly modified to make sure the energy balance is satisfied in both types of scenarios of e=0 and e=1

Problem 2 (Engine On/Off Problem). Abbreviation: [ECO+ENG]

$${min}_{{P}_{g e n} , a , e} {\int }_{{t}_{0}}^{{t}_{N}} {\dot{m}}_{f} dt , \qquad ( 17 )$$

$$s . t . \dot{ξ} = - \frac{1}{{Q}_{nom}} \underbrace{[ \frac{{η}_{b} {V}_{o c}}{2 {R}_{0}} - {η}_{b} \sqrt{{( \frac{{V}_{o c}}{2 {R}_{0}} )}^{2} - \frac{{P}_{cell}}{{R}_{0}}} ]}_{{I}_{cell}} , \qquad ( 18 )$$

$$\dot{v} = a , \qquad ( 19 )$$

$$\dot{d} = v , \qquad ( 20 )$$

$$Bound const . \{ \begin{matrix}- 3 \leq a \leq 2 [ m / {s}^{2} ] \\ e ( t ) ∈ \{ 0 , 1 \} \\ 0.1 \leq ξ \leq 0.995 \\ 0 \leq v \leq 65 [ mph ]\end{matrix} \qquad ( 21 )$$

$$Alg . const . \{ \begin{matrix}{P}_{gen} ( t ) ∈ \{ 0 ⋃ [ 3.6 , 148.5 ] \} [ kW ] , \\ - 3 \leq {I}_{cell} \leq 7.5 [ A ] , \\ \vert {v}_{ref} - v \vert \leq 4.5 [ mph ] , - \\ v ( t ) ≡ 0 if {v}_{ref} ( t ) = 0 ,\end{matrix} \qquad ( 22 )$$

$$Initial cond . \{ \begin{matrix}{ξ}_{{t}_{0}} = 0.99 \\ {v}_{{t}_{0}} = 0 \\ {d}_{{t}_{0}} = 0\end{matrix} \qquad ( 23 )$$

$$Final cond . \{ \begin{matrix}{ξ}_{{t}_{N}} = 0.95 \\ {v}_{{t}_{N}} = 0 \\ {d}_{{t}_{N}} = D : = {\int }_{{t}_{0}}^{{t}_{N}} {v}_{ref} dt ,\end{matrix} \qquad ( 24 )$$

Lastly, Prob. 3 involves an additional state variable of three-way catalyst temperature, T_{cat}. Thermal model of the TWC is implemented as explained earlier in Sec. 2.1. Using the thermal model, an emissions model based on overall catalyst efficiency term is also implemented to calculate the system-out NOx emission (SONOx) from engine-out exhaust NOx emission. Consequently and importantly, the objective function in this problem is modified to include weighted term of SONOx emissions along with the original fuel consumption term.

Problem 3 (Aftertreatment Problem). Abbreviation: [ECO+ENG+AFT]

$${min}_{{P}_{g e n} , a , e} {\int }_{{t}_{0}}^{{t}_{N}} {\dot{m}}_{f} + δ {\dot{m}}_{{SONO}_{x}} dt \qquad ( 25 )$$

$$s . t . \dot{ξ} = - \frac{1}{{Q}_{nom}} \underbrace{[ \frac{{η}_{b} {V}_{o c}}{2 {R}_{0}} - {η}_{b} \sqrt{{( \frac{{V}_{o c}}{2 {R}_{0}} )}^{2} - \frac{{P}_{cell}}{{R}_{0}}} ]}_{{I}_{cell}} , \qquad ( 26 )$$

$$\dot{v} = a , \qquad ( 27 )$$

$$\dot{d} = v , \qquad ( 28 )$$

$${\dot{T}}_{cat} = \frac{B}{A} ( {T}_{exh} - {T}_{cat} ) + \frac{{η}_{TWC} {\dot{m}}_{exh}}{A} - \frac{μ}{A} ( {T}_{cat} - {T}_{amb} ) , \qquad ( 29 )$$

$$Bound const . \{ \begin{matrix}- 3 \leq a \leq 2 [ m / {s}^{2} ] \\ e ( t ) ∈ \{ 0 , 1 \} \\ 0.1 \leq ξ \leq 0.995 \\ 0 \leq v \leq 65 [ mph ]\end{matrix} \$\$ \qquad ( 30 )$$

$$Alg . const . \{ \begin{matrix}{P}_{gen} ( t ) ∈ \{ 0 ⋃ [ 3.6 , 148.5 ] \} [ kW ] , \\ - 3 \leq {I}_{cell} \leq 7.5 [ A ] , \\ \vert {v}_{ref} - v \vert \leq 4.5 [ mph ] , \\ v ( t ) ≡ 0 if {v}_{ref} ( t ) = 0 \\ if e ( t ) = 0 \{ \begin{matrix}{\dot{m}}_{exh} = 0 , \\ {T}_{exh} = 25 [ C ] , \\ {\dot{m}}_{{EONO}_{x}} = 0 ,\end{matrix}\end{matrix} \qquad ( 31 )$$

$$Initial cond . \{ \begin{matrix}{ξ}_{{t}_{0}} = 0.99 \\ {v}_{{t}_{0}} = 0 \\ {d}_{{t}_{0}} = 0 \\ {T}_{cat , {t}_{0}} = {T}_{amb}\end{matrix} \qquad ( 32 )$$

$$Final cond . \{ \begin{matrix}{ξ}_{{t}_{N}} = 0.95 , \\ {v}_{{t}_{N}} = 0 , \\ {d}_{{t}_{N}} = D : {\int }_{{t}_{0}}^{{t}_{N}} {v}_{ref} dt ,\end{matrix} \qquad ( 33 )$$

where, \dot{m}_{SONOx} (1−η_{TWC})\dot{m}_{EONOx} is the system-out NOx emissions, and an initial condition of starting catalyst at room temperature is assumed. This is so that coldstart behavior can be understood and analyzed as the study deals with system NOx emissions. The catalyst efficiency η_{TWC} is a sigmoid-like function of catalyst temperature around the light-off temperature as given in (8). Weighting factor δ is adjusted to have both terms take similar numerical values.

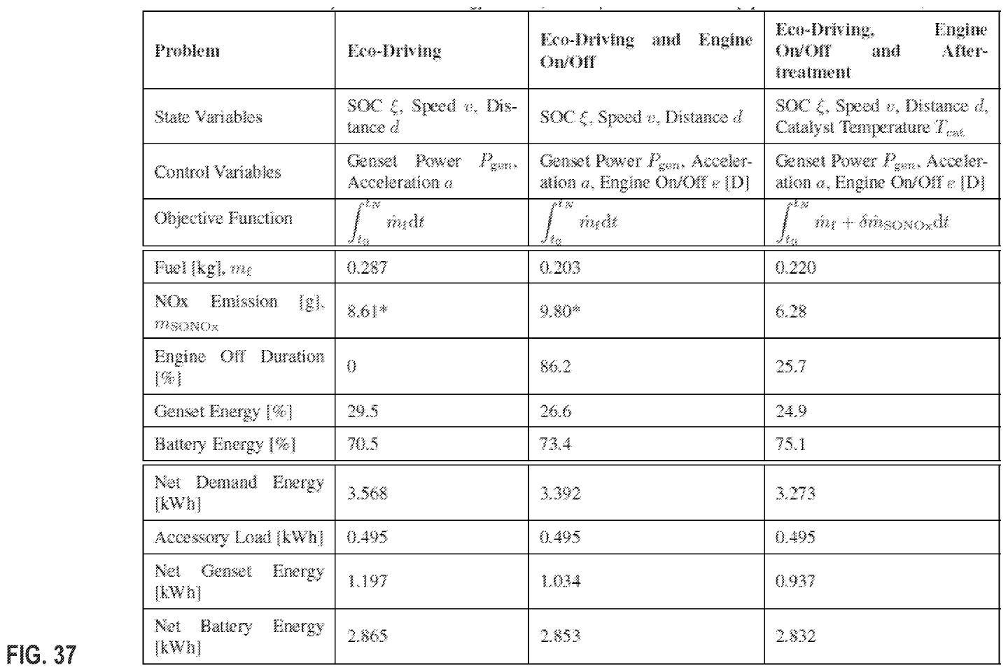

These three problems as well as results are summarized in FIG. 37.

After describing the models and the problem descriptions, the study explains the process of discretization of the problems into multiphase nonlinear programs (NLPs) or mixed-integer nonlinear programs (MINLPs). The term multiphase is used to differentiate the traction and braking phases in the drive cycle because of different dynamics associated with each. Once formulated, numerical approach is used for the optimization solution which is described in the past work [1].

For discretization of optimal control problems, Probs. 1-3, the study uses pseudo-spectral collocation (PSC) scheme which is an implicit Runge-Kutta scheme of high order. In HEV energy management literature, PSC has not been used frequently; some of those works include [5][6]. In pseudo-spectral collocation, the continuous time optimal control problem is transcribed into an NLP. It is a first-discretize-then-optimize numerical method, also called direct method for optimization. Discretization step size in time axis is selected as 1 second. For each discretization step, also called control interval, the study choose three Legendre-Gauss-Radau collocation points for the experiments because of computational time and accuracy trade-offs. Total number of control intervals for each experiment is thus t_{N}−t₀=755−300=455. The state trajectory smoothly varies in pseudo-spectral collocation because of fine discretization at collocation points, however, the study kept the control signals piece-wise constant see FIG. 39.

Once discretized and formulated as a mathematical program, the example implementation can solve it using off-the shelf sparse NLP solver IPOPT [7] which is based on interior-point method (or barrier method). Generally, interior-point method works better and faster with systems having less discontinuities. However, the problem involves thousands of optimization variables with various linearly interpolated lookup tables and a binary-valued control along with switched dynamics, making it very nonlinear and discontinuous. Thus, the example study makes use of more sophisticated linear solver, MA97 by Harwell Subroutine Library ([8]) through IPOPT.

All computations were conducted on Lenovo ThinkPad X1 Carbon Laptop PC with an Intel® Core™ i5-8250U CPU and 8 GB RAM running Windows 11 Home. To define and formulate the nonlinear program in symbolic language toolbox the study used CasADi 3.5.1, [9], within MATLAB R2020b interface. For easier implementation in CasADi, the study uses a toolbox built on top of CasADi specifically for optimal control problems, known as YOP, [10].

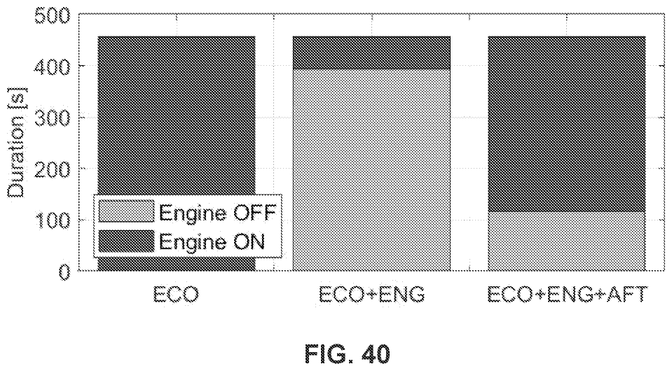

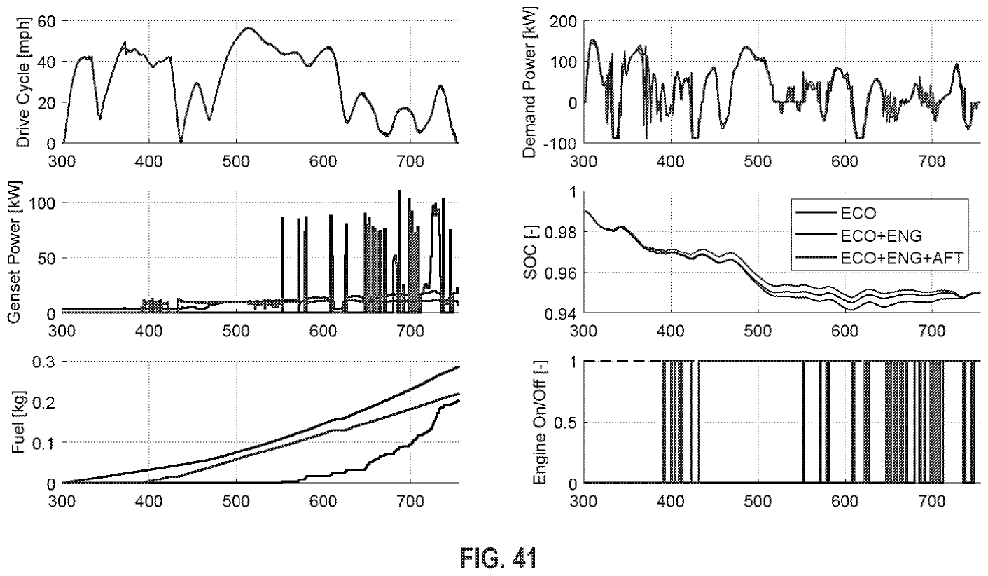

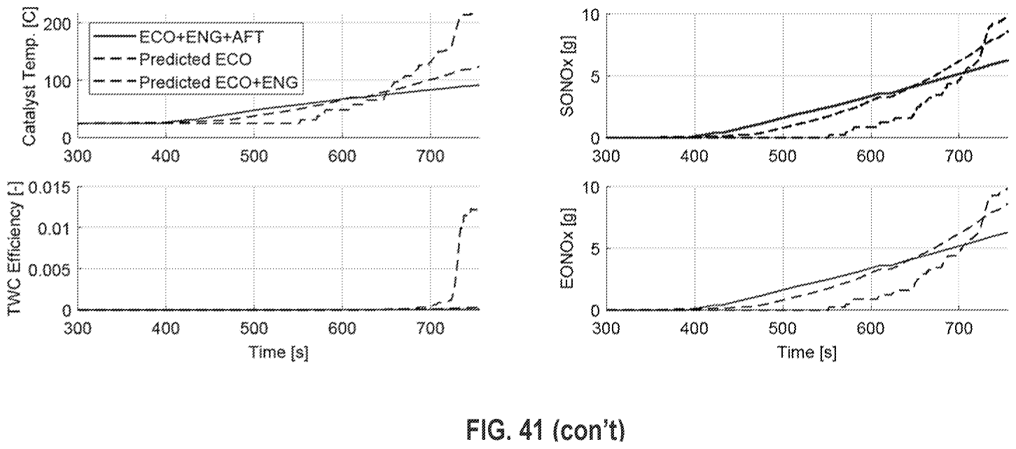

For a cold-start initial conditions, the study shows the combined results of all three problems, namely ECO, ECO+ENG, and ECO+ENG+AFT in FIG. 41. The three problems are defined in increasing order of complexity as well as impact on reduction of energy footprint. Many noticeable trends can be observed. The study shows that the genset power and engine on/off trajectories are significantly different in all three scenarios. For ECO problem, engine on/off control is not available and thus genset keeps operating at lower powers initially and at slightly high power later on. When engine on/off control is added to make the ECO+ENG problem, the study can observe very large duration of engine off operation, and then high spikes of genset power to meet SOC final value constraint. For the ECO+ENG+AFT problem, remember that its objective function also contains a NOx emission term, thus the study shows its effect in having slightly longer engine on duration but all that with overall very low genset power. Engine on/off durations for all three problems is also shown in the histogram in FIG. 40. Corresponding effects of genset power are seen on the fuel consumption. The SOC trends are relatively similar for all problems.

In the last four subplots of the same figure, the study has shown predicted trajectories of catalyst temperature, SONOx, TWC efficiency, and EONOx for ECO and ECO+ENG problems. Since these two problems did not include any aftertreatment signals, thus the study simulated the control outputs of these problems on the model of ECO+ENG+AFT problem to generate these plots. Most important of the observations here is that the study can clearly show the ECO+ENG+AFT problem resulting in least overall NOx emissions even though the catalyst temperature gets slightly higher for the other two problems. This is because the study has considered cold-start scenario and thus the temperatures do not rise significantly and are much below light-off in such a short duration drive cycle. Hence, in such kind of problem, reducing overall EONOx becomes more important than rising catalyst temperature to cross light-off. Finally, in FIG. 37, the study has summarized the overall emissions and energy-related metrics for the three problems. The cumulative numbers show that as the study adds diverse control and state signals to a problem, making the overall system mix of complex dynamics, and then solve for more powerful objective functions, the study can reduce overall energy consumption and NOx emissions significantly. Over traditional methods which handle each powertrain subsystem individually and disjointly, the example methodology clearly has an edge. Likewise, the example numerical approach has the potential of optimizing large number of states and controls simultaneously which the benchmark deterministic Dynamic Programming solver or its likes do not have.

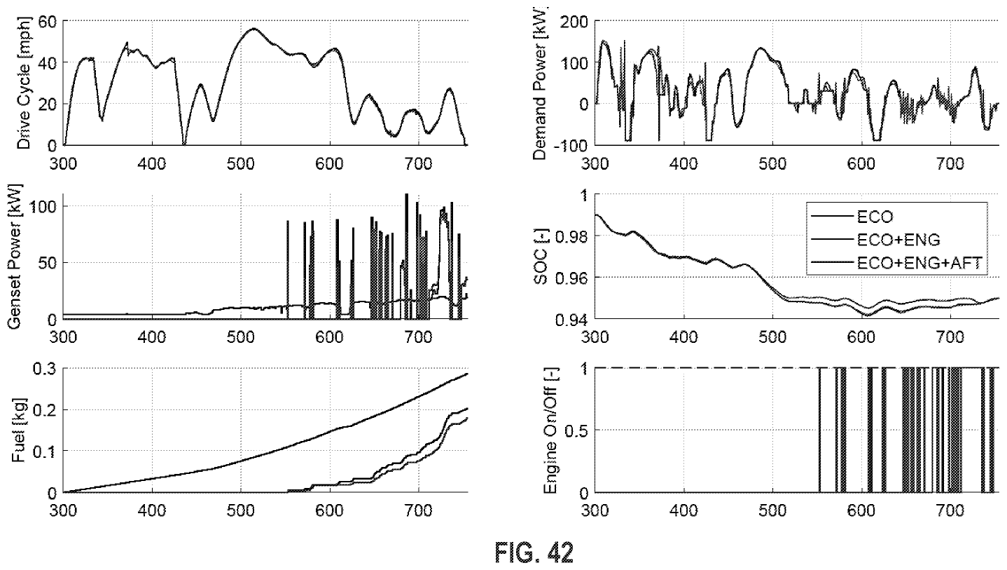

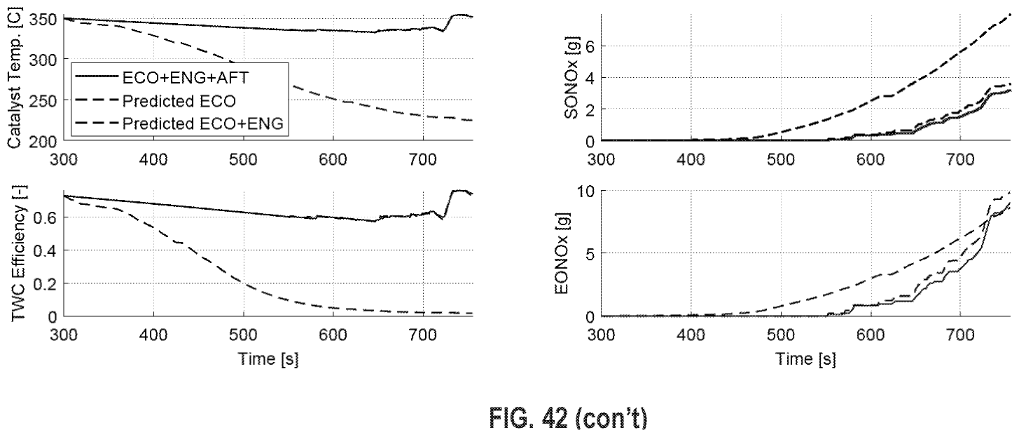

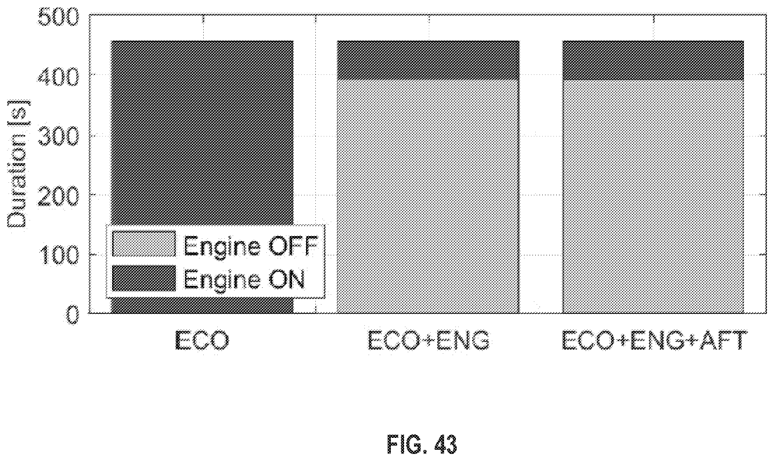

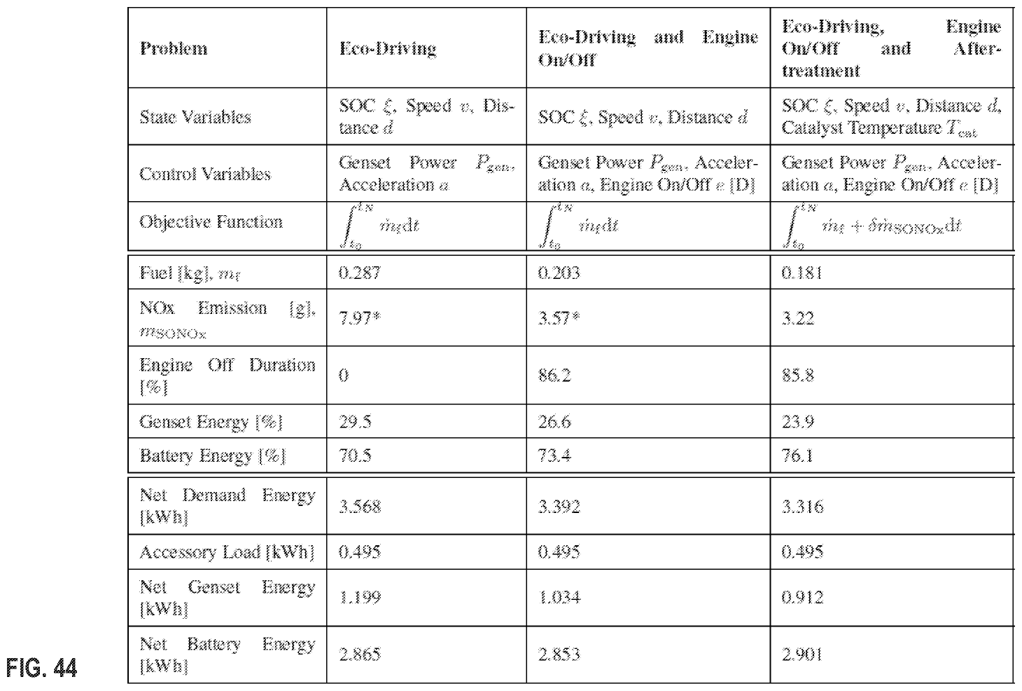

FIGS. 42 and 43 show the results when initial condition of the catalyst temperature was set as T_{cat}, t₀=3500 Celsius, i.e., warm start conditions. Likewise, in FIG. 44 a table is illustrated to summarize the overall emissions and energy-related metrics for the three problems in warm-start case.

The example implementation includes three example powertrain energy management problems of increasing complexity for a class 6 range-extender electric vehicle. Problems are of diverse nature and time-scales involving electrical dynamics through SOC, vehicular dynamics through eco-driving, and thermal dynamics through engine and aftertreatment models. Mathematical complexity in the problems is of high degree due to dynamic power split control between energy sources, engine on/off control, along with the consideration of 1-D and 2-D look-up tables, multiple phases, two-point boundary constraints and switched algebraic relations—that pose vanishing constraints. Objective functions considered involve fuel consumption and system emissions. The study uses a pseudo-spectral collocation theory-based numerical optimization approach to solve the large problems. Results are presented with analysis and energy metrics that show captures subsystem interactions and impact on overall objectives due to all powertrain components simultaneously—battery, genset, motor, aftertreatment, and eco-driving vehicle controller.

### Example 4

Hybrid electric vehicles (HEVs) have increasingly become complex systems. Optimal energy management strategies (EMSs) consider the various subsystems of a powertrain, as well as their interactions to achieve targets of fuel economy along with emissions of air pollutants and greenhouse gases. Many a times, the objectives in an EMS can conflict with each other, such as minimizing the fuel and improving driveability performance. On the other hand, the subsystems of a powertrain may exhibit very different behaviors in their time-dynamics and control. For example, an electric battery may have rapid charging and discharging while on the other hand, an after-treatment catalyst may have slow increase in its temperature. Likewise, the transmission and clutch subsystems will have discontinuous shifts and switches, while the ratio of power-split between internal combustion engine and electric machine, could be any real-number within its bounds. Complicating it further, can be a scenario when in the same energy management problem eco-driving is allowed where one is not restricted to operate on a given drive cycle but is allowed to modulate the speed profile around a target profile.

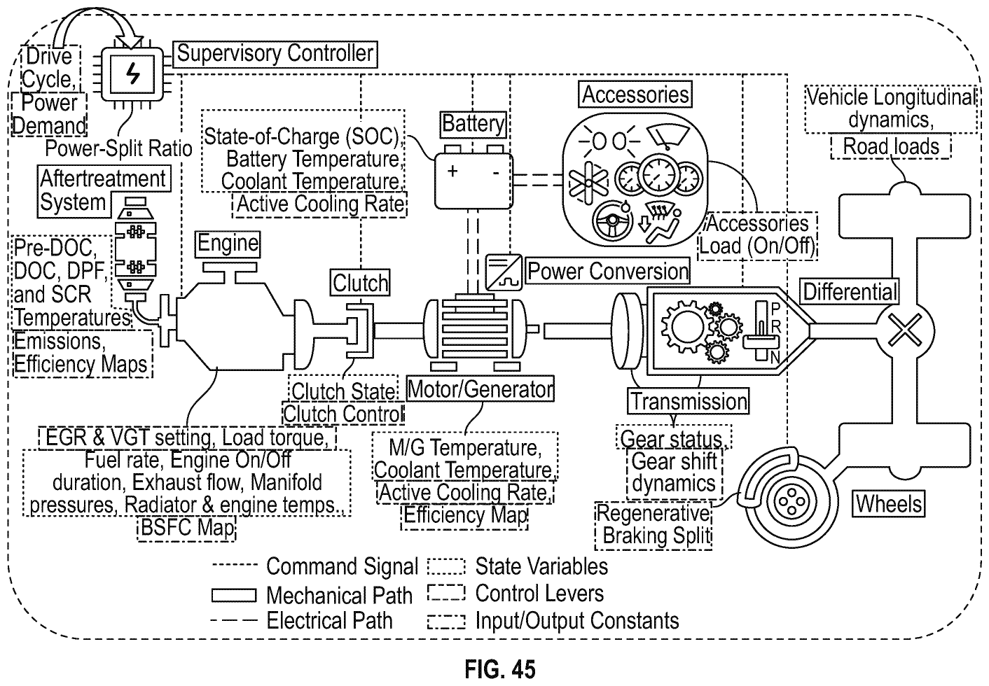

For the energy management, these dynamic and discontinuous interactions restrict engineers to only model incomplete and approximated relationships or to model the state and control variables in disjoint sub-problems. And so traditional control strategies focus on individual sub-component optimality instead of a joint holistic system-level optimization. For example, the engine may be programmed to solely operate at its optimal operating line and the after treatment system independently tuned to maintain certain temperatures of its catalysts. But, whether or not all these systems will jointly meet the overall objectives of the powertrain operation remains a question. If supervisory controller is involved, then all system state variables and control levers may not be modeled and solved jointly with supervisory controller to completely capture such interactions. Hence, there is a great need to develop energy management approaches that can handle high degree of complex system-level interactions, tackle stiffness caused by fast and slow dynamics, and exhibit discontinuous and combinatorial interactions on the optimal control problem, while meeting the conflicting objectives of hybrid electric powertrains. An example of a powertrain with various subsystems, states and controls that are usually considered across powertrain control literature is shown in FIG. 45.

As a non-limiting example, the study focus on developing and validating an HEV energy management algorithm involving large-scale optimization having high number of state and control variables. The example algorithm is based on MINLP employing PSC for transcription of the original mixed-integer optimal control problem into the MINLP. It has a three-step approach wherein the study solves a relaxed version of the large MINLP in first step, solve for the integer-variables using mixed-integer quadratic programming (MIQP) in the second step, and after fixing integer variables the study re-optimizes the real-valued NLP variables in the third step. The study shows results on five casestudy fuel-minimization problems with varying problem size and complexity to benchmark the computational-effort and optimality with Dynamic Programming solutions.

The example implementation can solve such optimal powertrain control problems which exhibit large number of dynamical states, combination of real and integer-valued controls, and constraints from various interacting powertrain components through complex relationships.

The generic optimal control problem can have continuous (real-valued) or discrete (integer-valued) state variables, denoted as x(t)ϵχ⊂ [symbol] ^{|⋅|} and x_{d}(t)ϵχ_{d}⊂ [symbol] ^{|χ}^{_{d}}^{|} respectively, at time t. Likewise, there can be continuous control variables, u(t)ϵ [symbol] ⊂ [symbol] and discrete control variables u_{d}(t)ϵ [symbol] _{d}⊂ [symbol] . The sets χ, [symbol] , χ_{d}, and [symbol] _{d} are simply specified by constant lower and upper bounds on each of its variables, and are handled by box constraints. The dynamics for the continuous state variables are specified by ordinary differential equations (ODE), whose right hand sides are nonlinear (and possibly discontinuous) functions of the state and control variables, as well as other dependent signals. As an example, the study considers fuel consumption to be a state variable in experiments which is given by linear interpolation of 2-D engine map, and hence has a discontinuous RHS. Dynamics of discrete state variables, on the other hand, are specified by their discrete-time dynamic equations. Examples of these are gear shifting and engine on/off switching.

When properly initialized, discrete state variables are a consequence of discrete controls having dynamics dependent only on their respective discrete controls. For example, engine on/off switch is a discrete control taking values 0 (no change), 1 (turn on) and −1 (turn off). The engine status is a state variable with dynamics dependent only on engine on/off switch. Thus, its differential equation can be written as linear combination of shifted and scaled Dirac Delta functions, having impulses at engine on/off switch events. Consequently, the engine status variable will only take discrete values.

The continuous state or control variables are classified into consistent state or control variables, (x_{con}(t), u_{con}(t)), and inconsistent state or control variables, (x_{inc}(t), u_{inc}(t)). Consistent variables are those which can be defined in a way that their dynamics depend neither on inconsistent nor discrete state or control variables. On the other hand, the inconsistent variables can have dependence on any state or control variable. Thus, the study has the three types of state ODEs:

$$[ \begin{matrix}{\dot{x}}_{con} ( t ) \\ {\dot{x}}_{inc} ( t ) \\ {\dot{x}}_{d} ( t )\end{matrix} ] = [ \begin{matrix}{f}_{con} ( {x}_{con} ( t ) , {u}_{con} ( t ) , t ) \\ {f}_{inc} ( x ( t ) , u ( t ) , {x}_{d} ( t ) , {u}_{d} ( t ) , t ) \\ {f}_{d} ( {x}_{d} ( t ) , {u}_{d} ( t ) , t )\end{matrix} ] , \qquad ( 1 )$$

where, x(t)=[x_{con}(t) x_{inc}(t)]^{T}, u(t)=[u_{con}(t) u_{inc}(t)]^{T}, and the vector-valued functions f_{(⋅)} are general form expressions of the RHSs of respective ODEs which solely depend on the way system dynamics are modeled. Distinction of continuous state variables into consistent and inconsistent naturally arises due to the separation caused with discrete variables, x_{d}(t) and u_{d}(t). For example, in a backward powertrain model when gear status is considered to be a discrete state and the vehicle speed as a continuous state, then the vehicle speed, distance and acceleration are all consistent variables since system causality dictates that these vehicle-level variables come from a known drive cycle, and gear selection depends on those but it will not be the other way around. In that case, all powertrain variables after transmission will be classified as inconsistent variables because they all have dependence on gear selection. In general, wherever there is a discrete variable, the study tries to split the overall system there into the two continuous variable types. In the case studies, this classifies vehicle-level variables (speed, distance and acceleration) as consistent and powertrain-level variables (SOC, torque split, after-treatment temperatures, etc.) as inconsistent. However, note that if such separation of (1) is not possible for some problem, then all continuous variables can be considered as inconsistent variables.

All state variables require initial conditions to be defined. These are known constants defining values of every state variable at the initial time. Along with initial conditions for the states, some state variables also have constraint on the final value they take. For the problems presented in the results herein, the study imposes charge-sustaining constraint on battery's state of charge. For problems considering eco-driving, the total distance covered by the eco-driving vehicle at speed v(t) must be the same as the total distance covered by the reference speed profile v_{org}(t).

$${[ \begin{matrix}x ( t ) \\ {x}_{d} ( t )\end{matrix} ]}_{t = 0} = [ \begin{matrix}{x}_{0} \\ {x}_{d , 0}\end{matrix} ] , {[ \begin{matrix}x ( t ) \\ {x}_{d} ( t )\end{matrix} ]}_{t = T} = [ \begin{matrix}{x}_{t} \\ {x}_{d , T}\end{matrix} ] \qquad ( 2 )$$

In order to characterize the plant behavior completely, the study defines another set of variables which are functions of each other as well as of the states and controls. These are coupled in the optimal control problem through algebraic relationships. The study terms them signals. For example, during traction phase in parallel HEV, the electric machine torque, τₘ and total demand torque after transmission, τₜₒₜₐₗ are related to torque split, μ through: τₘ=μτₜₒₜₐₗ. The total demand torque is, likewise, algebraically related to the vehicle speed v and acceleration a through transmission efficiency, gear number g, and various road load signals. Another example is of the fuel consumption engine-out NOx emissions which are based on 2-D look-up tables of engine shaft speed to and engine torque τₑ. If any of these signals is constrained, then that is effectively a type of path constraint on states or controls. These relationships are numerous ranging from kinematic equations at vehicle and driveline level, to energy conservation and efficiency losses in between propulsion (engine and traction motor), after-treatment and driveline blocks, as well as thermal heat transfer and electric current dynamics. For the example case study problems, these relationships and dependent variables are listed in the modeling examples described herein.

Each of the state and control variables is bounded below and above by known constants, called box constraints. All box constraints are specified as vectors by subscripts (⋅)_{lb} and (⋅)_{ub} for lower and upper bounds, respectively:

$${u}_{l b} \leq u ( t ) \leq {u}_{u b} \qquad ( 3 )$$

$${x}_{l b} \leq x ( t ) \leq {x}_{u b}$$

$${u}_{d , lb} \leq {u}_{d} ( t ) \leq {u}_{d , u b}$$

$${x}_{d , lb} \leq {x}_{d} ( t ) \leq {x}_{d , u b}$$

Along with box constraints, the state and control variables can have explicit or implicit constraints that are time-varying. These are jointly termed as path constraints. Examples of explicit path constraints on a state variable are the eco driving speed constraint and stop-at-stop constraint—vehicle speed v(t) is constrained to be within a constant envelope of V_{margin}=5 km/h above and below the reference speed profile, v_{org} (t) and should stop when there is a stop in the reference:

$$\vert {v}_{org} ( t ) - v ( t ) \vert \leq [ \begin{matrix}{V}_{margin} & if {v}_{org} ( t ) \neq 0 \\ 0 & if {v}_{org} ( t ) = 0\end{matrix} ]$$

Likewise, example of implicit path constraints can be the time varying min/max limits on signals such as engine or motor torques.

$${τ}_{e , min} ( t ) \leq {τ}_{e} ( t ) \leq {τ}_{e , max} ( t )$$

$${τ}_{m , min} ( t ) \leq {τ}_{m} ( t ) \leq {τ}_{m , max} ( t )$$

One important path constraint is the dwell-time constraint on a discrete variable. For example, if the controller optimizes gear profile to minimize fuel consumption, the study observes gear chattering phenomenon. But it is undesirable for gears to rapidly switch here and there as that causes immense drivability discomfort. Hence an explicit path constraint is needed on gear switching that limits number of gear shifts for a certain dwell-time period t_{dwell}. This is a combinatorial constraint on a discrete state variable that can be solved according to the methods of the present disclosure. Path constraints can be grouped as:

$$h ( x ( t ) , u ( t ) , {x}_{d} ( t ) , {u}_{d} ( t ) , t ) \leq 0. \qquad ( 4 )$$

Finally, using (1)(2)(3)(4) the study arrives at the complete mixed integer optimal control problem, Prob. 11 where, x(t)=[x_{con}(t) x_{inc}(t)]^{T}, and u(t)=[u_{con}(t) u_{inc}(t)]^{T}. The cost function comprises of a running cost L and a terminal cost ψ. The study considered total fuel consumption over the whole cycle as the cost function. Note that, in the following definition, the study identified the vectors in boldface, time-varying signals with “(t)” and constants without “(t)”.

Problem 1 (OCCP1: Optimal Powertrain Control Problem):

$${min}_{u ( t ) , {u}_{d} ( t )} ψ ( x ( T ) , {x}_{d} ( T ) , T ) + {\int }_{0}^{T} L ( x ( t ) , u ( t ) , {x}_{d} ( t ) , {u}_{d} ( t ) , t ) dt$$

$$s . t . ODEs : \{ \begin{matrix}{\dot{x}}_{con} ( t ) = {f}_{con} ( {x}_{con} ( t ) , {u}_{con} ( t ) , t ) \\ {\dot{x}}_{inc} ( t ) = {f}_{inc} ( x ( t ) , u ( t ) , {x}_{d} ( t ) , {u}_{d} ( t ) , t ) \\ {\dot{x}}_{d} ( t ) = {f}_{d} ( {x}_{d} ( t ) , {u}_{d} ( t ) , t )\end{matrix}$$

$$Box Constr . : \{ \begin{matrix}{u}_{lb} \leq u ( t ) \leq {u}_{ub} \\ {x}_{lb} \leq x ( t ) \leq {x}_{ub} \\ {u}_{d , lb} \leq {u}_{d} ( t ) \leq {u}_{d , ub} \\ {x}_{d , lb} \leq {x}_{d} ( t ) \leq {x}_{d , ub}\end{matrix}$$

$$Path Constr . : \{ h ( x ( t ) , u ( t ) , {x}_{d} ( t ) , {u}_{d} ( t ) , t ) \leq 0$$

$$Boundary Constr \text{::} \{ \begin{matrix}x ( 0 ) = {x}_{0} \\ {x}_{d} ( 0 ) = {x}_{d , 0} \\ x ( T ) = {x}_{T} \\ {x}_{d} ( T ) = {x}_{d , T}\end{matrix}$$

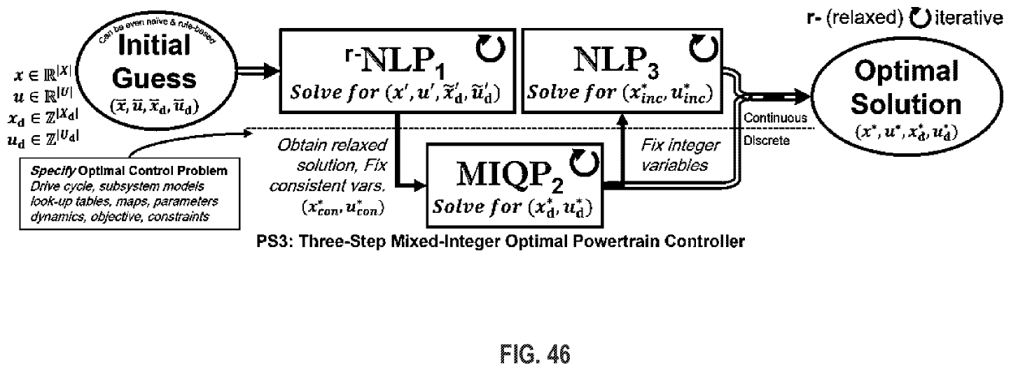

A direct method of numerical optimization is used to solve the optimal control problem. Direct methods rely on a first-discretize-then-optimize approach. All numerical optimization methods at some point rely on an iterative approach towards finding solutions. Insofar, the underlying principle approach is to iteratively progress in the gradient direction such that a minima is found within specified tolerance levels. As described earlier, the study makes use of a customized MINLP solution approach, which is done in three steps, solving [symbol] , [symbol] and [symbol] in each step respectively, depicted in FIG. 46.

Discretization of the optimal control problem is the first crucial step in solving it using a numerical optimization technique. Furthermore, some of the constraints in the problem definition, that are related to gear dwell-time, can be better described only after an equivalent discrete-time problem is defined. Hence, before the study attempts to solve the optimal control problem to determine a solution, the study discretizes it in time. Once an equivalent discrete-time optimization problem is defined, the study can then move on to formulating the three-step approach to solve the resultant mixed-integer nonlinear program (MINLP). For this discretization of the continuous-time optimal control problem into a discrete-time numerical optimization problem the study make use of the pseudo-spectral collocation theory.

The pseudo-spectral method is essentially a high-order implicit Runge-Kutta (IRK) based collocation scheme in which the time-axis is discretized at non-uniform locations which are determined based on roots of a certain family of orthogonal polynomials. These polynomials are employed to accurately approximate the state trajectories originating from the differential equations that govern the plant dynamics in optimal control problems. Due to high accuracy of derivatives and integrals that comes via such an approximation, pseudospectral collocation has gained a lot of popularity.

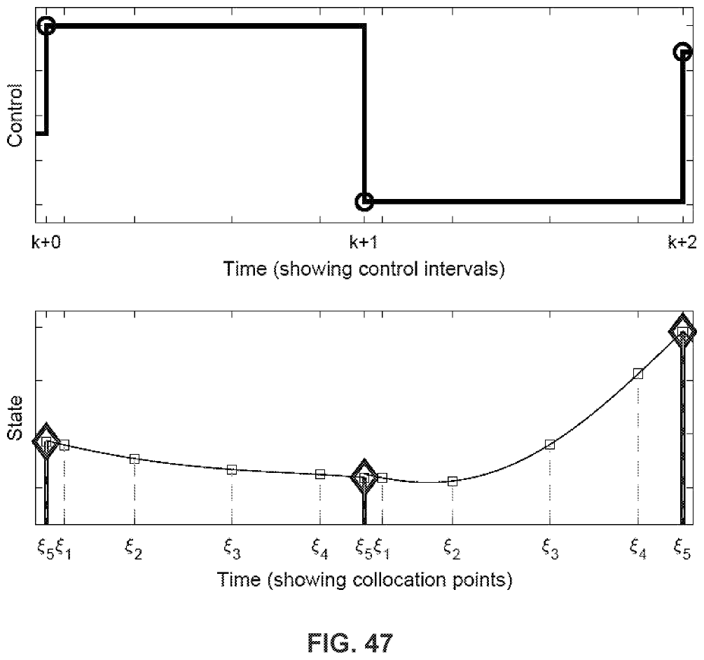

The example uses a discretization step size of, Δt:=Δtₖ=1 second ∀kϵ{1, . . . , N} for the k-th time interval indicated by the time tϵ[tₖ₋₁, tₖ), and having a total of N such intervals, called ‘control intervals’, spanning the complete time horizon [0,T]. For notational convenience, when dealing with discrete time signals the study uses k in parentheses instead of t. The control signals are assumed to be piece-wise constant within each of the N intervals. On the other hand, the state trajectories smoothly vary due to high-order implicit Runge-Kutta (IRK) discretization at collocation points. For highly accurate state dynamics modeling the study uses five LGR (Legendre-Gauss-Radau) collocation points within each control interval—see FIG. 47. But, practically, for some of the experiments when accuracy is not expected to be compromised or when a benchmark needs to be compared, the study uses one collocation point per interval. One specialty of LGR collocation scheme, unlike other choices of LGL (Legendre-Gauss-Lobotto) or LG (Legendre-Gauss) schemes, is that it includes the interval's end point as a collocation point. Thus, LGR collocation points have stiff decay property that can well handle stiffness associated with the corresponding ODEs. The study omits details of how the pseudospectral collocation scheme operates to achieve discretization at non-uniform points inside a control interval, and refer the reader to exclusive works on the subject by [36] and [37].

Since the original optimal control problem (Prob. 1) involves discrete state and control variables, discretization of the same using pseudo-spectral collocation into N control intervals, as mentioned above, will transcribe it into a mixed integer nonlinear program. Instead of numerically solving the MINLP directly, the study first applies relaxation to its discrete variables that allows the solver to assume continuous values for the otherwise discrete-valued variables, (x_{d}(k), u_{d}(k))∀kϵ{1, . . . , N}. Thus, if the study only has one discrete state, the gear number, g(t), then the relaxed gear number state, g(t) discretized into N intervals, \tilde{g}(k)∀kϵ{1, . . . , N} can be any real number within 1=:g_{lb}≤\tilde{g}(k)≤g_{ub}:=n_{b}, where n_{b} is the total number of gear choices here. For a six-speed transmission, n_{b}=6. When \tilde{g}(k) takes whole number values, the gear ratios correspond to them, however, for fractional gear numbers, the gear ratios are linearly interpolated. For any other discrete state or control variable, an analogous relaxation will be applied to convert the MINLP into an NLP. Furthermore, since imposing combinatorial constraints (like minimum dwell-time) on discrete variables will not make sense for relaxed variables, so the study does not impose those in the first step of the three-step algorithm, and take care of it in the second step. Finally, the study arrives at the relaxed-NLP (Prob. 2 which is solved in step-1 of proposed algorithm by an off-the-shelf gradient-based sparse NLP solver, IPOPT [24].

Problem 2( [symbol] ): It is defined as the discretized equivalent of Prob.11 with a total of N control intervals of step-Δt=1s each, using pseudo-spectral collocation scheme at Legendre-Gauss-Radau points for the state trajectories, where:
a subset of the path constraints h(x(t), u(t),x_{d}(t), u_{d}(t), t)≤0, namely the dwelltime constraints (or other combinatorial constraints) on discrete variables are ignored; and
discrete states x_{d}(t) ϵ [symbol] ^{|χ}^{_{d}}^{|} and discrete controls u_{d}(t)ϵ [symbol] are respectively replaced by relaxed states, \tilde{x}_{d}(t)ϵ [symbol] ^{|χ}^{_{d}}^{|} and relaxed controls ũ_{d}(t) ϵ [symbol] using linear interpolation.

Assuming that the study can obtain a solution,

$$( {x}^{′} ( k ) , {u}^{′} ( k ) , {\tilde{x}}_{d}^{′} ( k ) , {\tilde{u}}_{d}^{′} ( k ) ) ∀ k ∈$$

{1, . . . , N}, to the nonlinear program [symbol] the study now describes step-2 of the algorithm that handles integer optimization. From the obtained solution, the consistent variables are assigned their fixed trajectories which do not alter after this step:

$${x}_{c o n}^{*} ( k ) {←}^{assign} {x}_{c o n}^{′} ( k ) , {u}_{c o n}^{*} ( k ) {←}^{assign} {u}_{c o n}^{′} ( k ) .$$

Step-1 resulted in relaxed trajectories for the discrete states and controls which are not integer valued nor do they meet dwell-time constraints. Now, the primary focus in step-2 is to obtain the integer states and controls

$$( {x}_{d}^{*} ( k ) , {u}_{d}^{*} ( k ) )$$

which are closest to their relaxed counterparts from step-1,

$$( {\tilde{x}}_{d}^{′} ( k ) , {\tilde{u}}_{d}^{′} ( k ) ) .$$

In doing so, the solution should also satisfy any combinatorial constraints on discrete variables. This is achieved by defining a mixed-integer quadratic program.

Problem 3( [symbol] ): Given optimized relaxed trajectories of discrete variables

$${\tilde{x}}_{d}^{′} ( k ) and {\tilde{u}}_{d}^{′} ( k ) ,$$

and fixed trajectories of consistent variables

$${x}_{c o n}^{*} ( k ) and {u}_{c o n}^{*} ( k )$$

for kϵ{1, . . . , N} from step-1 solution, solve the corresponding discretized equivalent of the following optimal control problem to obtain

$${x}_{d}^{*} ( k ) and {u}_{d}^{*} ( k ) :$$

$${min}_{{u}_{d} ( t )} {\int }_{0}^{T} {‖ {u}_{d} ( t ) - {\tilde{u}}_{d}^{′} ( t ) ‖}^{2} + {‖ {x}_{d} ( t ) - {\tilde{x}}_{d}^{′} ( t ) ‖}^{2} dt$$

$$subject to {\hat{x}}_{d} ( t ) = {f}_{d} ( {x}_{d} ( t ) , {u}_{d} ( t ) , t )$$

$${u}_{d , l b} \leq {u}_{d} ( t ) \leq {u}_{d , ab}$$

$${x}_{d , l b} \leq {x}_{d} ( t ) \leq {x}_{d , ab}$$

$${x}_{d} ( 0 ) = {x}_{d , 0}$$

$${x}_{d} ( T ) = {x}_{d , T}$$

$$h ( x ( t ) , u ( t ) , {x}_{d} ( t ) , {u}_{d} ( t ) , t ) \leq 0 … … \{ \begin{matrix}for some {x}_{inc} ( t ) \& {u}_{inc} ( t ) \\ satisfying , where \\ u ( t ) := [ \begin{matrix}{u}_{inc} ( t ) & {{u}_{con}^{*} ( t ) ]}^{⊤}\end{matrix} \\ x ( t ) := [ \begin{matrix}{x}_{inc} ( t ) & {{x}_{con}^{*} ( t ) ]}^{⊤}\end{matrix}\end{matrix}$$

Since this problem optimizes only the discrete variables, a direct shooting discretization scheme is adopted instead of direct pseudo-spectral collocation.

Typically, Prob. 3 can be easily framed as a mixed-integer quadratic program. This is because, firstly, the discrete state dynamics, f_{d}, are typically linear combinations of shifted and scaled Dirac Delta functions dependent on the integer-valued control—which makes them linear equality constraints. Secondly, for the path constraints h(x(t), u(t), x_{d}(t), u_{d}(t), t), the consistent variables are already known and fixed. Whereas, only the existence condition of a feasible solution is required for the inconsistent variables thereby avoiding explicit inclusion of nonlinearities in the Prob. 3. The remaining terms are either quadratic on linear. In the following paragraph, the study gives an example of Prob. 3 having gear number as the optimization variable with minimum dwell-time and other combinatorial constraints, which is written as an MIQP.

Gear Example of [symbol] : To better explain Prob. 3, the study is given an example MIQP problem that has gear number as a discrete control variable and is imposed with dwelltime constraints. Let's denote the optimal relaxed gear number obtained from step-1 as \tilde{g}′(k). First, the study transforms the scalar relaxed gear trajectory, \tilde{g}′(k)ϵ[1, n_{b}]⊂ [symbol] for k=1, . . . , N, into a vectorized binary equivalent,

$${r}^{′} ( k ) = {[ \begin{matrix}\begin{matrix}\begin{matrix}{r}_{1}^{′} ( k ) & {r}_{2}^{′} ( k )\end{matrix} & …\end{matrix} & {r}_{{n}_{b}}^{′} ( k )\end{matrix} ]}^{⊤} ∈$$

[0,1]ⁿ^{_{b}} ⊂ [symbol] ⁿ^{_{b}} where each element of the vector represents one of the n_{b} gear choices. Representing dwell-time constraint using binary variables that take values 0 or 1 is simpler than representing it using integer variables. To arrive at r′(k) from \tilde{g}′(k), the study distributes the percentage difference in between floor [\tilde{g}′(k)] and ceil [\tilde{g}′(k)] integers indicating likelihood of belonging to one of the two nearest integer gear numbers. For example, if the relaxed gear took a value of \tilde{g}′(k)=3.38 at k-th control interval, then its best integer value has 38% likelihood of being in 4^{th} gear and 62% of being in 3^{rd} gear. The equivalent binary vector for 6-speed transmission will be r′(k)=[0 0 0.62 0.38 0 0]^{T}. Given the relaxed vectorized gear trajectory as an input, the following mixed-integer quadratic program (MIQP) aims to determine the binaryvalued vectorized gear trajectory, b(k)ϵ{0,1}ⁿ^{_{b}}∀k=1, . . . , N. The minimum gear dwell-time constraint needs to be properly defined in discrete-time at this point, and by the use of binary variables, this task is simplified to two sets of inequalities for each possible gear choice at each time step, as given in Prob. 4

Problem 4: For every kϵ{1, . . . , N} grid interval and n_{b} gear choices at each step, obtain the binary gear trajectory, b(k)ϵ{0,1}ⁿ^{_{b}} that minimizes sum of its squared differences from the input relaxed gear trajectory, r′(k)ϵ[0,1]ⁿ^{_{b}},

$${min}_{b ( k )} {Σ}_{k = 1}^{N} {‖ b ( k ) - {r}^{′} ( k ) ‖}_{2}^{2} = {Σ}_{k = 1}^{N} {Σ}_{j = 1}^{{n}_{b}} {( {b}_{j} ( k ) - {r}_{j}^{′} ( k ) )}^{2}$$

s.t. One-Gear-At-A-Time Constraint ∀k:

$$1 = {Σ}_{j = 1}^{{n}_{b}} {b}_{j} ( k )$$

Feasible Gear Selection Constraint ∀k∀j:

$$0 \leq {b}_{j} ( k ) \leq {B}_{j} ( k ) := \{ \begin{matrix}1 if j - th gear is feasible at k \\ 0 if j - th gear is infeasible at k\end{matrix}$$

Minimum Dwell-Time Constraints ∀k∀j:

$$∀ i ∈ \{ k , k + 1 , … , k + ⌊ \frac{{t}_{dwell}}{Δ t} ⌋ \} :$$

$${b}_{j} ( k ) - {b}_{j} ( k - 1 ) \leq {b}_{j} ( i )$$

$${b}_{j} ( k - 1 ) - {b}_{j} ( k ) \leq 1 - {b}_{j} ( i )$$

where, t_{dwell} is the minimum dwell-time duration in seconds that gear has to remain unchanged before next gear shift. Here, gear feasibility limit Bⱼ(k)∀k∀j is pre-calculated using min/max shaft speed limits and torque limits of internal combustion engine and traction motor, based on Prob. 2 s solution

$$( {x}_{c o n}^{*} ( k ) , {u}_{c o n}^{*} ( k ) )$$

of consistent variables.

As a result of solving Prob. 4 the study obtains the optimal binary valued discrete variable trajectories b(k) for k=1, . . . , N. This is transformed back into optimal integer trajectories of the discrete variables

$${x}_{d}^{*} ( k ) and {u}_{d}^{*} ( k ) ,$$

which completes integer optimization.

Problem S( [symbol] ): This is a simpler version of Prob. 2 where the consistent variables

$$( {x}_{con}^{*} , {u}_{c o n}^{*} )$$

and discrete variables

$$( {x}_{d}^{*} , {u}_{d}^{*} )$$

are fixed and known beforehand from steps 1 and 2. The objective is to minimize the fuel using only the inconsistent variables (x_{inc}(k), u_{inc}(k))∀k ϵ{1, . . . , N} subject to relevant set of dynamical, box, path and boundary constraints from Prob. 1 Here also, there are N control intervals of step-size Δt=1 s each, employing pseudospectral collocation using Legendre-Gauss-Radau points.

Referring back to the algorithm diagram of FIG. 46, once [symbol] and [symbol] are solved, the optimal consistent variables are known

$$( {x}_{con}^{*} , {u}_{c o n}^{*} )$$

(cf. step-1) and the optimal integer variables

$$( {x}_{d}^{*} , {u}_{d}^{*} )$$

(cf. step-2). These can be used to obtain overall optimal solution for the remaining variables, i.e., inconsistent variables

$$( {x}_{inc}^{*} , {u}_{inc}^{*} )$$

using the nonlinear program defined by Prob. 5. This complete process is explained in an algorithmic form in Algorithm 1. where writing the parenthesized “(k)” is avoided for brevity.

Algorithm 1(PS3) Mixed-integer powertrain control using nonlinear programming and pseudo-spectral collocation
1: Load drive cycle information, model parameters, and maps
2: Obtain naïve initial guess for all the state and control variables (\tilde{x}_{con},ū_{con},x̅_{inc},ū_{inc},x̅_{d},ū_{d}) which can be simply rule-based
3: Step 1: Assume relaxed values (\tilde{x}_{d}, ũ_{d}) for the integervalued variables, (x_{d}, u_{d}) and then solve the large nonlinear program (Prob. 2) to obtain optimal trajectories of all states

$$( {x}_{con}^{′} , {x}_{inc}^{′} , {\tilde{x}}_{d}^{′} , ) ,$$

and controls

$$( {u}_{con}^{′} , {u}_{inc}^{′} , {\tilde{u}}_{d}^{′} )$$

$$( \begin{matrix}{x}_{con}^{′} , {x}_{inc}^{′} , {\tilde{x}}_{d}^{′} , \\ {u}_{con}^{′} , {u}_{inc}^{′} , {u}_{d}^{′}\end{matrix} ) {←}^{solve} ℕ𝕃ℙ𝕝 ( \begin{matrix}{\overline{x}}_{con} , {\overline{x}}_{inc} , {\overline{x}}_{d} , \\ {\overline{u}}_{con} , {\overline{u}}_{inc} , {\overline{u}}_{d}\end{matrix} )$$

4: Fix the optimal trajectories of consistent variables from the obtained solution of step-1:

$$( {x}_{con}^{*} , {u}_{con}^{*} ) {←}^{assign} ( {x}_{con}^{′} , {u}_{con}^{′} )$$

5: Step 2: Using optimal trajectories of consistent variables

$$( {x}_{con}^{*} , {u}_{con}^{*} )$$

and the relaxed variables

$$( {\tilde{x}}_{d}^{′} , {\tilde{u}}_{d}^{′} )$$

solve mixed-integer quadratic program (Prob. 3) to obtain integer solutions

$$( {x}_{d}^{*} , {u}_{d}^{*} )$$

respecting all relevant constraints including the combinatorial constraints. This can be done by transforming integer variables into vectorized binary equivalents:

$$( {x}_{d}^{*} , {u}_{d}^{*} ) {←}^{solve} {𝕄𝕀ℚℙ}_{2} ( {x}_{con}^{*} , {u}_{con}^{*} , {\tilde{x}}_{d}^{′} , {\tilde{u}}_{d}^{′} )$$

6: Step 3: By fixing the optimal trajectories of discrete variables from step-2

$$( {x}_{d}^{*} , {u}_{d}^{*} )$$

and consistent variables from step-1

$$( {x}_{con}^{*} , {u}_{con}^{*} ) ,$$

solve the second nonlinear program (Prob. 55 with step-1's solution as an initial guess. Here, all the inconsistent state and control variables will be reoptimized.

$$( {x}_{inc}^{*} , {u}_{inc}^{*} ) {←}^{solve} {ℕ𝕃ℙ}_{3} ( {x}_{inc}^{′} , {u}_{inc}^{′} )$$

7: The overall mixed-integer solution is finally thus obtained

$$( {x}^{*} , {u}^{*} , {x}_{d}^{*} , {u}_{d}^{*} ) ,$$

where the continuous variables are

$${u}^{*} = {[ {u}_{inc}^{*} {u}_{con}^{*} ]}^{T} and {x}^{*} = {[ {x}_{inc}^{*} {x}_{con}^{*} ]}^{T} .$$

The study included a comparison of the example implementation to the standard benchmark of Dynamic Programming (DP) for HEV energy management problems. The study ran experiments for a variety of problems i.e. different combinations of real and integer-valued state and control variables in the OCP, using the algorithms PS3 and DP. The conclusions are summarized in herein. This example includes five case problems (Case 1 to Case 5) that DP can realistically solve to establish a comparison. In all five cases presented here, all the real-valued variables are inconsistent variables. However, the case-study problem in [35] involves consistent as well as inconsistent real-valued variables.

All computations were conducted on Lenovo ThinkPad X1 Carbon Laptop PC with an Intel® Core™ i5-8250U CPU and 8 GB RAM running Windows 10. To model and solve the nonlinear program the study uses CasADi 3.4.5, [38], within MATLAB R2019a. For easier implementation, a CasADibased toolbox, YOP [39] is used to parse the optimal control problems into nonlinear programs. The solution to NLP is provided by the sparse NLP solver IPOPT by [24], running the linear solver MUMPS or MA97 by Harwell Subroutine Library [40]. For solving MIQP, the study uses Gurobi optimizer [41].

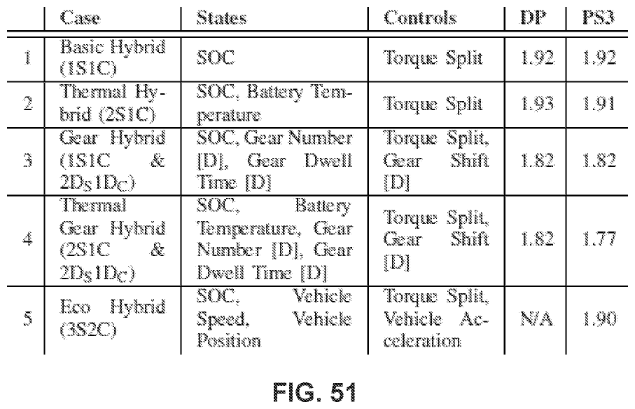

For consistent comparison, discretization step-size of one second is chosen for both algorithms (PS3 and DP) and a first-order polynomial degree is used for collocation in PS3 (with LGR points). The initial guess for the optimization variables used by PS3 was based on naïve rule-based estimate of state and control trajectories. The DP solver the study uses is based on the well known ‘dpm’ function method by [42]. Space discretization were used in DP for the state and control variables are provided in FIG. 51. Example DP space discretization levels are shown in FIG. 50.

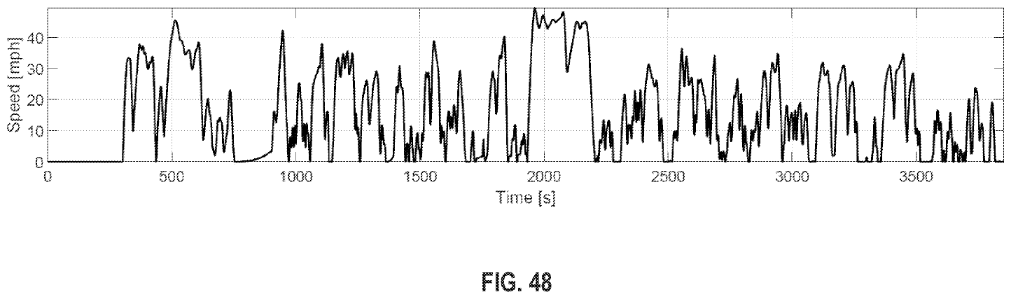

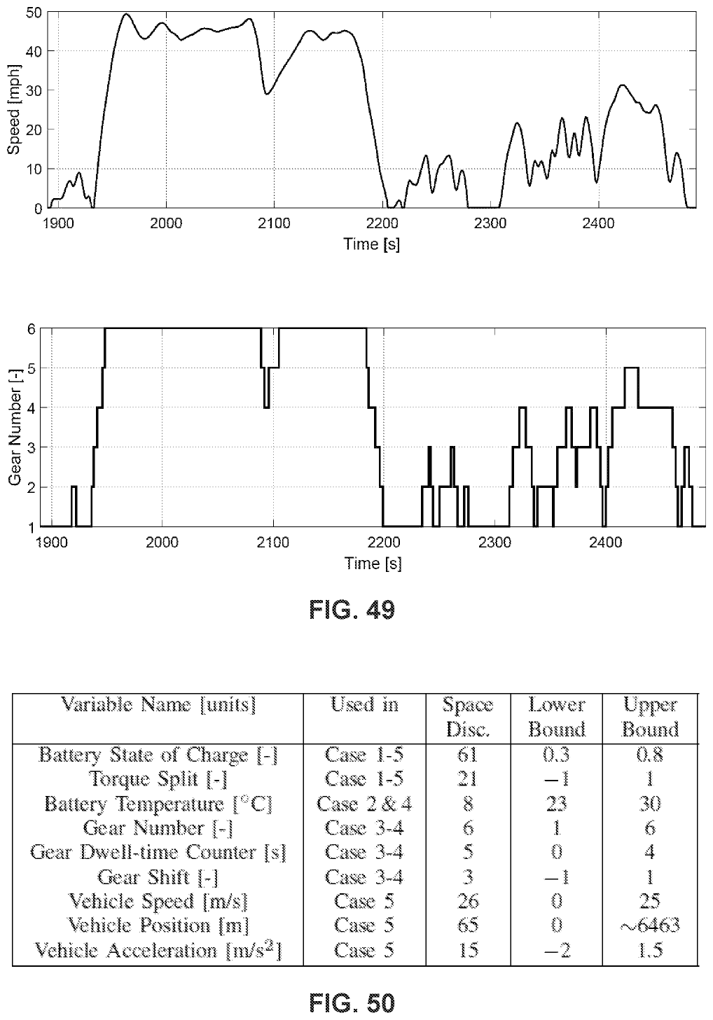

The example described herein considers a strong parallel P2 hybrid electric vehicle architecture, like the one shown in FIG. 45. This is for a medium-duty diesel-engine, a 90 kW-rated electric machine, 11 kWh lithium-iron-phosphate (LFP) battery pack with 31 Ah capacity, and 6-speed automatic transmission. Data maps for the LFP battery model used in this paper are given in the. All other modeling details about the internal combustion engine, electric machine, vehicle dynamics and driveline are given in the sequel [35]. A short segment of 10 minutes duration from the NREL drive cycle for parcel pickup and delivery is illustrated in FIG. 48 with a speed-dependent gear profile is used as reference for the following experiments, as shown in FIG. 49.

This problem involves a single real-valued state, battery state-of-charge, SOC (ξ) and a single control variable, torque split between internal combustion engine and the electric motor (p). Since no integer variables are involved in this problem, hence, only the step-1 of Algorithm 1 is relevant and used which gives the final optimal solution.

The control and state-space discretization required for DP is set to take 61 values for SOC (0.3≤ζ≤0.8), and 21 values for the control variable, torque split (−1≤μ≤1). This discretization is chosen to keep minimum computation time and memory load, without significant drop in optimality of the solutions. A point to note is that unlike DP, PS3 can take all real-values up-to machine precision for the state and control variables, i.e., its search space is not discretized the way it is for DP.

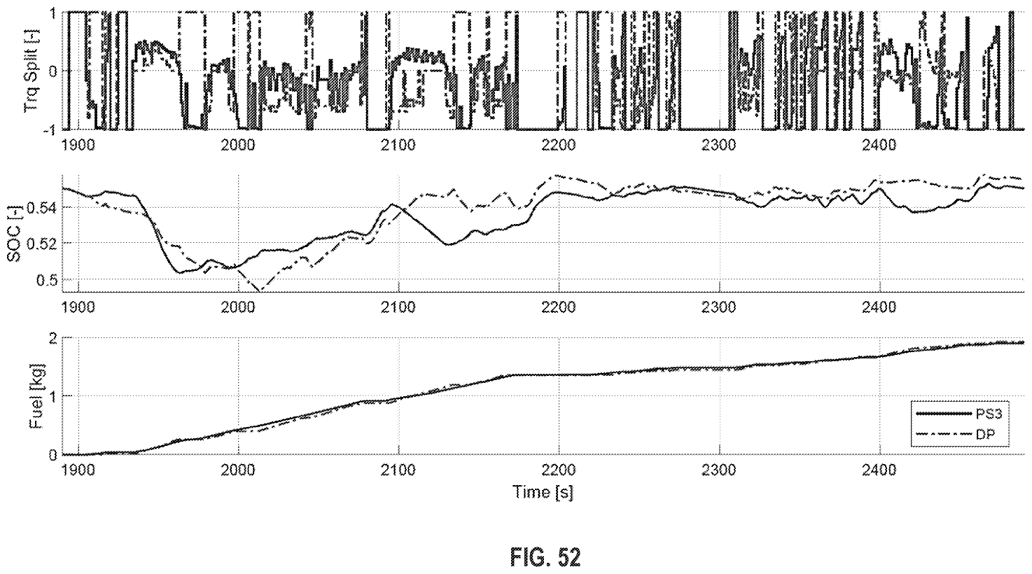

The obtained results are plotted in FIG. 52. Although the state (SOC) and control (Torque Split) trajectories appear different at many places in the plot, the study observes that both the algorithms have comparable overall cost i.e. total fuel consumed −1.920 kg (DP) and 1.921 kg (PS3), and have low computational times—4 seconds (DP) and 19 seconds (PS3).

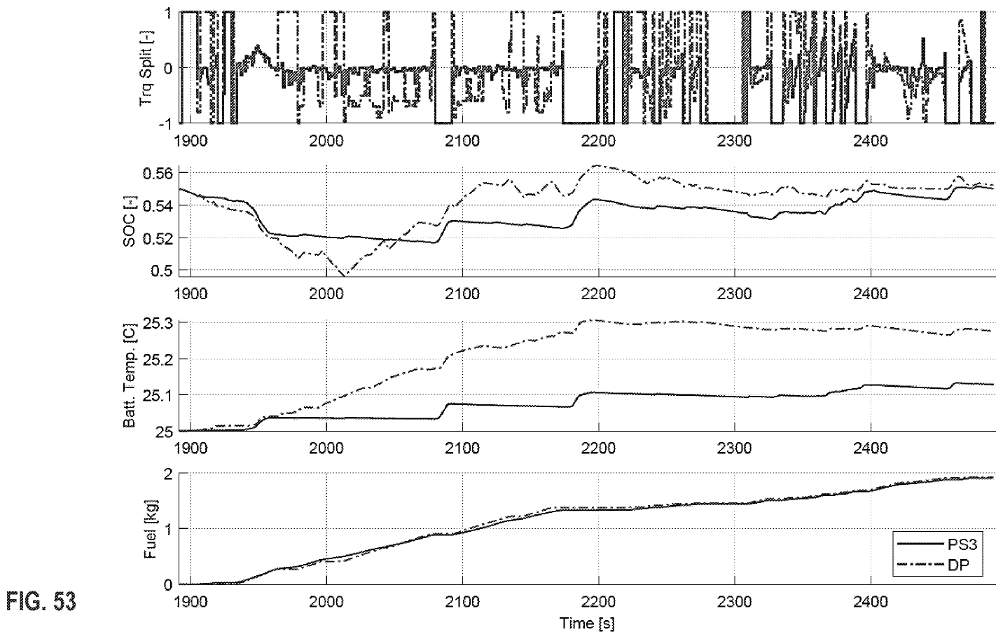

The second problem builds on top of the basic hybrid problem by involving two real-valued state variables, battery SOC and battery temperature, and one control variable, torque split. With the additional state variable of battery temperature having first-order thermal dynamics model, the study makes use of temperature-dependent (and SOC-dependent) 2D look-up table for cell internal resistance (see for its modeling details). The LFP battery model has very low Ohmic heat loss for a 10 minute drive cycle. In fact, the overall change in battery temperature is within one Celsius of the ambient temperature (25 Celsius). For this reason, the study discretizes the battery temperature values in DP to take any of 8 uniformly-spaced values within 23C and 30C. Results are plotted in FIG. 53. Again, the study shows that performance is comparable—1.93 kg (DP) and 1.91 kg (PS3), and computational times are still low—8.21 seconds (DP) and 23.27 seconds (PS3). Furthermore, the trajectories are different, yet overall effect on the cost is similar. An observation is that DP has higher battery utilization instances causing more current to be drawn in-and-out, and hence, the battery temperature rises more in the DP solution.

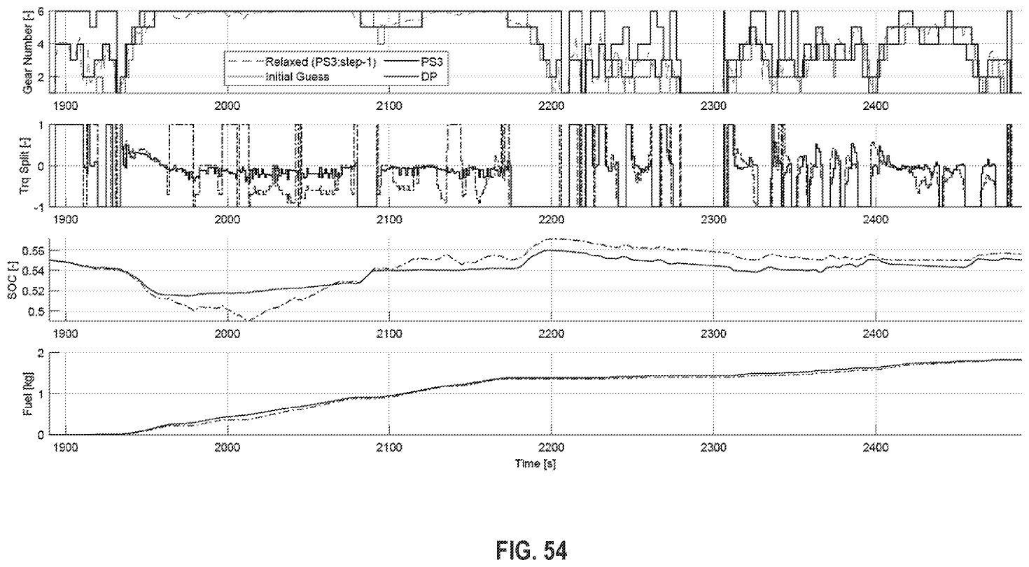

This case involves a mixed-integer optimal control problem. It considers one real-valued state, battery SOC, and one control variable, torque split (1S1C). And there are two integer-valued states, gear number and gear dwell-time counter, and one integer-valued control, gear shift command (2D_{S}1D_{C}). As for DP, the space-discretization for real-valued variables is the same as before, and the integer-valued variables have search space at only their respective feasible integer values (e.g. gear number can be an integer from 1 to 6, gear command can be an integer from −5 to 5, etc.). Being a mixed-integer problem, the study makes full use of the three-step algorithm, PS3. In the first step, the study obtains a relaxed gear profile (shown in the results plot later). The second step solves a mixed-integer quadratic program to find an integer gear profile near the relaxed profile while meeting the 3-seconds dwell-time constraint. And finally, the third step obtains the optimal real-valued signals with the input of known gear profile obtained from second step. Some important signals are shown in the plots of FIG. 54. Observations from the plots are:

Gear profiles of PS3 and DP are quite different, and so are the torque split profiles. But, the total fuel consumed by the end is almost identical 1.819 kg (DP) and 1. 815 kg(PS3).

Computational times are 502.82 seconds (DP) and [1249.9+1.4786+16.1430=]1267.5 seconds (PS3). DP's computational load is still tractable because the most of the state or control variables involved are integervalued in this problem. DP is able to handle integer valued variables quite well because space-discretization is simplified for integers. Computation time for PS3 is higher, but still tractable, than that for DP as it requires running of three sequential computational programs to be solved over its three steps.

Gear profile from DP solution tends to take higher values, which is better for fuel reduction, but it comes at the expense of steeper drops in the SOC. To meet the charge-sustaining constraint, DP solution then uses larger magnitudes of engine torque values costing higher fuel. The net result is that DP's fuel trajectory is lower in the first half of the cycle, but by the end it meets up with that of PS3 resulting in identical overall fuel consumed.

Since the study uses the interior-point solver, IPOPT as the NLP solver for PS3, the relaxed gear trajectory of PS3's step-1 is close to the given rule-based initial guess (solid-green). This confirms that having a good initial guess, especially when integer-valued variables are involved is critical for optimality in solutions.

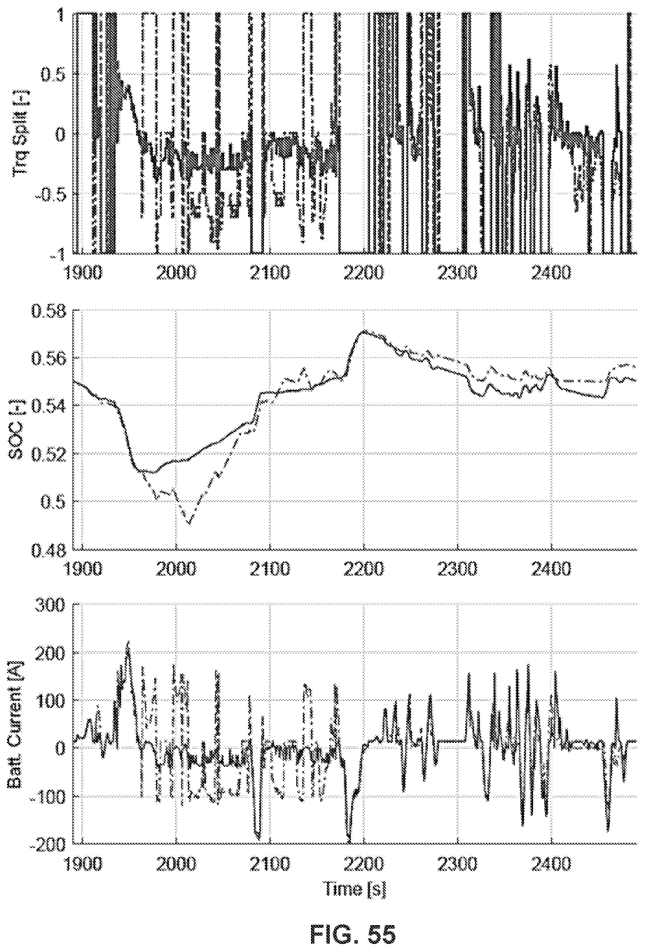

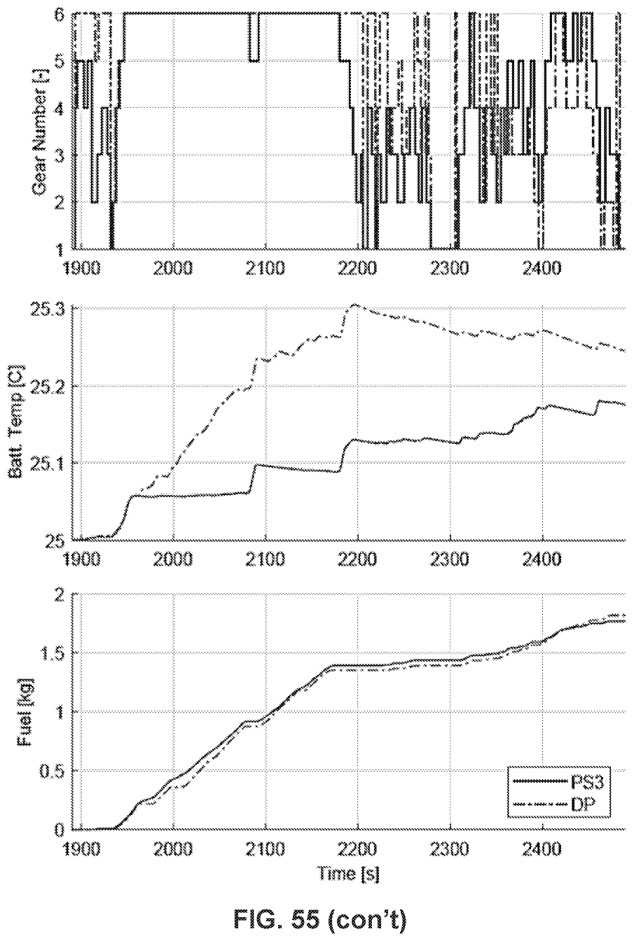

In order to demonstrate, how DP starts to become intractable for more complicated problems, the study considers this case of combined Cases 2-3, to make Case 4. Essentially, on top of the state and control variables of the gear hybrid problem, now there is fourth state variable, that of battery temperature which is real-valued like SOC. So, this problem involves two real-valued and two integer-valued state variables, and similarly one real-valued and one integer-valued control variable. Some plots for the obtained results are shown in FIG. 55. The key take-away from this experiment is that PS3 remains computationally reasonable despite to an added real-valued variable, however, due to its curse of dimensionality, DP starts to require large memory and computational resources. Overall fuel consumed is 1.818 kg (DP) and 1.770 kg (PS3), and computational times are 5046.6 seconds (84 minutes) (DP) and [1843.5+1.5770+63.6420=]1908.7 seconds 132 minutes) (PS3).

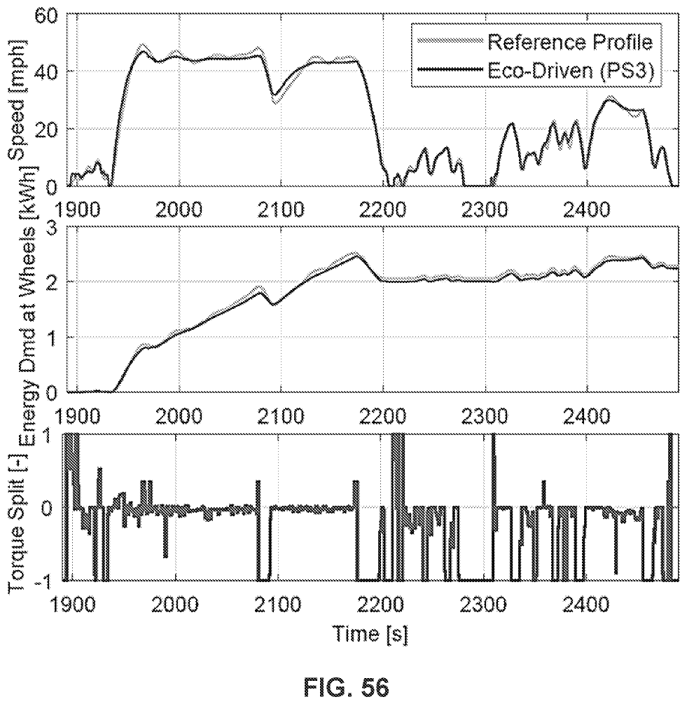

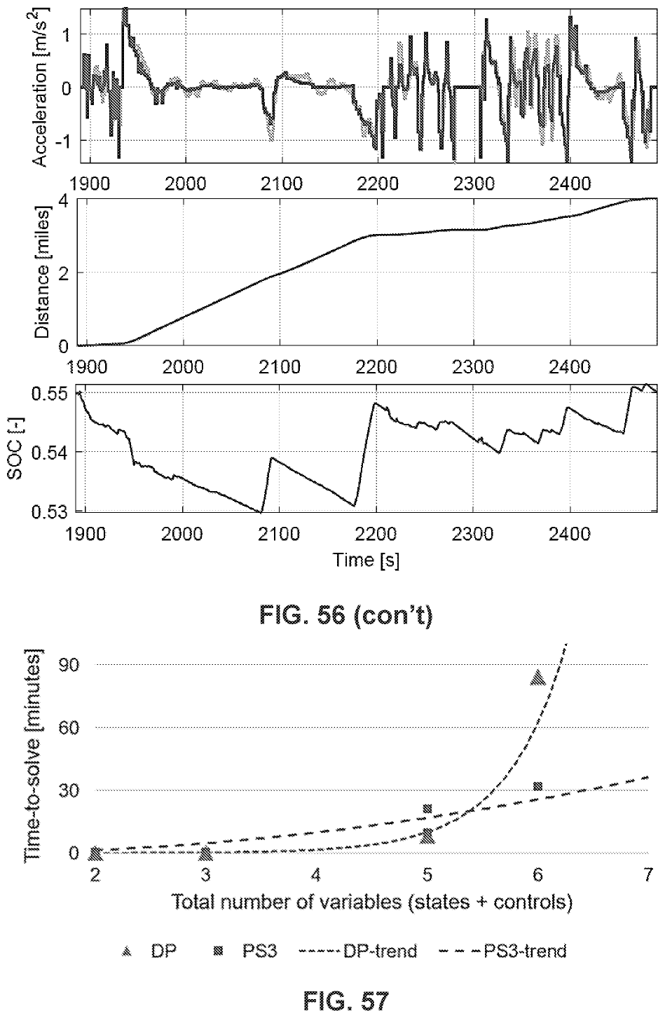

Finally, the study considers a case in which there are three state variables (SOC, vehicle speed, vehicle position) and two control variables (SOC, vehicle acceleration). The idea of ecodriving is to allow the vehicle to maneuver within a 5 km/h threshold of the reference target speed profile (shown in FIG. 56), such that the total distance covered on the whole route is the same. Simultaneously, torque split is also optimized.

PS3 is able to give a solution which is shown in FIG. 56. Computation time running PS3 for this experiment was 585.62 seconds and the total fuel consumed was 1.90 kg. The benefit of eco-driving versus non-eco-driving scenario was measured by comparing the net energy demand at the wheels which reduces by 2.213% of the reference, shown in FIG. 56.

As for a solution using Dynamic Programming, since all these variables are real-valued, DP exceeds the memory resources and fails to give a solution. When the example implementation tried a coarse space-discretization that does not exceed available memory, it is unable to find a feasible solution due to the coarseness.

When analyzing the plots, the study observes that the effect of eco-driving is that the eco-driven vehicle operates at slightly lower speeds when the reference is at high speeds, and at slightly higher speed when the reference is at very low speed—this behavior allows the eco-driven vehicle to use more electrical energy for vehicle traction, instead of fuel energy, thereby reducing fuel.

In FIG. 51, the study summarized the total fuel consumed for the various problems presented to benchmark performance of PS3 against DP. The study observes observe for problems which DP can solve, PS3's solutions match DP's globally optimal solutions. This establishes the general acceptability of PS3 as an alternative benchmark against DP. Theoretically, DP is a global optimization solver, and PS3 using IPOPT—only gives locally optimal solutions. But, robust adjustment of solver parameters and initial guesses leads PS3 to highly useful and near-globally-optimal performance, within reasonable computational cost.

Secondly, despite PS3 utilizing gradient-based optimization approach, the integer-valued variables (Case 3-4) are well optimized giving benchmark performance with the help of state-of-art MIQP solver, Gurobi. Thirdly, as the number of state and control variables in an optimal control problem increase, it becomes tedious for dynamic programming to give tractable solutions without compromising sensible space-discretization levels. This is due to DP's inherent curse of dimensionality, and is particularly apparent when real-valued variables are involved. Comparative trends of computation time with increasing problem size are shown in FIG. 57. The extrapolated trend of PS3's computation time is backed up with numerical results on a case-study problem involving 13 state variables and 4 control variables, which is presented in the sequel [35]. Lastly, as with any numerical solver, the computation time for PS3 can vary based on the desired tolerances, initial guess, and other solver options.

The example study of the example implementation referred to herein as “PS3”, includes mixed-integer optimal control problems with application to energy management of electrified powertrains involving high number of states and controls. Example implementations can employ direct pseudo-spectral collocation for highly accurate state dynamics estimation and relies on state-of-art numerical optimization solvers for NLP and MIQP. The underlying framework is built upon the open-source modeling language CasADi [38], is implemented in MATLAB, utilizes YOP [39] for parsing NLPs, and runs IPOPT [24] and Gurobi [41] solvers in its three steps.

The example algorithm utilizes validated powertrain component models and stands out in being able to provide solutions to diverse class of powertrain problems. PS3 benchmarks for problems that may involve simultaneous eco-driving and integer optimization along with non-differentiable look-up tables, thermal states, and combinatorial path constraints in the models. The study provides empirical justification of PS3's ability to be considered a benchmark algorithm by comparing results against Dynamic Programming for four out of five case-studies where various combinations of continuous and discrete states and controls were chosen to minimize fuel. Results were analyzed on a realistic drive cycle with frequent starts and stops, steeper acceleration and deceleration events, as well as wide-range of power demands. The study's analysis shows that this algorithm does not scale in computational load as DP does, and can handle highly complex interactions that occur in modern-day powertrains. This methodology can be robustly applied to difficult real-world problem classes and it has potential applications in real-time embeddable controllers. It can also serve as a numerical benchmark for other methodologies.

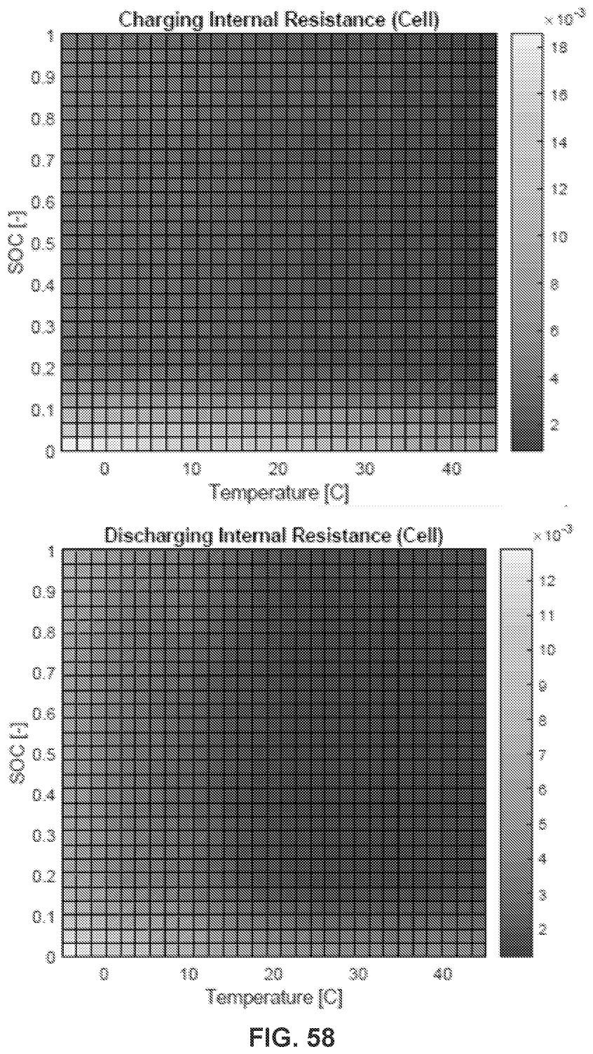

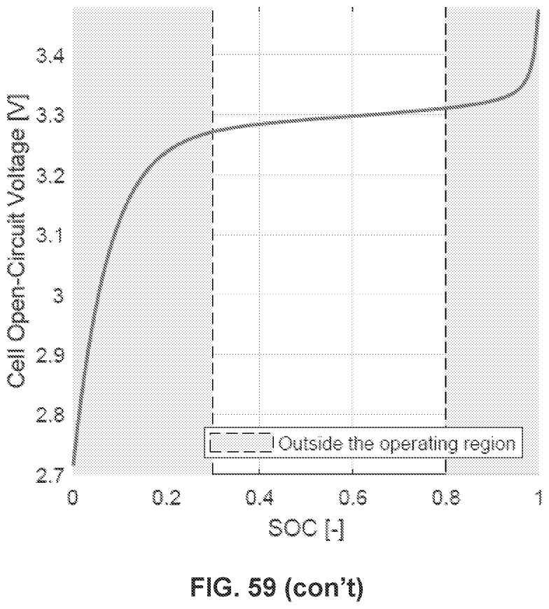

Implementations of the battery model described herein can include a battery pack model of 11 kWh Lithium-Iron-Phosphate (LFP) having 350 V nominal voltage. Charge sustaining operation is assumed for the drive cycle, and so the initial condition and final condition for SOC is set equal to 55%. For the electrical dynamics, the study assumes a zero-th order equivalent circuit model, and for the thermal dynamics, a first order temperature model with heat addition due to ohmic losses. Here the study uses a temperature-dependent internal resistance 2-D maps, which, along with the open-circuit voltage (OCV) plot is shown in FIG. 58 where OCV is modeled using the following expression:

V_{oc}=Nₛ(V₀−α_{b}(1−e^{-β}^{_{b}}^{ζ})+γ_{b} ζ+ξ_{b}(1−e^{-ϵ}^{_{b}}^{/(1-ζ)})), where, ζ, Nₛ and V₀ are battery state-of-charge (SOC), number of cells in series, and nominal voltage respectively, while the remaining constants α_{b}, β_{b}, γ_{b}, ζ_{b}, ϵ_{b} are obtained by curve-fitting the OCV with respect to SOC using real-world empirical data.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
[1] Huang, Y., Surawski, N. C., Organ, B., Zhou, J. L., Tang, O. H., and Chan, E. F., 2019, “Fuel consumption and emissions performance under real driving: Comparison between hybrid and conventional vehicles,” Science of the Total Environment, 659, pp. 275-282.
[2] Hu, X., Han, J., Tang, X., and Lin, X., 2021, “Powertrain design and control in electrified vehicles: a critical review,” IEEE Transactions on Transportation Electrification.
[3] Bai, S., and Liu, C., 2021, “Overview of energy harvesting and emission reduction technologies in hybrid electric vehicles,” Renewable and Sustainable Energy Reviews, 147, p. 111188.
[4] Reuters, 2020, China's nev sales to account for 20% of new car sales by 2025, 50% by 2035, October
[5] Carlier, M., 2022, U.s.: Quarterly hybrid and plugin hybrid electric vehicle sales 2021, February
[6] Silvas, E., Hofman, T., Murgovski, N., Etman, L. P., and Steinbuch, M., 2016, “Review of optimization strategies for system-level design in hybrid electric vehicles,” IEEE Transactions on Vehicular Technology, 66(1), pp. 57-70.
[7] Cohen, G., 1978, “Optimization by decomposition and coordination: A unified approach,” IEEE Transactions on Automatic Control, 23(2), pp. 222-232.
[8] Wachter, A., and Biegler, L. T., 2006, “On the implementation of an interior-point filter line-search algorithm for large-scale nonlinear programming,” Mathematical programming, 106(1), pp. 25-57.
[9] Bonami, P., Biegler, L. T., Conn, A. R., Cornuajols, G., Grossmann, I. E., Laird, C. D., Lee, J., Lodi, A., Margot, F., Sawaya, N., et al., 2008, “An algorithmic framework for convex mixed integer nonlinear programs,” Discrete optimization, 5(2), pp. 186204.
[10] MathWorks, 2022, Optimization Toolbox Documentation.
[11] Assanis, D., Delagrammatikas, G., Fellini, R., Filipi, Z., Liedtke, J., Michelena, N., Papalambros, P., Reyes, D., Rosenbaum, D., Sales, A., and Sasena, M., 1999, “Optimization Approach to Hybrid Electric Propulsion System Design,” Mechanics of Structures and Machines, 27(4), pp. 393-421.
[12] Liu, J., and Peng, H., 2010, “A systematic design approach for two planetary gear split hybrid vehicles,” Vehicle System Dynamics, 48(11), pp. 1395-1412.
[13] Bayrak, A. E., Ren, Y., and Papalambros, P. Y., 2013, “Design of hybrid-electric vehicle architectures using auto-generation of feasible driving modes,” In International Design Engineering Technical Conferences and Computers and Information in Engineering Conference, Vol. 55843, American Society of Mechanical Engineers, p. V001T01A005.
[14] Sundström, O., Ambühl, D., and Guzzella, L., 2010, “On implementation of dynamic programming for optimal control problems with final state constraints,” Oil & Gas Science and TechnologyRevue de l'Institut Frangais du Petrole, 65(1), pp. 91-102.
[15] Pisu, P., and Rizzoni, G., 2007, “A comparative study of supervisory control strategies for hybrid electric vehicles,” IEEE transactions on control systems technology, 15(3), pp. 506-518.
[16] Banvait, H., Anwar, S., and Chen, Y., 2009, “A rule-based energy management strategy for plug-in hybrid electric vehicle (phev),” In 2009 American control conference, IEEE, pp. 3938-3943.
[17] Zhao, J., and Sciarretta, A., 2016, “Design and Control Co-Optimization for Hybrid Powertrains: Development of Dedicated Optimal Energy Management Strategy,” IFAC-PapersOnLine, 49(11), pp. 277-284.
[18] Silvas, E., Backx, E., Hofman, T., Voets, H., and Steinbuch, M., 2014, “Design of power steering systems for heavy-duty long-haul vehicles,” IFAC Proceedings Volumes, 47(3), pp. 3930-3935.
[19] Silvas, E., Turan, O., Hofman, T., and Steinbuch, M., 2013, “Modeling for control and optimal design of a power steering pump and an air conditioning compressor used in heavy duty trucks,” In 2013 IEEE Vehicle Power and Propulsion Conference (VPPC), IEEE, pp. 1-6.
[20] Azad, S., Behtash, M., Houshmand, A., and Alexander-Ramos, M. J., 2019, “Phev powertrain co-design with vehicle performance considerations using mdsdo,” Structural and Multidisciplinary Optimization, 60(3), pp. 1155-1169.
[21] Azad, S., and Alexander-Ramos, M. J., 2021, “Robust combined design and control optimization of hybrid-electric vehicles using mdsdo,” IEEE Trans-actions on Vehicular Technology, 70(5), pp. 41394152.
[22] Houshmand, A., 2016, “Multidisciplinary dynamic system design optimization of hybrid electric vehicle powertrains,” PhD thesis, University of Cincinnati.
[23] Anil, V., Zhao, T., Zhao, M., Villani, M., Ahmed, Q., and Rizzoni, G., 2020, “Powertrain Design Optimization for a Range-Extended Electric Pickup and Delivery Truck,” SAE Int. J. Commer. Veh., 13(3), pp. 189-203.
[24] Azad, S., and Alexander-Ramos, M. J., 2021, “A single-loop reliability-based mdsdo formulation for combined design and control optimization of stochastic dynamic systems,” Journal of Mechanical Design, 143(2).
[25] Murgovski, N., Johannesson, L., Sjöberg, J., and Egardt, B., 2012, “Component sizing of a plug-in hybrid electric powertrain via convex optimization,” Mechatronics, 22(1), pp. 106-120.
[26] Ramakrishnan, K., Mastinu, G., and Gobbi, M., 2019, “Multidisciplinary design of electric vehicles based on hierarchical multi-objective optimization,” Journal of Mechanical Design, 141(9).
[27] Fahdzyana, C. A., Salazar, M., Donkers, T., and Hofman, T., 2021, “Integrated Design of a CVTequipped Electric Powertrain via Analytical Target Cascading,” 2021 European Control Conference, ECC 2021, pp. 927-932.
[28] Behtash, M., and Alexander-Ramos, M. J., 2020, “A decomposition-based optimization algorithm for combined plant and control design of interconnected dynamic systems,” Journal of Mechanical Design, 142(6).
[29] Villani, M., Shiledar, A., Zhao, T., Lana, C., Le, D., Ahmed, Q., and Rizzoni, G., 2021, “Optimal energy management strategy for energy efficiency improvement and pollutant emissions mitigation in a range-extender electric vehicle,” In 15th International Conference on Engines & Vehicles, no. 202124-0103.
[30] Michelena, N., Park, H., and Papalambros, P. Y., 2003, “Convergence properties of analytical target cascading,” AIAA journal, 41(5), pp. 897-905.
[31] Andersson, J. A., Gillis, J., Horn, G., Rawlings, J. B., and Diehl, M., 2019, “Casadi: a software framework for nonlinear optimization and optimal control,” Mathematical Programming Computation, 11(1), pp. 1-36.
[32] Leek, V., 2016, An Optimal Control Toolbox for MATLAB Based on CasADi.
[33] Sundström, O., and Guzzella, L., 2009, “A generic dynamic programming Matlab function,” Proceedings of the IEEE International Conference on Control Applications(7), pp. 1625-1630.
[34] Elnagar, G., Kazemi, M. A., and Razzaghi, M., 1995, “The pseudospectral legendre method for discretizing optimal control problems,” IEEE transactions on Automatic Control, 40(10), pp. 1793-1796.
[35] Tosserams, S., Etman, L., Papalambros, P., and Rooda, J., 2006, “An augmented lagrangian relaxation for analytical target cascading using the alternating direction method of multipliers,” Structural and multidisciplinary optimization, 31(3), pp. 176189.
[36] Kim, H. M., Michelena, N. F., Papalambros, P. Y., and Jiang, T., 2003, “Target cascading in optimal system design,” J. Mech. Des., 125(3), pp. 474-480.
[37] Fellini, R., Kim, H. M., Kokkolaras, M., Michelena, N., and Papalambros, P. Y., 2001, “Target cascading for design of product families,” In World Congress of Structural and Multidisciplinary Optimization: 04/06/2001-08/06/2001, Dalian University of Technology Press.
[38] Egardt, B., Murgovski, N., Pourabdollah, M., and Mardh, L. J., 2014, “Electromobility studies based on convex optimization: Design and control issues regarding vehicle electrification,” IEEE Control Systems Magazine, 34(2), pp. 32-49.
[39] Dranka, G. G., Ferreira, P., and Vaz, A. I. F., 2021, “A review of co-optimization approaches for operational and planning problems in the energy sector,” Applied Energy, 304, p. 117703.
[40] Vishwanath, A., Anwar, H., Chunodkar, A., and Ahmed, Q., 2021, “Comprehensive Energy Footprint Benchmarking of Strong Parallel Electrified Powertrain,” arXiv preprint arXiv:2106.00243.
[1A] European Environment Agency. Annual european union greenhouse gas inventory 1990-2017 and inventory report 2019. Available online, report no. 6/2019, EEA, 2019. URL: https://www.eea.europa.eu//publications/european-union-greenhouse-gas-inventory-2019 1
[2A]U.S. Environment Protection Agency. Fast facts on transportation greenhouse gas emissions. https://www.epa.gov/greenvehicles/fast-factstransportation-greenhouse-gas-emissions. Accessed: 2022-01-04. 1 [3]U.S. Environment Protection Agency. Smog, soot, and other air pollution from transportation. https://www.epa.gov/transportationair-pollution-and-climate-change/smog-soot-and-other-airpollution-transportation. Accessed: 2022-04-13. 1
[4A]U.S. Environment Protection Agency. Cleaner trucks initiative. https://www.epa.gov/regulations-emissions-vehicles-andengines/cleaner-trucks-initiative Accessed: 2022-01-04. 1
[5A] Oak Ridge National Laboratory. Transportation energy data book 36, tables 4.1, 4.2, 5.1, and 5.2. Available online, report no. ornl/tm-2017/513, ORNL, 2017. URL: https://www.epa.gov/regulations-emissionsvehicles-and-engines/cleaner-trucks-initiative. 1
[6A] Ahmed AI-Samari. Study of emissions and fuel economy for parallel hybrid versus conventional vehicles on real world and standard driving cycles. Alexandria Engineering Journal, 56(4):721-726, 2017. doi:https://doi.org/10.1016/j.aej.2017.04.010. 1
[7A] Hamza Anwar, Aashrith Vishwanath, Apurva Chunodkar, and Qadeer Ahmed. Comprehensive energy footprint benchmarking algorithm for electrified powertrains. arXiv preprint arXiv:2106.01459, 2021. 1, 2, 4. 5.7
[8A] Yongxiang Li, Chujin Hu, Zhenwen Chen, Chunhui Wang, Jing Li, and Haixia Guo. Sustainable improvement and evaluation of the shifting smoothness of vehicle transmission. Scientific Reports, 11(22610), November 2021. doi: 10.1038/s41598-021-02130-4. 1
[9A] Hanwen Liu, Xiaobing Liu, Sardar M. N. Islam, Xueqiao Yu, Qiqi Miao, Yapin Chen, and Lin Lin. Customer demand-driven low-carbon vehicles combined strategy and route optimisation integrated decision. Scientific Reports, 11(18483), September 2021. doi:10.1038/s41598-021-98028-2. (1)
[10A] Chan-Chiao Lin Jun-Mo, Jun mo Kang, J. W. Grizzle, and Huei Peng. Energy management strategy for a parallel hybrid electric truck. In Proceedings of the 2001 American Control Conference, pages 2878-2883, 2001. (1)
[11A] Lorenzo Serrao and Giorgio Rizzoni. Optimal control of power split for a hybrid electric refuse vehicle. In 2008 American Control Conference, pages 4498-4503, 2008. doi:10.1109/ACC.2008.4587204, 1
[12A] Saeed Amirfarhangi Bonab and Ali Emadi. Fuel-optimal energy management strategy for a power-split powertrain via convex optimization. IEEE Access, 8:30854-30862, 2020. doi:10.1109/ACCESS.2020.2972346, 1
[13A] Mohammad Behtash and Michael Alexander-Ramos. Decomposition-based mdsdo for co-design of large-scale dynamic systems. 08 2018. doi:10.1115/DETC2018-85935, 1 [14] Anil V Rao. A survey of numerical methods for optimal control. Advances in the Astronautical Sciences, 135(1):497-528, 2009. 1
[15A]C. R. Hargraves and S. W. Paris. Direct trajectory optimization using nonlinear programming and collocation. Journal of Guidance, Control, and Dynamics, 10(4):338-342, 1987. doi:10.2514/3.20223. 1
[16A] Florbela Fernandes, M. Fernanda Costa, and Edite Fernandes. Overview on mixed integer nonlinear programming problems. AIP Conference Proceedings, 1168, 09 2009. doi:10.1063/1.3241342. 1
[17A] Nicolo Robuschi, Clemens Zeile, Sebastian Sager, and Francesco Braghin. Multiphase mixed-integer nonlinear optimal control of hybrid electric vehicles. Automatica, 123:109325, 2021. doi: https://doi.org/10.1016/j.automatica.2020.109325, 1
[18A] Sebastian Sager, Michael Jung, and Christian Kirches. Combinatorial integral approximation. Mathematical Methods of Operations Research, 73:363380, 06 2011. doi:10.1007/s00186-011-0355-4. 1
[19A]C. Osornio-Correa, R. C. Villarreal-Calva, J. Estavillo-Galsworthy, A. Molina-Cristóbal, and S. D. Santillan-Gutierrez. Optimization of power train and control strategy of a hybrid electric vehicle for maximum energy economy. Ingenieria, Investigación y Tecnologia, 14(1):65-80, 2013. doi: https://doi.org/10.1016/S1405-7743(13)72226-1. 1
[20A]A MINLP Model for Global Optimization of Plug-In Hybrid Vehicle Design and Allocation to Minimize Life Cycle Greenhouse Gas Emissions, volume Volume 1: 36th Design Automation Conference, Parts A and B of International Design Engineering Technical Conferences and Computers and Information in Engineering Conference, 08 2010. doi:10.1115/DETC201028064. [
[21A] Dongsuk Kum, H. Peng, and N. Bucknor. Supervisory control of parallel hybrid electric vehicles for fuel and emission reduction. Journal of Dynamic Systems Measurement and Control-transactions of The Asme, 133:061010, 2011. 1
[22A]J. T. B. A. Kessels, F. P. T. Willems, W. J. Schoot, and P. P. J. van den Bosch. Integrated energy emission management for hybrid electric truck with scr aftertreatment. In 2010 IEEE Vehicle Power and Propulsion Conference, pages 1-6, 2010. doi:10.1109/VPPC.2010.5728990. 1
[23A] Andreas Wachter and Lorenz T Biegler. On the implementation of an interior-point filter line-search algorithm for large-scale nonlinear programming. Mathematical programming, 106(1):25-57, 2006. 5.7
[24A] LLC Gurobi Optimization. Gurobi optimizer reference manual. http://www.gurobi.com/, 2021. 5.7 [25] Olle Sundstrom and Lino Guzzella. A generic dynamic programming matlab function. In 2009 IEEE control applications, (CCA) & intelligent control, (ISIC), pages 1625-1630. IEEE, 2009. 5.7
[1B] Anwar, H., Vishwanath, A., Chunodkar, A., and Ahmed, Q., 2021, “Comprehensive energy footprint benchmarking algorithm for electrified powertrains,” arXiv preprint arXiv:2106.01459.
[2B] Anwar, H., Vishwanath, A., Chunodkar, A., and Ahmed, Q., 2021, “Comprehensive energy footprint benchmarking of strong parallel electrified powertrain,” arXiv preprint arXiv:2106.00243.
[3B] Huang, Y., Wang, H., Khajepour, A., He, H., and Ji, J., 2017, “Model predictive control power management strategies for hevs: A review,” Journal of Power Sources, 341, pp. 91-106.
[4B] Hadj-Said, S., Colin, G., Ketfi-Cherif, A., and Chamaillard, Y., 2016, “Convex optimization for energy management of parallel hybrid electric vehicles,” IFAC-PapersOnLine, 49(11), pp. 271-276.
[5B] Zhou, W., Zhang, C., Li, J., and Fathy, H. K., 2015, “A pseudospectral strategy for optimal power management in series hybrid electric powertrains,” IEEE Transactions on Vehicular Technology, 65(6), pp. 4813-4825.
[6B] Robuschi, N., Zeile, C., Sager, S., and Braghin, F., 2021, “Multiphase mixed-integer nonlinear optimal control of hybrid electric vehicles,” Automatica, 123, Jan., p. 109325.
[7B]Wächter, A., and Biegler, L. T., 2006, “On the implementation of an interior-point filter line-search algorithm for large-scale nonlinear programming,” Mathematical programming, 106(1), pp. 25-57.
[8B] HSL, 2007, A collection of fortran codes for largescale scientific computation.
[9B] Andersson, J., 2013, “A general-purpose software framework for dynamic optimization,” PhD thesis, PhD thesis, Arenberg Doctoral School, KU Leuven.
[10B] Leek, V., 2016, An optimal control toolbox for matlab based on casadi https://www.yoptimalcontrol.se/.
[1C] D.-D. Tran, M. Vafaeipour, M. El Baghdadi, R. Barrero, J. Van Mierlo, and O. Hegazy, “Thorough state-of-the-art analysis of electric and hybrid vehicle powertrains: Topologies and integrated energy management strategies,” Renewable and Sustainable Energy Reviews, vol. 119, p. 109596, 2020.
[2C]Y. Huang, H. Wang, A. Khajepour, H. He, and J. Ji, “Model predictive control power management strategies for hevs: A review,” Journal of Power Sources, vol. 341, pp. 91-106, 2017.
[3C]A. Bürger, C. Zeile, A. Altmann-Dieses, S. Sager, and M. Diehl, “Design, implementation and simulation of an mpc algorithm for switched nonlinear systems under combinatorial constraints,” Journal of Process Control, vol. 81, pp. 15-30, 2019.
[4C]J. Wu, J. Ruan, N. Zhang, and P. D. Walker, “An optimized real-time energy management strategy for the power-split hybrid electric vehicles,” IEEE Transactions on Control Systems Technology, vol. 27, no. 3, pp. 1194-1202, 2018
[5C]S. Onori, L. Serrao, and G. Rizzoni, Hybrid electric vehicles: energy management strategies. Springer, 2016, vol. 13.
[6C]Y. Pan and E. Theodorou, “Probabilistic differential dynamic programming,” in Advances in Neural Information Processing Systems, 2014, pp. 1907-1915.
[7C]W. Li, G. Xu, Z. Wang, and Y. Xu, “Dynamic energy management for hybrid electric vehicle based on approximate dynamic programming,” in 2008 7th World Congress on Intelligent Control and Automation. IEEE, 2008, pp. 7864-7869.
[8C]L. Johannesson, M. Asbogard, and B. Egardt, “Assessing the potential of predictive control for hybrid vehicle powertrains using stochastic dynamic programming,” IEEE Transactions on Intelligent Transportation Systems, vol. 8, no. 1, pp. 71-83, 2007.
[9C]V. Larsson, L. Johannesson, and B. Egardt, “Cubic spline approximations of the dynamic programming cost-to-go in hev energy management problems,” in 2014 European Control Conference (ECC). IEEE, 2014, pp. 1699-1704.
[10C]W. B. Powell, Approximate Dynamic Programming: Solving the curses of dimensionality. John Wiley & Sons, 2007, vol. 703
[11C]C.-C. Lin, H. Peng, and J. Grizzle, “A stochastic control strategy for hybrid electric vehicles,” in Proceedings of the 2004 American control conference, vol. 5. IEEE, 2004, pp. 4710-4715.
[12C]L. Serrao, S. Onori, and G. Rizzoni, “A comparative analysis of energy management strategies for hybrid electric vehicles,” Journal of Dynamic Systems, Measurement, and Control, vol. 133, no. 3, p. 031012, 2011.
[13C]M. Ghasemi and X. Song, “Powertrain energy management for autonomous hybrid electric vehicles with flexible driveline power demand,” IEEE Transactions on Control Systems Technology, vol. 27, no. 5, pp. 2229-2236, 2018.
[14C]Z. Chen, R. Xiong, and J. Cao, “Particle swarm optimization-based optimal power management of plug-in hybrid electric vehicles considering uncertain driving conditions,” Energy, vol. 96, pp. 197-208, 2016.
[15C]P. Pisu, E. Silani, G. Rizzoni, and S. M. Savaresi, “A Imi-based supervisory robust control for hybrid vehicles,” in Proceedings of the 2003 American Control Conference, 2003., vol. 6. IEEE, 2003, pp. 4681-4686
[16C]N. Robuschi, M. Salazar, N. Viscera, F. Braghin, and C. H. Onder, “Minimum-fuel energy management of a hybrid electric vehicle via iterative linear programming,” IEEE Transactions on Vehicular Technology, 2020.
[17C]S. Marinkov, N. Murgovski, and B. de Jager, “Convex modeling and optimization of a vehicle powertrain equipped with a generatorturbine throttle unit,” IEEE Transactions on Control Systems Technology, vol. 25, no. 4, pp. 1264-1277, 2016.
[18C]M. Koot, J. T. Kessels, B. De Jager, W. Heemels, P. Van den Bosch and M. Steinbuch, “Energy management strategies for vehicular electric power systems,” IEEE transactions on vehicular technology, vol. 54, no. 3, pp. 771-782, 2005.
[19C]V. Reinbold, E. Vinot, and L. Gerbaud, “Global optimization of a paralle hybrid vehicle using optimal energy management,” International Journal of Applied Electromagnetics and Mechanics, vol. 43, no. 1-2, pp. 115126, 2013.
[20C]M. Grant and S. Boyd, “Cvx: Matlab software for disciplined convex programming, version 2.1,” 2014.
[21C]B. Egardt, N. Murgovski, M. Pourabdollah, and L. J. Mardh, “Electromobility studies based on convex optimization: Design and control issues regarding vehicle electrification,” IEEE Control Systems Magazine, vol. 34, no. 2, pp. 32-49, 2014.
[22C]S. Hadj-Said, G. Colin, A. Ketfi-Cherif, and Y. Chamaillard, “Convex optimization for energy management of parallel hybrid electric vehicles,” IFAC-PapersOnLine, vol. 49, no. 11, pp. 271-276, 2016.
[23C]J. Park and S. Boyd, “A semidefinite programming method for integer convex quadratic minimization,” Optimization Letters, vol. 12, no. 3, pp. 499-518, 2018
[24C]A. Wächter and L. T. Biegler, “On the implementation of an interiorpoint filter line-search algorithm for large-scale nonlinear programming,” Mathematical programming, vol. 106, no. 1, pp. 25-57, 2006
[25C]C. Büskens and D. Wassel, “The esa nlp solver worhp,” in Modeling and optimization in space engineering. Springer, 2012, pp. 85-110.
[26C]W. Zhou, C. Zhang, J. Li, and H. K. Fathy, “A pseudospectral strategy for optimal power management in series hybrid electric powertrains,” IEEE Transactions on Vehicular Technology, vol. 65, no. 6, pp. 48134825, 2015
[27C]S. Wei, Y. Zou, F. Sun, and O. Christopher, “A pseudospectral method for solving optimal control problem of a hybrid tracked vehicle,” Applied energy, vol. 194, pp. 588-595, 2017.
[28C]Y. Liu, Z. Li, Z. Lin, K. Zhao, and Y. Zhu, “Multi-objective optimization of energy management strategy on hybrid energy storage system based on radau pseudospectral method,” IEEE Access, vol. 7, pp. 112483-112493, 2019.
[29C]N. Robuschi, C. Zeile, S. Sager, and F. Braghin, “Multiphase mixed integer nonlinear optimal control of hybrid electric vehicles,” Automatica, vol. 123, p. 109325, 2021.
[30C]P. Bonami, L. T. Biegler, A. R. Conn, G. Cornuéjols, I. E. Grossmann, C. D. Laird, J. Lee, A. Lodi, F. Margot, N. Sawaya et al., “An algorithmic framework for convex mixed integer nonlinear programs,” Discrete Optimization, vol. 5, no. 2, pp. 186-204, 2008.
[31C]R. H. Byrd, J. Nocedal, and R. A. Waltz, “Knitro: An integrated package for nonlinear optimization,” in Large-scale nonlinear optimization. Springer, 2006, pp. 35-59.
[32C]M. Diehl, “Lecture notes on numerical optimization,” 2016.
[33C]S. Sager, Numerical methods for mixed-integer optimal control problems. Der Andere Verlag Tönning, 2005.
[34C]J. T. Betts, Practical methods for optimal control and estimation using nonlinear programming. SIAM, 2010.
[35C]A. Vishwanath, H. Anwar, A. Chunodkar, and Q. Ahmed, “Comprehensive energy footprint benchmarking of strong parallel electrified powertrain,” arXiv preprint arXiv:2106.00243, 2021.
[36C]A. V. Rao, “A survey of numerical methods for optimal control,” Advances in the Astronautical Sciences, vol. 135, no. 1, pp. 497-528, 2009.
[37C]L. Biegler, Nonlinear Programming: Concepts, Algorithms, and Applications to Chemical Processes, ser. MOS-SIAM Series on Optimization. Society for Industrial and Applied Mathematics, 2010.
[38C]J. A. E. Andersson, J. Gillis, G. Horn, J. B. Rawlings, and M. Diehl, “CasADi—A software framework for nonlinear optimization and optimal control,” Mathematical Programming Computation, vol. 11, no. 1, pp. 1-36, 2019.
[39C]V. Leek, “An optimal control toolbox for matlab based on casadi,” https://www.yoptimization.com/2016.
[40C] HSL, “A collection of fortran codes for large-scale scientific computation,” http://www.hsl.rl.ac.uk/2007.
[41C]L. Gurobi Optimization, “Gurobi optimizer reference manual,” http://www.gurobi.com/2021.
[42C]O. Sundstrom and L. Guzzella, “A generic dynamic programming matlab function,” in 2009 IEEE control applications, (CCA) & intelligent control, (ISIC). IEEE, 2009, pp. 1625-1630.
[43C]“Nrel drivecat—drive cycle analysis tool. national renewable energy laboratory,” www.nrel.gov/transportation/drive-cycle-tool 2020.

1. A computer-implemented method for controlling a powertrain of a vehicle comprising:
receiving a plurality of optimization variables;
receiving a cost function representing a vehicle system, wherein the cost function comprises a plurality of weights assigned to the plurality of optimization variables;
decomposing the cost function into a plurality of control problems; and
generating a solution to the cost function by solving the plurality of control problems.

2. The computer-implemented method of claim 1, further comprising outputting the solution to a vehicle, whereby the powertrain of the vehicle is controlled based on the solution to the cost function.

3. The computer-implemented method of claim 1, wherein the optimization variables comprise a plurality of states.

4. The computer-implemented method of claim 3, wherein the plurality of states comprise at least one of vehicle speed, vehicle distance, gear number, gear dwell time count, battery state-of-charge, battery temperature, engine status, engine on/off dwell time counter, fuel consumption, pre-Diesel Oxidation Catalyst (DOC) temperature, DOC temperature, Diesel Particulate Filter (DPF) temperature, and selective catalytic reduction (SCR) temperature.

5. The computer-implemented method of claim 1, wherein the optimization variables comprise a plurality of design parameters.

6. (canceled)

7. The computer-implemented method of claim 1, wherein the optimization variables further comprise a plurality of control variables.

8. (canceled)

9. The computer-implemented method of claim 1, wherein the optimization variables comprise a plurality of design parameters, and wherein the design parameters comprise number of battery cells in series (Ns), number of battery cells in parallel (Np), scaling factor for a genset power, and genset selection between diesel and compressed natural gas (CNG).

10. The computer-implemented method of claim 1, wherein the cost function is a function that comprises values representing fuel, battery energy, and emissions.

11. (canceled)

12. The computer-implemented method of claim 1, wherein the solution to the cost function comprises a design-space optimization.

13. A system for controlling a powertrain of a vehicle, the system comprising: a vehicle powertrain; and
a computing device in operable communication with the vehicle powertrain, wherein the computing device comprises a processor and a memory, the memory having computer-executable instructions stored thereon that, when executed by the processor, cause the processor to:
receive a plurality of optimization variables;
receive a cost function representing a vehicle system, wherein the cost function comprises a plurality of weights assigned to the plurality of optimization variables;
decompose the cost function into a plurality of control problems;
generate a solution to the cost function by solving the plurality of control problems; and
control the vehicle powertrain based on the solution to the cost function.

14. The system of claim 13, wherein the memory has further computer-executable instructions stored thereon that, when executed by the processor, cause the processor to output the solution to a vehicle comprising the vehicle powertrain, whereby the vehicle powertrain is controlled based on the solution to the cost function.

15. The system of claim 13, wherein the optimization variables comprise a plurality of states.

16. The system of claim 15, wherein the plurality of states comprise at least one of vehicle speed, vehicle distance, gear number, gear dwell time count, battery state-of-charge, battery temperature, engine status, engine on/off dwell time counter, fuel consumption, pre-Diesel Oxidation Catalyst (DOC) temperature, DOC temperature, Diesel Particulate Filter (DPF) temperature, and selective catalytic reduction (SCR) temperature.

17. The system of claim 13, wherein the optimization variables comprise a plurality of design parameters.

18. The system of claim 13, wherein the optimization variables comprise a plurality of continuous and discrete variables.

19. The system of claim 13, wherein the optimization variables comprise a plurality of control variables.

20. The system of claim 19, wherein the control variables comprise at least one of vehicle acceleration, gear shift command, torque split, and engine switch.

21. The system of claim 13, wherein the optimization variables comprise a plurality of design parameters, and wherein the design parameters comprise number of battery cells in series (Ns), number of battery cells in parallel (Np), scaling factor for a genset power, and genset selection between diesel and compressed natural gas (CNG).

22. The system of claim 13, wherein the cost function is a function that comprises values representing fuel, battery energy, and emissions.

23. (canceled)

24. The system of claim 13, wherein the solution to the cost function comprises a design-space optimization.
